(19) United States
(12) Patent Application Publication
(10) Pub. No.: US 2026/0089336 A1
(43) Pub. Date: Mar. 26, 2026

(54) APPARATUS AND METHOD FOR ENCODING AND DECODING IMAGE BY USING REFERENCE BLOCK

(71) Applicant: SAMSUNG ELECTRONICS CO., LTD., Suwon-si (KR)

(72) Inventors: Ling LI, Suwon-si (KR); Kwangpyo CHOI, Suwon-si (KR)

(73) Assignee: SAMSUNG ELECTRONICS CO., LTD., Suwon-si (KR)

(21) Appl. No.: 19/408,916

(22) Filed: Dec. 4, 2025

Related U.S. Application Data
(63) Continuation of application No. PCT/KR2024/004948, filed on Apr. 12, 2024.

(30) Foreign Application Priority Data
Jun. 9, 2023 (KR) 10-2023-0074384
Aug. 29, 2023 (KR) 10-2023-0113967

(51) Int. Cl. H04N 19/159; H04N 19/105; H04N 19/11; H04N 19/167; H04N 19/176; H04N 19/593

(52) U.S. Cl. CPC H04N 19/159; H04N 19/105; H04N 19/11; H04N 19/167; H04N 19/176; H04N 19/593

(57) ABSTRACT

A method for image decoding includes determining at least one of a first reference block in a current picture reconstructed before a current block or a second reference block in a previous picture reconstructed before the current block, based on template matching; identifying a corresponding location of a pre-determined location within the current block from at least one of the first reference block or the second reference block generating a prediction block by performing intra prediction on the current block according to an intra prediction mode used to reconstruct a sample at the identified corresponding location; and reconstructing the current block using the prediction block.

### CROSS REFERENCE TO RELATED APPLICATION(S)

This application is a bypass continuation application of International Patent Application No. PCT/KR2024/004948, filed on Apr. 12, 2024, which claims priority to Korean Patent Application No. 10-2023-0074384, filed on Jun. 9, 2023 and Korean Patent Application No. 10-2023-0113967, filed on Aug. 29, 2023, the disclosures of which are incorporated herein by reference in their entireties.

### BACKGROUND

### 1. Field

One or more embodiments of the present disclosure relate to the field of image encoding and decoding, and more particularly, to an apparatus and method for encoding and decoding an image using a reference block included in at least one of a current image or a previous image.

### 2. Description of Related Art

In image encoding and decoding, an image may be split into blocks, and each block may be encoded and decoded based on inter prediction or intra prediction.

Inter prediction may refer to a technique for compressing an image by removing temporal redundancy between images. Inter prediction may predict blocks of a current image using a reference image. A reference block that is most similar to a current block may be searched for in a certain search range in the reference image. The current block may be predicted based on the reference block, and a prediction block generated as a result of prediction may be subtracted from the current block to generate a residual block.

In standards, such as H.264 Advanced Video Coding (AVC) and High Efficiency Video Coding (HEVC), motion vectors of previously encoded blocks adjacent to a current block or blocks included in a previously encoded image may be used as a motion vector predictor of the current block in order to predict a motion vector of the current block. A motion vector difference, which may refer to a difference between the motion vector of the current block and the motion vector predictor of the current block, may be signaled to a decoder side through a certain method.

Intra prediction may refer to a technology for compressing an image by removing spatial redundancy in the image. Intra prediction may generate a prediction block based on neighboring pixels of the current block according to an intra prediction mode. Then, a residual block may be generated by subtracting the prediction block from the current block.

The residual block generated by inter prediction or intra prediction may be transmitted to the decoder through transformation and quantization. The decoder may inversely quantize and inversely transform the residual block, and may reconstruct the current block by combining the prediction block of the current block with the residual block. In certain cases, the decoder may remove artifacts from the reconstructed current block by filtering the reconstructed current block. The efficiency of generating the prediction block may be improved.

### SUMMARY

According to an aspect of one or more embodiments of the present disclosure, a method for image decoding may include determining at least one of a first reference block in a current picture reconstructed before a current block or a second reference block in a previous picture reconstructed before the current block, based on template matching; identifying a corresponding location of a pre-determined location within the current block from at least one of the first reference block or the second reference block; generating a prediction block by performing intra prediction on the current block according to an intra prediction mode used to reconstruct a sample at the identified corresponding location; and reconstructing the current block using the prediction block.

According to another aspect of one or more embodiments of the present disclosure, a method for image encoding may include determining at least one of a first reference block in a current picture encoded before a current block or a second reference block in a previous picture encoded before the current block, based on template matching; identifying a corresponding location of a pre-determined location within the current block from at least one of the first reference block or the second reference block; generating a prediction block by performing intra prediction on the current block according to an intra prediction mode used to encode a sample at the identified corresponding location; and encoding the current block using the prediction block.

According to another aspect of one or more embodiments of the present disclosure, a non-transitory computer-readable medium having stored thereon instructions that, when executed by at least one processor individually or collectively, may cause the at least one processor to determine at least one of a first reference block in a current picture encoded before the current block or a second reference block in a previous picture encoded before the current block, based on template matching; identify a corresponding location of a pre-determined location within the current block from at least one of the first reference block or the second reference block; generate a prediction block by performing intra prediction on the current block according to an intra prediction mode used to encode a sample at the identified corresponding location; and encode the current block using the prediction block to generate a bitstream comprising a result of encoding the current block to be stored in the non-transitory computer-readable medium.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram of an image decoding apparatus according to one or more embodiments;

FIG. 2 is a block diagram of an image encoding apparatus according to one or more embodiments;

FIG. 3 illustrates a process of determining at least one coding unit by splitting a current coding unit, according to one or more embodiments;

FIG. 4 illustrates a process of determining at least one coding unit by splitting a non-square coding unit, according to one or more embodiments;

FIG. 5 illustrates a process of splitting a coding unit based on at least one of block shape information and split shape mode information, according to one or more embodiments;

FIG. 6 illustrates a method of determining a preset coding unit from among an odd number of coding units, according to one or more embodiments;

FIG. 7 illustrates an order of processing a plurality of coding units when determining the plurality of coding units by splitting a current coding unit, according to one or more embodiments;

FIG. 8 illustrates a process of determining that a current coding unit is to be split into an odd number of coding units, when the coding units are not processable in a preset order, according to one or more embodiments;

FIG. 9 illustrates a process of determining at least one coding unit by splitting a first coding unit, according to one or more embodiments;

FIG. 10 illustrates that a shape into which a non-square second coding unit determined by splitting a first coding unit, is splittable is restricted when the second coding unit satisfies a preset condition, according to one or more embodiments;

FIG. 11 illustrates a process of splitting a square coding unit when split shape mode information does not indicate splitting in units of four square coding units, according to one or more embodiments;

FIG. 12 illustrates that a processing order between a plurality of coding units may be changed depending on a process of splitting a coding unit, according to one or more embodiments;

FIG. 13 illustrates a process of determining a depth of a coding unit as a shape and size of the coding unit change, when the coding unit is recursively split such that a plurality of coding units are determined, according to one or more embodiments;

FIG. 14 illustrates depths that are determinable based on shapes and sizes of coding units, and part indexes (PIDs) for distinguishing the coding units, according to one or more embodiments;

FIG. 15 illustrates that a plurality of coding units are determined based on a plurality of preset data units included in a picture, according to one or more embodiments;

FIG. 16 illustrates coding units of individual pictures, when the individual pictures have different split shape combinations of coding units, according to one or more embodiments;

FIG. 17 illustrates various shapes of coding units that can be determined based on split shape mode information that is expressed with a binary code, according to one or more embodiments;

FIG. 18 illustrates other shapes of coding units that can be determined based on split shape mode information that is expressed with a binary code, according to one or more embodiments;

FIG. 19 is a block diagram of an image encoding and decoding system that performs loop filtering, according to one or more embodiments;

FIG. 20 is a block diagram of an image decoding apparatus according to one or more embodiments;

FIG. 21 is a diagram illustrating types of intra prediction modes according to one or more embodiments;

FIG. 22 is a diagram illustrating neighboring samples that may be used for intra prediction with respect to a current block, according to one or more embodiments;

FIG. 23 is a diagram for explaining a process of predicting a current block using neighboring samples according to an intra prediction mode, according to one or more embodiments;

FIG. 24 is a diagram for explaining a method of determining a reference block of a current block, according to one or more embodiments;

FIG. 25 is a diagram illustrating locations of neighboring blocks related to a current block, according to one or more embodiments;

FIG. 26 is a diagram for explaining a method of determining an intra prediction mode of a reference block as an intra prediction mode of a current block, according to one or more embodiments;

FIG. 27 is a diagram illustrating neighboring samples that may be used for intra prediction with respect to a neighboring sample set of a current block, according to one or more embodiments;

FIG. 28 is a diagram for explaining a process of predicting a neighboring sample set using neighboring samples of a neighboring sample set according to an intra prediction mode, according to one or more embodiments;

FIG. 29 is a diagram for explaining a method of determining an intra prediction mode of a reference block as an intra prediction mode of a current block, according to one or more embodiments;

FIG. 30 is a diagram for describing a process of propagating an intra prediction mode, according to one or more embodiments;

FIG. 31 is a flowchart of an image decoding method according to one or more embodiments;

FIG. 32 is a block diagram of an image encoding apparatus according to one or more embodiments; and

FIG. 33 is a flowchart of an image encoding method according to one or more embodiments.

### DETAILED DESCRIPTION

As the present disclosure allows for various changes and numerous embodiments, particular embodiments will be illustrated in the drawings and described in detail in the written description. However, this is not intended to limit the present disclosure to particular modes of practice, and all changes, equivalents, and substitutes that do not depart from the spirit and technical scope of the present disclosure are encompassed in the disclosure.

In the description of embodiments of the present disclosure, certain detailed explanations of the related art may be omitted when it is deemed that they may unnecessarily obscure the essence of the present disclosure. Terms (e.g., “first” and “second”) used to describe embodiments may correspond to identifiers for distinguishing one component from another.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items).

Further, unless stated otherwise or otherwise clear from context, phrase “based on” means “based at least in part on” and not “based solely on.”

It will be understood that when an element or layer is referred to as being “on,” “connected to” or “coupled to” another element or layer, it can be directly on, connected or coupled to the other element or layer, or intervening elements or layers may be present. By contrast, when an element is referred to as being “directly on,” “directly connected to,” or “directly coupled to” another element or layer, there are no intervening elements or layers present.

Use of terms such as “a” and “an” and “the” and similar referents in context of describing disclosed embodiments (especially in context of following claims) are to be construed to cover both singular and plural, unless otherwise indicated herein or clearly contradicted by context, and not as a definition of a term. Number of items in a plurality is at least two, but can be more when so indicated either explicitly or by context.

Terms such as “comprising,” “having,” “including,” and “containing” are to be construed as open-ended terms (meaning “including, but not limited to,”) unless otherwise noted. The terms may specify the presence of stated features, numbers, steps, operations, elements, components or combinations thereof. The terms may not preclude the possibility of the presence or addition of one or more other features, numbers, steps, operations, elements, components, and/or combinations thereof. Recitation of ranges of values herein are merely intended to serve as a shorthand method of referring individually to each separate value falling within range, unless otherwise indicated herein and each separate value is incorporated into specification as if it were individually recited herein.

Regarding a component represented as a “˜ er (or) (unit)” or a “module” used herein, two or more components may be combined into one component or one component may be divided into two or more components. In addition, each component described hereinafter may additionally perform some or all of functions performed by another component, in addition to main functions of itself, and some of the main functions of each component may be performed entirely by another component.

An ‘image’ used herein may indicate a picture, a still image, a frame, a moving image composed of a plurality of continuous still images, or a video.

A ‘sample’ used herein may refer to, as data assigned to a sampling location of an image, data to be processed. For example, pixels in a frame of a spatial domain may correspond to samples. A unit including a plurality of samples may be defined as a block.

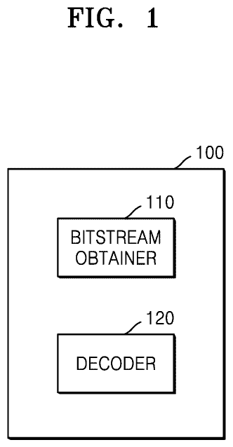

Hereinafter, an image encoding method and apparatus and an image decoding method and apparatus based on coding units and transformation units having a tree structure according to one or more embodiments will be described with reference to FIGS. 1 through 19.

FIG. 1 is a block diagram of an image decoding apparatus 100 according to one or more embodiments.

The image decoding apparatus 100 may include a bitstream obtainer 110 and a decoder 120. The bitstream obtainer 110 and the decoder 120 may include at least one processor. When examples describe at least one processor (e.g., central processing unit (CPU), graphics processing unit (GPU)) performing one or more operations described herein, this may indicate that the at least one processor is configured to perform the one or more operations. Additionally or alternatively, the at least one processor (e.g., individually or collectively) may perform one or more instructions stored in memory and/or non-transitory computer-readable medium to perform the one or more operations or cause the apparatus or device to perform the one or more operations.

Additionally, one or more decoding apparatuses or devices described herein (e.g., image decoding apparatus 100, image decoding apparatus 2000, image) may be incorporated into various electronic devices, such as a TV, smartphone, desktop, or laptop. It may also include a communication interface to receive the bitstream from an external device, and a display screen to show the results of decoding the bitstream.

Moreover, one or more decoding apparatuses or devices described herein (image encoding apparatus 200, encoding apparatus 3200) integrated into electronic devices including video cameras, or servers (e.g., video streaming servers or media servers), which are configured to encode videos and transmit the encoded videos to the one or more decoding apparatuses or devices.

The bitstream obtainer 110 and the decoder 120 may include a memory storing instructions that are to be executed by the at least one processor.

The bitstream obtainer 110 may receive a bitstream. The bitstream may include information resulting from image encoding by an image encoding apparatus 200 which will be described later. The bitstream may be transmitted from the image encoding apparatus 200. The image decoding apparatus 100 may be connected to the image encoding apparatus 200 in a wired or wireless manner, and the bitstream obtainer 110 may receive a bitstream in a wired or wireless manner. The bitstream obtainer 110 may receive a bitstream from a storage medium, such as optical media, a hard disk, etc. The decoder 120 may reconstruct an image, based on information obtained from the received bitstream. The decoder 120 may obtain a syntax element for reconstructing an image from the bitstream. The decoder 120 may reconstruct the image, based on the syntax element.

Describing an operation of the image decoding apparatus 100 in detail, the bitstream obtainer 110 may receive a bitstream.

The image decoding apparatus 100 may perform an operation of obtaining a bin string corresponding to a split shape mode of a coding unit from the bitstream. The image decoding apparatus 100 may perform an operation of determining a split rule of a coding unit. The image decoding apparatus 100 may perform an operation of splitting a coding unit into a plurality of coding units, based on at least one of the bin string corresponding to the split shape mode and the split rule. The image decoding apparatus 100 may determine a first range which is an allowable size range of a coding unit, according to a ratio of a height to a width of the coding unit, in order to determine the split rule. The image decoding apparatus 100 may determine a second range which is an allowable size range of a coding unit, according to a split shape mode of the coding unit, in order to determine the split rule.

Hereinafter, splitting of a coding unit will be described in detail according to one or more embodiments of the present disclosure.

First, one picture may be split into one or more slices or one or more tiles. One slice or one tile may be a sequence of one or more largest coding units (coding tree units (CTUs)). According to an implementation example, one slice includes one or more tiles, or one slice may include one or more largest coding units. A slice including one tile or a plurality of times may be determined within a picture.

There is a largest coding block (coding tree block (CTB)) conceptually compared to a largest coding unit (CTU). The largest coding block (CTB) denotes an N×N block including N×N samples (where N is an integer). Each color component may be split into one or more largest coding blocks.

When a picture has three sample arrays (sample arrays for Y, Cr, and Cb components), a largest coding unit (CTU) includes a largest coding block of a luma sample, two corresponding largest coding blocks of chroma samples, and syntax structures used to encode the luma sample and the chroma samples. When a picture is a monochrome picture, a largest coding unit includes a largest coding block of a monochrome sample and syntax structures used to encode the monochrome samples. When a picture is a picture encoded in color planes separated according to color components, a largest coding unit includes syntax structures used to encode the picture and samples of the picture.

One largest coding block (CTB) may be split into M×N coding blocks including M×N samples (M and N are integers).

When a picture has sample arrays for Y, Cr, and Cb components, a coding unit (CU) includes a coding block of a luma sample, two corresponding coding blocks of chroma samples, and syntax structures used to encode the luma sample and the chroma samples. When a picture is a monochrome picture, a coding unit includes a coding block of a monochrome sample and syntax structures used to encode the monochrome samples. When a picture is a picture encoded in color planes separated according to color components, a coding unit includes syntax structures used to encode the picture and samples of the picture.

As described above, a largest coding block and a largest coding unit are conceptually distinguished from each other, and a coding block and a coding unit are conceptually distinguished from each other. In other words, a (largest) coding unit refers to a data structure including a (largest) coding block including a corresponding sample and a syntax structure corresponding to the (largest) coding block. However, because it is understood by one of ordinary skill in the art that a (largest) coding unit or a (largest) coding block refers to a block of a preset size including a preset number of samples, a largest coding block and a largest coding unit, or a coding block and a coding unit are mentioned in the following specification without being distinguished unless otherwise described.

An image may be split into largest coding units (CTUs). A size of each largest coding unit may be determined based on information obtained from a bitstream. A shape of each largest coding unit may be a square shape of the same size. However, embodiments are not limited thereto.

For example, information about a maximum size of a luma coding block may be obtained from a bitstream. For example, the maximum size of the luma coding block indicated by the information about the maximum size of the luma coding block may be one of 4×4, 8×8, 16×16, 32×32, 64×64, 128×128, and 256×256.

For example, information about a luma block size difference and a maximum size of a luma coding block that may be split into two may be obtained from a bitstream. The information about the luma block size difference may refer to a size difference between a luma largest coding unit and a largest luma coding block that may be split into two. Accordingly, when the information about the maximum size of the luma coding block that may be split into two and the information about the luma block size difference obtained from the bitstream are combined with each other, a size of the luma largest coding unit may be determined. A size of a chroma largest coding unit may be determined using the size of the luma largest coding unit. For example, when a Y:Cb:Cr ratio is 4:2:0 according to a color format, a size of a chroma block may be half a size of a luma block, and a size of a chroma largest coding unit may be half a size of a luma largest coding unit.

According to one or more embodiments, because information about a maximum size of a luma coding block that is binary splittable is obtained from a bitstream, the maximum size of the luma coding block that is binary splittable may be variably determined. In contrast, a maximum size of a luma coding block that is ternary splittable may be fixed. For example, the maximum size of the luma coding block that is ternary splittable in an I-picture may be 32×32, and the maximum size of the luma coding block that is ternary splittable in a P-picture or a B-picture may be 64×64.

A largest coding unit may be hierarchically split into coding units, based on split shape mode information obtained from a bitstream. At least one of information indicating whether quad splitting is performed, information indicating whether multi-splitting is performed, split direction information, and split type information may be obtained as the split shape mode information from the bitstream.

For example, the information indicating whether quad splitting is performed may indicate whether a current coding unit is quad split (QUAD_SPLIT) or not.

When the current coding unit is not quad split, the information indicating whether multi-splitting is performed may indicate whether the current coding unit is no longer split (NO_SPLIT) or binary/ternary split.

When the current coding unit is binary split or ternary split, the split direction information indicates that the current coding unit is split in one of a horizontal direction and a vertical direction.

When the current coding unit is split in the horizontal direction or the vertical direction, the split type information indicates that the current coding unit is binary split or ternary split.

A split mode of the current coding unit may be determined according to the split direction information and the split type information. A split mode when the current coding unit is binary split in the horizontal direction may be determined to be a binary horizontal split mode (SPLIT_BT_HOR), a split mode when the current coding unit is ternary split in the horizontal direction may be determined to be a ternary horizontal split mode (SPLIT_TT_HOR), a split mode when the current coding unit is binary split in the vertical direction may be determined to be a binary vertical split mode (SPLIT_BT_VER), and a split mode when the current coding unit is ternary split in the vertical direction may be determined to be a ternary vertical split mode (SPLIT_TT_VER).

The image decoding apparatus 100 may obtain, from the bitstream, the split shape mode information from one bin string. A form of the bitstream received by the image decoding apparatus 100 may include fixed length binary code, unary code, truncated unary code, pre-determined binary code, or the like. The bin string is information in a binary number. The bin string may include at least one bit. The image decoding apparatus 100 may obtain the split shape mode information corresponding to the bin string, based on the split rule. The image decoding apparatus 100 may determine whether to quad split a coding unit, whether not to split a coding unit, a split direction, and a split type, based on one bin string.

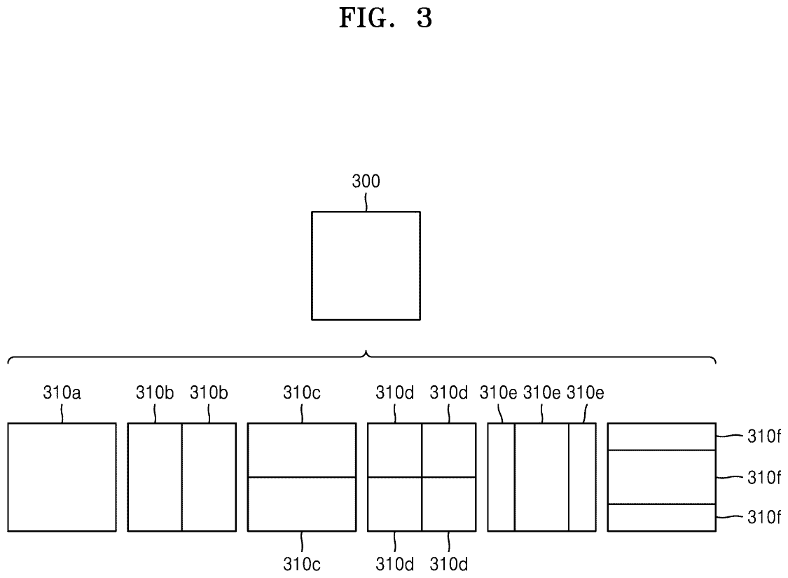

The coding unit may be smaller than or the same as the largest coding unit. For example, because a largest coding unit is a coding unit having a maximum size, the largest coding unit is one of coding units. When split shape mode information about a largest coding unit indicates that splitting is not performed, a coding unit determined in the largest coding unit has the same size as that of the largest coding unit. When split shape mode information about a largest coding unit indicates that splitting is performed, the largest coding unit may be split into coding units. Also, when split shape mode information about a coding unit indicates that splitting is performed, the coding unit may be split into smaller coding units. However, the splitting of the image is not limited thereto, and the largest coding unit and the coding unit may not be distinguished. The splitting of the coding unit will be described in detail with reference to FIGS. 3 through 16.

Also, one or more prediction blocks for prediction may be determined from a coding unit. The prediction block may be the same as or smaller than the coding unit. Also, one or more transform blocks for transformation may be determined from a coding unit. The transform block may be equal to or smaller than the coding unit.

The shapes and sizes of the transform block and prediction block may not be related to each other.

In another embodiment, prediction may be performed using a coding unit as a predictor. Also, transformation may be performed using a coding unit as a transform block.

The splitting of the coding unit will be described in detail with reference to FIGS. 3 through 16. A current block and an adjacent block of the present disclosure may indicate one of the largest coding unit, the coding unit, the prediction block, and the transform block. Also, the current block of the current coding unit is a block that is currently being decoded or encoded or a block that is currently being split. The adjacent block may be a block reconstructed before the current block. The adjacent block may be adjacent to the current block spatially or temporally. The adjacent block may be located at one of the lower left, left, upper left, top, upper right, right, lower right of the current block.

FIG. 3 illustrates a process, performed by the image decoding apparatus 100, of determining at least one coding unit by splitting a current coding unit, according to one or more embodiments.

A block shape may include 4N×4N, 4N×2N, 2N×4N, 4N×N, N×4N, 32N×N, N×32N, 16N×N, N×16N, 8N×N, or N×8N. Here, N may be a positive integer. Block shape information is information indicating at least one of a shape, a direction, a ratio of width and height, or size of a coding unit.

The shape of the coding unit may include a square and a non-square. When the lengths of the width and height of the coding unit are the same (i.e., when the block shape of the coding unit is 4N×4N), the image decoding apparatus 100 may determine the block shape information of the coding unit as a square. The image decoding apparatus 100 may determine the shape of the coding unit to be a non-square.

When the width and the height of the coding unit are different from each other (i.e., when the block shape of the coding unit is 4N×2N, 2N×4N, 4N×N, N×4N, 32N×N, N×32N, 16N×N, N×16N, 8N×N, or N×8N), the image decoding apparatus 100 may determine the block shape information of the coding unit as a non-square shape. When the shape of the coding unit is non-square, the image decoding apparatus 100 may determine the ratio of the width and height among the block shape information of the coding unit to be at least one of 1:2, 2:1, 1:4, 4:1, 1:8, 8:1, 1:16, 16:1, 1:32, and 32:1. Also, the image decoding apparatus 100 may determine whether the coding unit is in a horizontal direction or a vertical direction, based on the length of the width and the length of the height of the coding unit. Also, the image decoding apparatus 100 may determine the size of the coding unit, based on at least one of the length of the width, the length of the height, or the area of the coding unit.

According to one or more embodiments, the image decoding apparatus 100 may determine the shape of the coding unit using the block shape information, and may determine a splitting method of the coding unit using the split shape mode information. That is, a coding unit splitting method indicated by the split shape mode information may be determined based on a block shape indicated by the block shape information used by the image decoding apparatus 100.

The image decoding apparatus 100 may obtain the split shape mode information from a bitstream. However, one or more embodiments is not limited thereto, and the image decoding apparatus 100 and the image encoding apparatus 200 may determine pre-agreed split shape mode information, based on the block shape information. The image decoding apparatus 100 may determine the pre-agreed split shape mode information with respect to a largest coding unit or a minimum coding unit. For example, the image decoding apparatus 100 may determine split shape mode information with respect to the largest coding unit to be a quad split. Also, the image decoding apparatus 100 may determine split shape mode information regarding the smallest coding unit to be “not to perform splitting”. In detail, the image decoding apparatus 100 may determine the size of the largest coding unit to be 256×256. The image decoding apparatus 100 may determine the pre-agreed split shape mode information to be a quad split. The quad split is a split shape mode in which the width and the height of the coding unit are both bisected. The image decoding apparatus 100 may obtain a coding unit of a 128×128 size from the largest coding unit of a 256×256 size, based on the split shape mode information. Also, the image decoding apparatus 100 may determine the size of the smallest coding unit to be 4×4. The image decoding apparatus 100 may obtain split shape mode information indicating “not to perform splitting” with respect to the smallest coding unit.

According to one or more embodiments, the image decoding apparatus 100 may use the block shape information indicating that the current coding unit has a square shape. For example, the image decoding apparatus 100 may determine whether not to split a square coding unit, whether to vertically split the square coding unit, whether to horizontally split the square coding unit, or whether to split the square coding unit into four coding units, based on the split shape mode information. Referring to FIG. 3, when the block shape information of a current coding unit 300 indicates a square shape, the decoder 120 may not split a coding unit 310a having the same size as the current coding unit 300, based on the split shape mode information indicating not to perform splitting, or may determine coding units 310b, 310c, 310d, 310e, or 310f split based on the split shape mode information indicating a preset splitting method.

Referring to FIG. 3, according to one or more embodiments, the image decoding apparatus 100 may determine two coding units 310b obtained by splitting the current coding unit 300 in a vertical direction, based on the split shape mode information indicating to perform splitting in a vertical direction. The image decoding apparatus 100 may determine two coding units 310c obtained by splitting the current coding unit 300 in a horizontal direction, based on the split shape mode information indicating to perform splitting in a horizontal direction. The image decoding apparatus 100 may determine four coding units 310d obtained by splitting the current coding unit 300 in vertical and horizontal directions, based on the split shape mode information indicating to perform splitting in vertical and horizontal directions. According to one or more embodiments, the image decoding apparatus 100 may determine three coding units 310e obtained by splitting the current coding unit 300 in a vertical direction, based on the split shape mode information indicating to perform ternary splitting in a vertical direction. The image decoding apparatus 100 may determine three coding units 310f obtained by splitting the current coding unit 300 in a horizontal direction, based on the split shape mode information indicating to perform ternary splitting in a horizontal direction. However, splitting methods of the square coding unit are not limited to the above-described methods, and the split shape mode information may indicate various methods. Preset splitting methods of splitting the square coding unit will be described in detail below in relation to various embodiments.

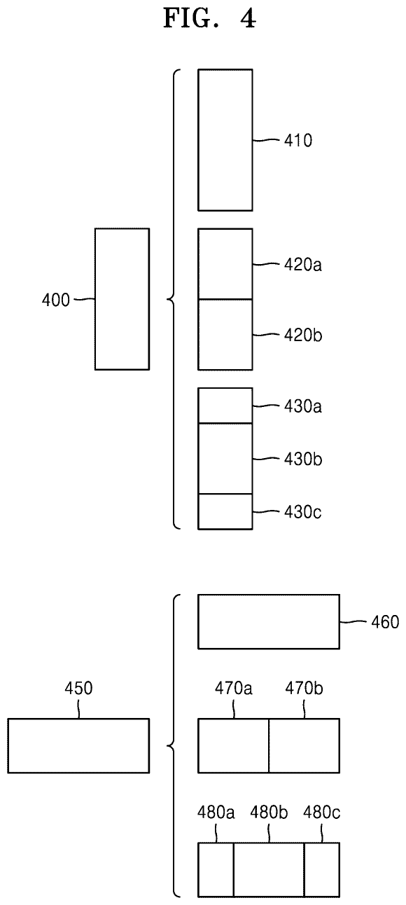

FIG. 4 illustrates a process, performed by the image decoding apparatus 100, of determining at least one coding unit by splitting a non-square coding unit, according to one or more embodiments.

According to one or more embodiments, the image decoding apparatus 100 may use block shape information indicating that a current coding unit has a non-square shape. The image decoding apparatus 100 may determine whether not to split the non-square current coding unit or whether to split the non-square current coding unit using a preset splitting method, based on split shape mode information. Referring to FIG. 4, when the block shape information of a current coding unit 400 or 450 indicates a non-square shape, the image decoding apparatus 100 may determine a coding unit 410 or 460 having the same size as the current coding unit 400 or 450, based on the split shape mode information indicating not to perform splitting, or may determine coding units 420a and 420b, 430a to 430c, 470a and 470b, or 480a to 480c split based on the split shape mode information indicating a preset splitting method. Preset splitting methods of splitting a non-square coding unit will be described in detail below in relation to various embodiments.

According to one or more embodiments, the image decoding apparatus 100 may determine a splitting method of a coding unit using the split shape mode information and, in this case, the split shape mode information may indicate the number of one or more coding units generated by splitting a coding unit. Referring to FIG. 4, when the split shape mode information indicates to split the current coding unit 400 or 450 into two coding units, the image decoding apparatus 100 may determine two coding units 420a and 420b, or 470a and 470b included in the current coding unit 400 or 450, by splitting the current coding unit 400 or 450 based on the split shape mode information.

According to one or more embodiments, when the image decoding apparatus 100 splits the current coding unit 400 or 450 having a non-square shape, based on the split shape mode information, the image decoding apparatus 100 may consider the location of a long side of the current coding unit 400 or 450 having a non-square shape to split a current coding unit. For example, the image decoding apparatus 100 may determine a plurality of coding units by splitting the current coding unit 400 or 450 in a direction of splitting a long side of the current coding unit 400 or 450, in consideration of the shape of the current coding unit 400 or 450.

According to one or more embodiments, when the split shape mode information indicates to split (ternary split) a coding unit into an odd number of blocks, the image decoding apparatus 100 may determine an odd number of coding units included in the current coding unit 400 or 450. For example, when the split shape mode information indicates to split the current coding unit 400 or 450 into three coding units, the image decoding apparatus 100 may split the current coding unit 400 or 450 into three coding units 430a, 430b, and 430c, or 480a, 480b, and 480c.

According to one or more embodiments, a ratio of the width and height of the current coding unit 400 or 450 may be 4:1 or 1:4. When the ratio of the width and height is 4:1, the block shape information may indicate a horizontal direction because the length of the width is longer than the length of the height. When the ratio of the width and height is 1:4, the block shape information may indicate a vertical direction because the length of the width is shorter than the length of the height. The image decoding apparatus 100 may determine to split a current coding unit into an odd number of blocks, based on the split shape mode information. Also, the image decoding apparatus 100 may determine a split direction of the current coding unit 400 or 450, based on the block shape information of the current coding unit 400 or 450. For example, when the current coding unit 400 is in the vertical direction, the image decoding apparatus 100 may determine the coding units 430a, 430b, and 430c by splitting the current coding unit 400 in the horizontal direction. Also, when the current coding unit 450 is in the horizontal direction, the image decoding apparatus 100 may determine the coding units 480a, 480b, and 480c by splitting the current coding unit 450 in the vertical direction.

According to one or more embodiments, the image decoding apparatus 100 may determine an odd number of coding units included in the current coding unit 400 or 450, and not all the determined coding units may have the same size. For example, a preset coding unit 430b or 480b from among the determined odd number of coding units 430a, 430b, and 430c, or 480a, 480b, and 480c may have a size different from the size of the other coding units 430a and 430c, or 480a and 480c. That is, coding units which may be determined by splitting the current coding unit 400 or 450 may have multiple sizes and, in some cases, all of the odd number of coding units 430a, 430b, and 430c, or 480a, 480b, and 480c may have different sizes.

According to one or more embodiments, when the split shape mode information indicates to split a coding unit into the odd number of blocks, the image decoding apparatus 100 may determine the odd number of coding units included in the current coding unit 400 or 450, and moreover, may put a preset restriction on at least one coding unit from among the odd number of coding units generated by splitting the current coding unit 400 or 450. Referring to FIG. 4, the image decoding apparatus 100 may set a decoding process regarding the coding unit 430b or 480b located at the center among the three coding units 430a, 430b, and 430c, or 480a, 480b, and 480c generated as the current coding unit 400 or 450 is split to be different from that of the other coding units 430a and 430c, or 480a and 480c. For example, the image decoding apparatus 100 may restrict the coding unit 430b or 480b at the center location to be no longer split or to be split only a preset number of times, unlike the other coding units 430a and 430c, or 480a and 480c.

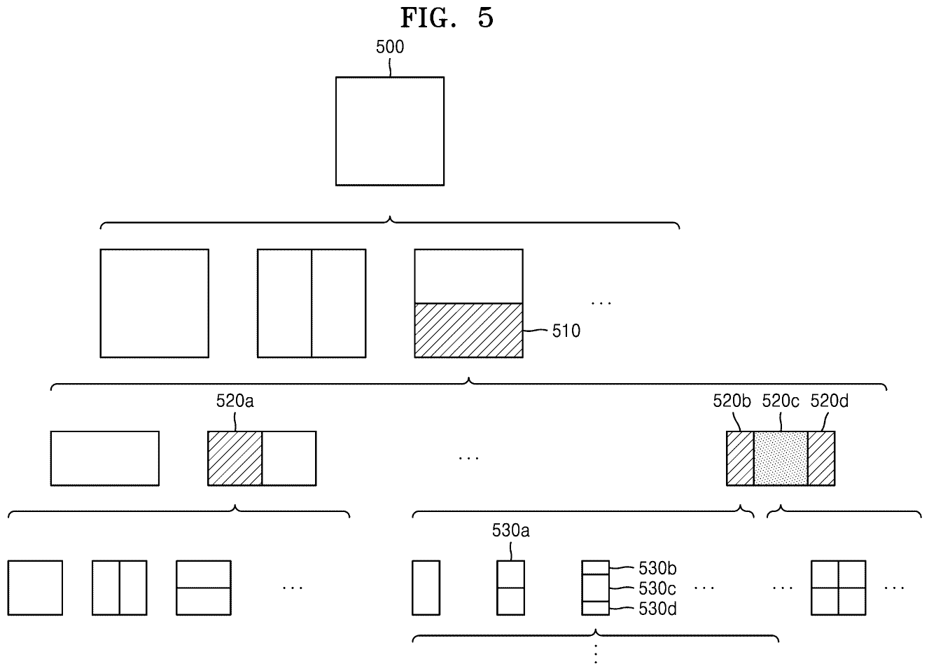

FIG. 5 illustrates a process, performed by the image decoding apparatus 100, of splitting a coding unit based on at least one of block shape information and split shape mode information, according to one or more embodiments.

According to one or more embodiments, the image decoding apparatus 100 may determine to split or to not split a first coding unit 500 having a square shape into coding units, based on at least one of the block shape information and the split shape mode information. According to one or more embodiments, when the split shape mode information indicates to split the first coding unit 500 in a horizontal direction, the image decoding apparatus 100 may determine a second coding unit 510 by splitting the first coding unit 500 in a horizontal direction. A first coding unit, a second coding unit, and a third coding unit used according to one or more embodiments are terms used to understand a relation before and after splitting a coding unit. For example, a second coding unit may be determined by splitting a first coding unit, and a third coding unit may be determined by splitting the second coding unit. It will be understood that the relation of the first coding unit, the second coding unit, and the third coding unit follows the above descriptions.

According to one or more embodiments, the image decoding apparatus 100 may determine to split or to not split the determined second coding unit 510 into coding units, based on the split shape mode information. Referring to FIG. 5, the image decoding apparatus 100 may split the second coding unit 510 having a non-square shape, which is determined by splitting the first coding unit 500, into one or more third coding units 520a, 520b, 520c, and 520d based on at least one of the split shape mode information and the split shape mode information, or may not split the second coding unit 510 having a non-square shape. The image decoding apparatus 100 may obtain the split shape mode information, and may obtain a plurality of various-shaped second coding units (e.g., 510) by splitting the first coding unit 500, based on the obtained split shape mode information, and the second coding unit 510 may be split using a splitting method of the first coding unit 500 based on the split shape mode information. According to one or more embodiments, when the first coding unit 500 is split into the second coding units 510 based on the split shape mode information of the first coding unit 500, the second coding unit 510 may also be split into the third coding units (e.g., 520a, or 520b, 520c, and 520d) based on the split shape mode information of the second coding unit 510. That is, a coding unit may be recursively split based on the split shape mode information of each coding unit. Therefore, a coding unit having a square shape may be determined by splitting a coding unit having a non-square shape, and the coding unit having a non-square shape may be determined by recursively splitting the coding unit having a square shape.

Referring to FIG. 5, a preset coding unit (e.g., a coding unit located at a center location, or a coding unit having a square shape) from among an odd number of third coding units 520b, 520c, and 520d determined by splitting the second coding unit 510 having a non-square shape may be recursively split. According to one or more embodiments, the square third coding unit 520c from among the odd number of third coding units 520b, 520c, and 520d may be split in a horizontal direction into a plurality of fourth coding units. A fourth coding unit 530b or 530d having a non-square shape from among a plurality of fourth coding units 530a, 530b, 530c, and 530d may be re-split into a plurality of coding units. For example, the fourth coding unit 530b or 530d having a non-square shape may be re-split into an odd number of coding units. A method that may be used to recursively split a coding unit will be described below in relation to various embodiments.

According to one or more embodiments, the image decoding apparatus 100 may split each of the third coding units 520a, or 520b, 520c, and 520d into coding units, based on the split shape mode information. Also, the image decoding apparatus 100 may determine to not split the second coding unit 510 based on the split shape mode information. According to one or more embodiments, the image decoding apparatus 100 may split the second coding unit 510 having a non-square shape into the odd number of third coding units 520b, 520c, and 520d. The image decoding apparatus 100 may put a preset restriction on a preset third coding unit from among the odd number of third coding units 520b, 520c, and 520d. For example, the image decoding apparatus 100 may restrict the third coding unit 520c at a center location from among the odd number of third coding units 520b, 520c, and 520d to be no longer split or to be split a settable number of times.

Referring to FIG. 5, the image decoding apparatus 100 may restrict the third coding unit 520c, which is at the center location from among the odd number of third coding units 520b, 520c, and 520d included in the non-square second coding unit 510, to be no longer split, to be split using a preset splitting method (e.g., split into only four coding units or split using a splitting method of the second coding unit 510), or to be split only a preset number of times (e.g., split only n times (where n>0)). However, the restrictions on the third coding unit 520c at the center location are not limited to the above-described examples, and may include various restrictions for decoding the third coding unit 520c at the center location differently from the other third coding units 520b and 520d.

According to one or more embodiments, the image decoding apparatus 100 may obtain the split shape mode information, which is used to split a current coding unit, from a preset location in the current coding unit.

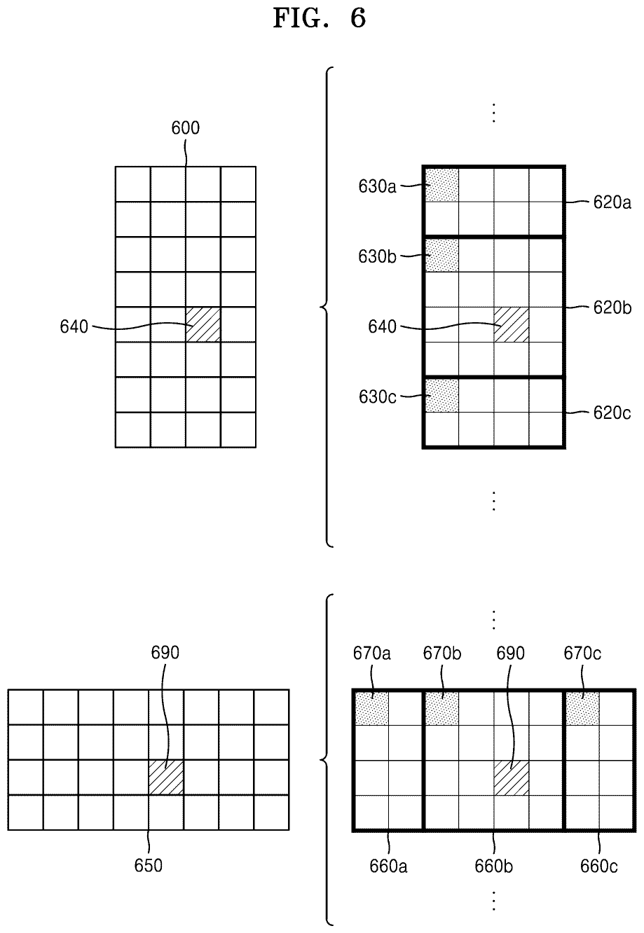

FIG. 6 illustrates a method, performed by the image decoding apparatus 100, of determining a preset coding unit from among an odd number of coding units, according to one or more embodiments.

Referring to FIG. 6, split shape mode information of a current coding unit 600 or 650 may be obtained from a sample of a preset location (e.g., a sample 640 or 690 of a center location) from among a plurality of samples included in the current coding unit 600 or 650. However, the preset location in the current coding unit 600, from which at least one piece of the split shape mode information may be obtained, is not limited to the center location in FIG. 6, and may include various locations included in the current coding unit 600 (e.g., top, bottom, left, right, upper left, lower left, upper right, lower right locations, or the like). The image decoding apparatus 100 may obtain the split shape mode information from the preset location and may determine to split or to not split the current coding unit into various-shaped and various-sized coding units.

According to one or more embodiments, when the current coding unit is split into a preset number of coding units, the image decoding apparatus 100 may select one of the coding units. Various methods may be used to select one of a plurality of coding units, as will be described below in relation to various embodiments.

According to one or more embodiments, the image decoding apparatus 100 may split the current coding unit into a plurality of coding units, and may determine a coding unit at a preset location.

According to one or more embodiments, image decoding apparatus 100 may use information indicating locations of the odd number of coding units, to determine a coding unit at a center location from among the odd number of coding units. Referring to FIG. 6, the image decoding apparatus 100 may determine the odd number of coding units 620a, 620b, and 620c or the odd number of coding units 660a, 660b, and 660c by splitting the current coding unit 600 or the current coding unit 650. The image decoding apparatus 100 may determine the middle coding unit 620b or the middle coding unit 660b using information about the locations of the odd number of coding units 620a, 620b, and 620c or the odd number of coding units 660a, 660b, and 660c. For example, the image decoding apparatus 100 may determine the coding unit 620b of the center location by determining the locations of the coding units 620a, 620b, and 620c based on information indicating locations of preset samples included in the coding units 620a, 620b, and 620c. In detail, the image decoding apparatus 100 may determine the coding unit 620b at the center location by determining the locations of the coding units 620a, 620b, and 620c based on information indicating locations of upper-left samples 630a, 630b, and 630c of the coding units 620a, 620b, and 620c.

According to one or more embodiments, the information indicating the locations of the upper-left samples 630a, 630b, and 630c, which are included in the coding units 620a, 620b, and 620c, respectively, may include information about locations or coordinates of the coding units 620a, 620b, and 620c in a picture. According to one or more embodiments, the information indicating the locations of the upper-left samples 630a, 630b, and 630c, which are included in the coding units 620a, 620b, and 620c, respectively, may include information indicating widths or heights of the coding units 620a, 620b, and 620c included in the current coding unit 600, and the widths or heights may correspond to information indicating differences between the coordinates of the coding units 620a, 620b, and 620c in the picture. That is, the image decoding apparatus 100 may determine the coding unit 620b at the center location by directly using the information about the locations or coordinates of the coding units 620a, 620b, and 620c in the picture, or using the information about the widths or heights of the coding units, which correspond to the difference values between the coordinates.

According to one or more embodiments, information indicating the location of the upper-left sample 630a of the upper coding unit 620a may include coordinates (xa, ya), information indicating the location of the upper-left sample 630b of the center coding unit 620b may include coordinates (xb, yb), and information indicating the location of the upper-left sample 630c of the lower coding unit 620c may include coordinates (xc, yc). The image decoding apparatus 100 may determine the middle coding unit 620b using the coordinates of the upper-left samples 630a, 630b, and 630c which are included in the coding units 620a, 620b, and 620c, respectively. For example, when the coordinates of the upper-left samples 630a, 630b, and 630c are sorted in an ascending or descending order, the coding unit 620b including the coordinates (xb, yb) of the sample 630b at a center location may be determined as a coding unit at a center location from among the coding units 620a, 620b, and 620c determined by splitting the current coding unit 600. However, the coordinates indicating the locations of the upper-left samples 630a, 630b, and 630c may include coordinates indicating absolute locations in the picture, or may use coordinates (dxb, dyb) indicating a relative location of the upper-left sample 630b of the middle coding unit 620b and coordinates (dxc, dyc) indicating a relative location of the upper-left sample 630c of the lower coding unit 620c with reference to the location of the upper-left sample 630a of the upper coding unit 620a. A method of determining a coding unit at a preset location using coordinates of a sample included in the coding unit, as information indicating a location of the sample, is not limited to the above-described method, and may include various arithmetic methods capable of using the coordinates of the sample.

According to one or more embodiments, the image decoding apparatus 100 may split the current coding unit 600 into a plurality of coding units 620a, 620b, and 620c, and may select one of the coding units 620a, 620b, and 620c based on a preset criterion. For example, the image decoding apparatus 100 may select the coding unit 620b, which has a size different from that of the others, from among the coding units 620a, 620b, and 620c.

According to one or more embodiments, the image decoding apparatus 100 may determine the width or height of each of the coding units 620a, 620b, and 620c using the coordinates (xa, ya) that is the information indicating the location of the upper-left sample 630a of the upper coding unit 620a, the coordinates (xb, yb) that is the information indicating the location of the upper-left sample 630b of the middle coding unit 620b, and the coordinates (xc, yc) that are the information indicating the location of the upper-left sample 630c of the lower coding unit 620c. The image decoding apparatus 100 may determine the respective sizes of the coding units 620a, 620b, and 620c using the coordinates (xa, ya), (xb, yb), and (xc, yc) indicating the locations of the coding units 620a, 620b, and 620c. According to one or more embodiments, the image decoding apparatus 100 may determine the width of the upper coding unit 620a to be the width of the current coding unit 600. The image decoding apparatus 100 may determine the height of the upper coding unit 620a to be yb-ya. According to one or more embodiments, the image decoding apparatus 100 may determine the width of the middle coding unit 620b to be the width of the current coding unit 600. The image decoding apparatus 100 may determine the height of the middle coding unit 620b to be yc-yb. According to one or more embodiments, the image decoding apparatus 100 may determine the width or height of the lower coding unit 620c using the width or height of the current coding unit 600 or the widths or heights of the upper and middle coding units 620a and 620b. The image decoding apparatus 100 may determine a coding unit, which has a size different from that of the others, based on the determined widths and heights of the coding units 620a, 620b, and 620c. Referring to FIG. 6, the image decoding apparatus 100 may determine the middle coding unit 620b, which has a size different from the size of the upper and lower coding units 620a and 620c, as the coding unit of the preset location. However, the above-described method, performed by the image decoding apparatus 100, of determining a coding unit having a size different from the size of the other coding units merely corresponds to an example of determining a coding unit at a preset location using the sizes of coding units, which are determined based on coordinates of samples, and thus various methods of determining a coding unit at a preset location by comparing the sizes of coding units, which are determined based on coordinates of preset samples, may be used.

The image decoding apparatus 100 may determine the width or height of each of the coding units 660a, 660b, and 660c using the coordinates (xd, yd) that are information indicating the location of an upper-left sample 670a of the left coding unit 660a, the coordinates (xe, ye) that are information indicating the location of an upper-left sample 670b of the middle coding unit 660b, and the coordinates (xf, yf) that are information indicating a location of the upper-left sample 670c of the right coding unit 660c. The image decoding apparatus 100 may determine the respective sizes of the coding units 660a, 660b, and 660c using the coordinates (xd, yd), (xe, ye), and (xf, yf) indicating the locations of the coding units 660a, 660b, and 660c.

According to one or more embodiments, the image decoding apparatus 100 may determine the width of the left coding unit 660a to be xe-xd. The image decoding apparatus 100 may determine the height of the left coding unit 660a to be the height of the current coding unit 650. According to one or more embodiments, the image decoding apparatus 100 may determine the width of the middle coding unit 660b to be xf-xe. The image decoding apparatus 100 may determine the height of the middle coding unit 660b to be the height of the current coding unit 650. According to one or more embodiments, the image decoding apparatus 100 may determine the width or height of the right coding unit 660c using the width or height of the current coding unit 650 or the widths or heights of the left and middle coding units 660a and 660b. The image decoding apparatus 100 may determine a coding unit, which has a size different from that of the others, based on the determined widths and heights of the coding units 660a, 660b, and 660c. Referring to FIG. 6, the image decoding apparatus 100 may determine the middle coding unit 660b, which has a size different from the sizes of the left and right coding units 660a and 660c, as the coding unit of the preset location. However, the above-described method, performed by the image decoding apparatus 100, of determining a coding unit having a size different from the size of the other coding units merely corresponds to an example of determining a coding unit at a preset location using the sizes of coding units, which are determined based on coordinates of samples, and thus various methods of determining a coding unit at a preset location by comparing the sizes of coding units, which are determined based on coordinates of preset samples, may be used.

However, locations of samples considered to determine locations of coding units are not limited to the above-described upper left locations, and information about arbitrary locations of samples included in the coding units may be used.

According to one or more embodiments, the image decoding apparatus 100 may select a coding unit at a preset location from among an odd number of coding units determined by splitting the current coding unit, considering the shape of the current coding unit. For example, when the current coding unit has a non-square shape, a width of which is longer than a height, the image decoding apparatus 100 may determine the coding unit at the preset location in a horizontal direction. That is, the image decoding apparatus 100 may determine one of coding units at different locations in a horizontal direction and may put a restriction on the coding unit. When the current coding unit has a non-square shape, a height of which is longer than a width, the image decoding apparatus 100 may determine the coding unit at the preset location in a vertical direction. That is, the image decoding apparatus 100 may determine one of coding units at different locations in a vertical direction and may put a restriction on the coding unit.

According to one or more embodiments, the image decoding apparatus 100 may use information indicating respective locations of an even number of coding units, to determine the coding unit at the preset location from among the even number of coding units. The image decoding apparatus 100 may determine an even number of coding units by splitting (binary splitting) the current coding unit, and may determine the coding unit at the preset location using the information about the locations of the even number of coding units. An operation related thereto may correspond to the operation of determining a coding unit at a preset location (e.g., a center location) from among an odd number of coding units, which has been described in detail above in relation to FIG. 6, and thus detailed descriptions thereof are not provided here.

According to one or more embodiments, when a non-square current coding unit is split into a plurality of coding units, preset information about a coding unit at a preset location may be used in a splitting operation to determine the coding unit at the preset location from among the plurality of coding units. For example, the image decoding apparatus 100 may use at least one of block shape information and split shape mode information, which is stored in a sample included in a middle coding unit, in a splitting operation to determine a coding unit at a center location from among the plurality of coding units determined by splitting the current coding unit.

Referring to FIG. 6, the image decoding apparatus 100 may split the current coding unit 600 into the plurality of coding units 620a, 620b, and 620c based on the split shape mode information, and may determine the coding unit 620b at a center location from among the plurality of coding units 620a, 620b, and 620c. Furthermore, the image decoding apparatus 100 may determine the coding unit 620b at the center location, in consideration of a location from which the split shape mode information is obtained. That is, the split shape mode information of the current coding unit 600 may be obtained from the sample 640 at a center location of the current coding unit 600 and, when the current coding unit 600 is split into the plurality of coding units 620a, 620b, and 620c based on the split shape mode information, the coding unit 620b including the sample 640 may be determined as the coding unit at the center location. However, information used to determine the coding unit at the center location is not limited to the split shape mode information, and various types of information may be used to determine the coding unit at the center location.

According to one or more embodiments, preset information for identifying the coding unit at the preset location may be obtained from a preset sample included in a coding unit to be determined. Referring to FIG. 6, the image decoding apparatus 100 may use the split shape mode information, which is obtained from a sample at a preset location in the current coding unit 600 (e.g., a sample at a center location of the current coding unit 600) to determine a coding unit at a preset location from among the plurality of coding units 620a, 620b, and 620c determined by splitting the current coding unit 600 (e.g., a coding unit at a center location from among a plurality of split coding units). That is, the image decoding apparatus 100 may determine the sample at the preset location by considering a block shape of the current coding unit 600, may determine the coding unit 620b including a sample, from which preset information (e.g., the split shape mode information) can be obtained, from among the plurality of coding units 620a, 620b, and 620c determined by splitting the current coding unit 600, and may put a preset restriction on the coding unit 620b. Referring to FIG. 6, according to one or more embodiments, the image decoding apparatus 100 may determine the sample 640 at the center location of the current coding unit 600 as the sample from which the preset information may be obtained, and may put a preset restriction on the coding unit 620b including the sample 640, in a decoding operation. However, the location of the sample from which the preset information can be obtained is not limited to the above-described location, and may include arbitrary locations of samples included in the coding unit 620b to be determined for a restriction.

According to one or more embodiments, the location of the sample from which the preset information may be obtained may be determined based on the shape of the current coding unit 600. According to one or more embodiments, the block shape information may indicate whether the current coding unit has a square or non-square shape, and the location of the sample from which the preset information may be obtained may be determined based on the shape. For example, the image decoding apparatus 100 may determine a sample located on a boundary for splitting at least one of a width and height of the current coding unit in half, as the sample from which the preset information can be obtained, using at least one of information about the width of the current coding unit and information about the height of the current coding unit. As another example, when the block shape information of the current coding unit indicates a non-square shape, the image decoding apparatus 100 may determine one of samples adjacent to a boundary for splitting a long side of the current coding unit in half, as the sample from which the preset information can be obtained.

According to one or more embodiments, when the current coding unit is split into a plurality of coding units, the image decoding apparatus 100 may use the split shape mode information to determine a coding unit at a preset location from among the plurality of coding units. According to one or more embodiments, the image decoding apparatus 100 may obtain the split shape mode information from a sample at a preset location in a coding unit, and may split the plurality of coding units, which are generated by splitting the current coding unit, using the split shape mode information, which is obtained from the sample of the preset location in each of the plurality of coding units. That is, a coding unit may be recursively split based on the split shape mode information, which is obtained from the sample at the preset location in each coding unit. An operation of recursively splitting a coding unit has been described above in relation to FIG. 5, and thus detailed descriptions thereof will not be provided here.

According to one or more embodiments, the image decoding apparatus 100 may determine one or more coding units by splitting the current coding unit, and may determine an order of decoding the one or more coding units, based on a preset block (e.g., the current coding unit).

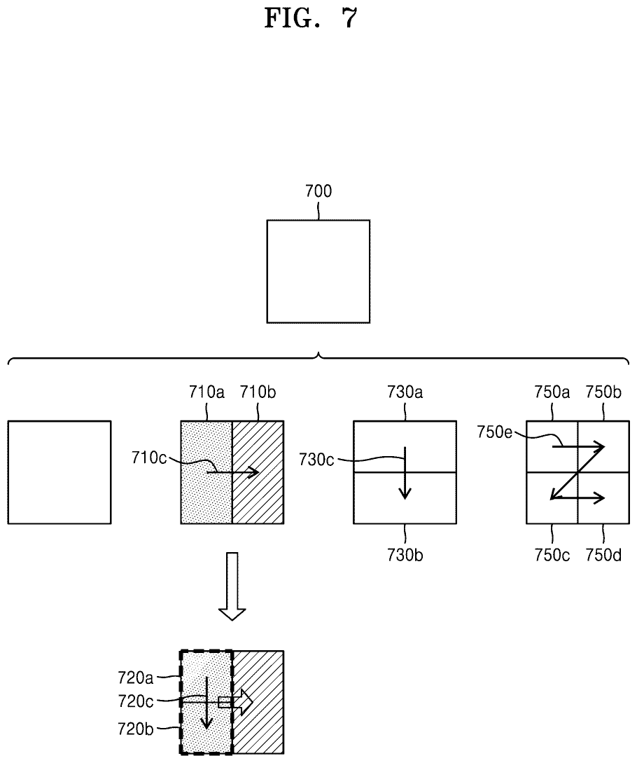

FIG. 7 illustrates an order of processing a plurality of coding units when the image decoding apparatus 100 determines the plurality of coding units by splitting a current coding unit, according to one or more embodiments.

According to one or more embodiments, the image decoding apparatus 100 may determine second coding units 710a and 710b by splitting a first coding unit 700 in a vertical direction, may determine second coding units 730a and 730b by splitting the first coding unit 700 in a horizontal direction, or may determine second coding units 750a, 750b, 750c, and 750d by splitting the first coding unit 700 in vertical and horizontal directions, based on split shape mode information.

Referring to FIG. 7, the image decoding apparatus 100 may determine to process the second coding units 710a and 710b, which are determined by splitting the first coding unit 700 in a vertical direction, in a horizontal direction order 710c. The image decoding apparatus 100 may determine to process the second coding units 730a and 730b, which are determined by splitting the first coding unit 700 in a horizontal direction, in a vertical direction order 730c. The image decoding apparatus 100 may determine the second coding units 750a, 750b, 750c, and 750d, which are determined by splitting the first coding unit 700 in vertical and horizontal directions, according to a preset order (e.g., a raster scan order or Z-scan order 750e) by which coding units in a row are processed and then coding units in a next row are processed.

According to one or more embodiments, the image decoding apparatus 100 may recursively split coding units. Referring to FIG. 7, the image decoding apparatus 100 may determine the plurality of coding units 710a and 710b, 730a and 730b, or 750a, 750b, 750c, and 750d by splitting the first coding unit 700, and may recursively split each of the determined plurality of coding units 710a, 710b, 730a, 730b, 750a, 750b, 750c, and 750d. A splitting method of the plurality of coding units 710a and 710b, 730a and 730b, or 750a, 750b, 750c, and 750d may correspond to a splitting method of the first coding unit 700. Accordingly, each of the plurality of coding units 710a and 710b, 730a and 730b, or 750a, 750b, 750c, and 750d may be independently split into a plurality of coding units. Referring to FIG. 7, the image decoding apparatus 100 may determine the second coding units 710a and 710b by splitting the first coding unit 700 in a vertical direction, and may determine to independently split or to not split each of the second coding units 710a and 710b.

According to one or more embodiments, the image decoding apparatus 100 may determine third coding units 720a and 720b by splitting the left second coding unit 710a in a horizontal direction, and may not split the right second coding unit 710b.

According to one or more embodiments, a processing order of coding units may be determined based on an operation of splitting a coding unit. In other words, a processing order of split coding units may be determined based on a processing order of coding units immediately before being split. The image decoding apparatus 100 may determine a processing order of the third coding units 720a and 720b determined by splitting the left second coding unit 710a, independently of the right second coding unit 710b. Because the third coding units 720a and 720b are determined by splitting the left second coding unit 710a in a horizontal direction, the third coding units 720a and 720b may be processed in a vertical direction order 720c. Because the left and right second coding units 710a and 710b are processed in the horizontal direction order 710c, the right second coding unit 710b may be processed after the third coding units 720a and 720b included in the left second coding unit 710a are processed in the vertical direction order 720c. An operation of determining a processing order of coding units based on a coding unit before being split is not limited to the above-described example, and various methods may be used to independently process coding units, which are split and determined to various shapes, in a preset order.

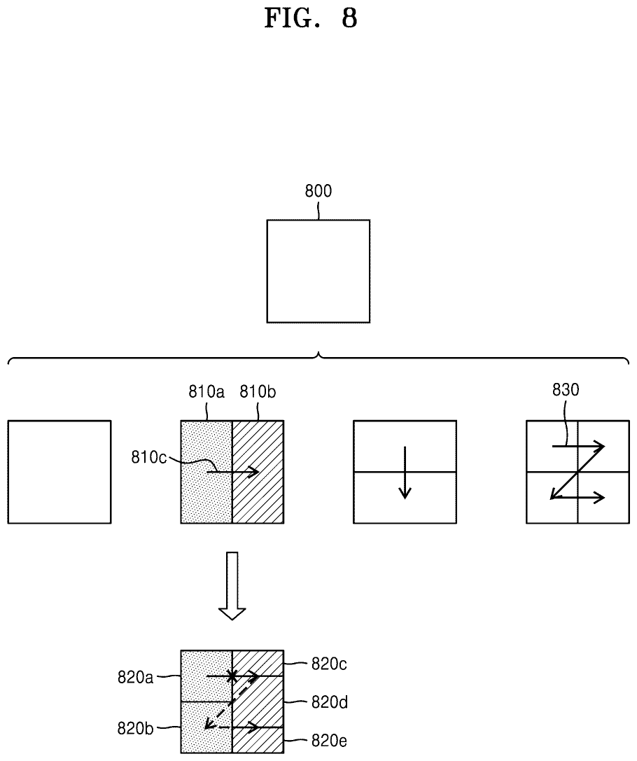

FIG. 8 illustrates a process, performed by the image decoding apparatus 100, of determining that a current coding unit is to be split into an odd number of coding units, when the coding units are not processable in a preset order, according to one or more embodiments.

According to one or more embodiments, the image decoding apparatus 100 may determine that the current coding unit is to be split into an odd number of coding units, based on obtained split shape mode information. Referring to FIG. 8, a square first coding unit 800 may be split into non-square second coding units 810a and 810b, and the second coding units 810a and 810b may be independently split into third coding units 820a and 820b, and 820c, 820d, and 820e. According to one or more embodiments, the image decoding apparatus 100 may determine the plurality of third coding units 820a and 820b by splitting the left second coding unit 810a in a horizontal direction, and may split the right second coding unit 810b into the odd number of third coding units 820c, 820d, and 820e.

According to one or more embodiments, the video decoding apparatus 100 may determine whether any coding unit is split into an odd number of coding units, by determining whether the third coding units 820a and 820b, and 820c, 820d, and 820e are processable in a preset order. Referring to FIG. 8, the image decoding apparatus 100 may determine the third coding units 820a and 820b, and 820c, 820d, and 820e by recursively splitting the first coding unit 800. The image decoding apparatus 100 may determine whether any of the first coding unit 800, the second coding units 810a and 810b, or the third coding units 820a and 820b, and 820c, 820d, and 820e are split into an odd number of coding units, based on at least one of the block shape information and the split shape mode information. For example, a coding unit located in the right from among the second coding units 810a and 810b may be split into an odd number of third coding units 820c, 820d, and 820e. A processing order of a plurality of coding units included in the first coding unit 800 may be a preset order (e.g., a Z-scan order 830), and the image decoding apparatus 100 may determine whether the third coding units 820c, 820d, and 820e, which are determined by splitting the right second coding unit 810b into an odd number of coding units, satisfy a condition for processing in the preset order.

According to one or more embodiments, the image decoding apparatus 100 may determine whether the third coding units 820a and 820b, and 820c, 820d, and 820e included in the first coding unit 800 satisfy the condition for processing in the preset order, and the condition relates to whether at least one of a width and height of the second coding units 810a and 810b is to be split in half along a boundary of the third coding units 820a and 820b, and 820c, 820d, and 820e. For example, the third coding units 820a and 820b determined when the height of the left second coding unit 810a of the non-square shape is split in half may satisfy the condition. It may be determined that the third coding units 820c, 820d, and 820e do not satisfy the condition because the boundaries of the third coding units 820c, 820d, and 820e determined when the right second coding unit 810b is split into three coding units are unable to split the width or height of the right second coding unit 810b in half. When the condition is not satisfied as described above, the image decoding apparatus 100 may determine disconnection of a scan order, and may determine that the right second coding unit 810b is to be split into an odd number of coding units, based on a result of the determination. According to one or more embodiments, when a coding unit is split into an odd number of coding units, the image decoding apparatus 100 may put a preset restriction on a coding unit at a preset location from among the split coding units. The restriction or the preset location has been described above in relation to various embodiments, and thus detailed descriptions thereof will not be provided herein.

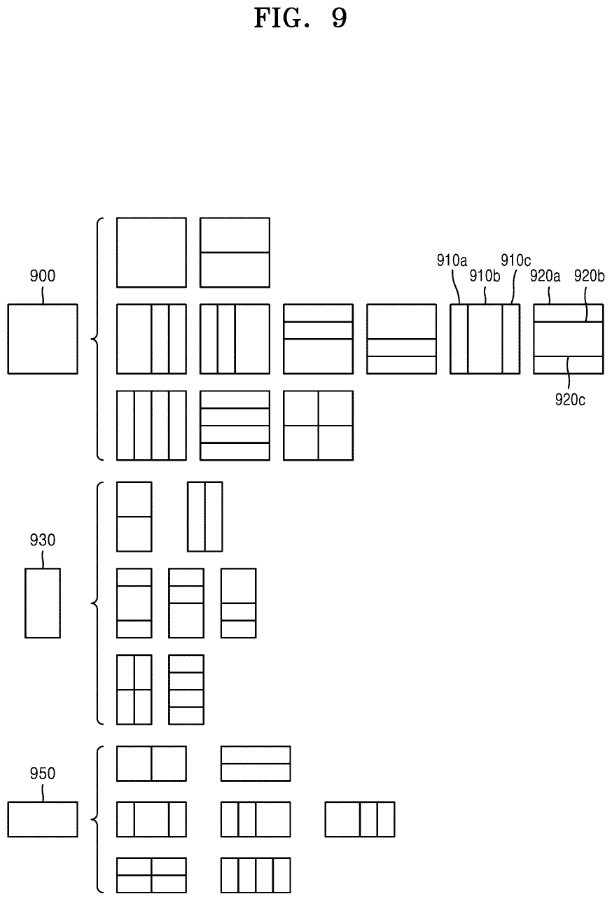

FIG. 9 illustrates a process, performed by the image decoding apparatus 100, of determining at least one coding unit by splitting a first coding unit 900, according to one or more embodiments.

According to one or more embodiments, the image decoding apparatus 100 may split the first coding unit 900, based on split shape mode information, which is obtained through the bitstream obtainer 110. The square first coding unit 900 may be split into four square coding units, or may be split into a plurality of non-square coding units. For example, referring to FIG. 9, when the first coding unit 900 has a square shape and the split shape mode information indicates to split the first coding unit 900 into non-square coding units, the image decoding apparatus 100 may split the first coding unit 900 into a plurality of non-square coding units. In detail, when the split shape mode information indicates to determine an odd number of coding units by splitting the first coding unit 900 in a horizontal direction or a vertical direction, the image decoding apparatus 100 may split the square first coding unit 900 into an odd number of coding units, e.g., second coding units 910a, 910b, and 910c determined by splitting the square first coding unit 900 in a vertical direction or second coding units 920a, 920b, and 920c determined by splitting the square first coding unit 900 in a horizontal direction.

According to one or more embodiments, the image decoding apparatus 100 may determine whether the second coding units 910a, 910b, 910c, 920a, 920b, and 920c included in the first coding unit 900 satisfy a condition for processing in a preset order, and the condition relates to whether at least one of a width and height of the first coding unit 900 is to be split in half along a boundary of the second coding units 910a, 910b, 910c, 920a, 920b, and 920c. Referring to FIG. 9, because boundaries of the second coding units 910a, 910b, and 910c determined by splitting the square first coding unit 900 in a vertical direction do not split the width of the first coding unit 900 in half, it may be determined that the first coding unit 900 does not satisfy the condition for processing in the preset order. Also, because boundaries of the second coding units 920a, 920b, and 920c determined by splitting the square first coding unit 900 in a horizontal direction do not split the height of the first coding unit 900 in half, it may be determined that the first coding unit 900 does not satisfy the condition for processing in the preset order. When the condition is not satisfied as described above, the image decoding apparatus 100 may decide disconnection of a scan order, and may determine that the first coding unit 900 is to be split into an odd number of coding units, based on a result of the decision. According to one or more embodiments, when a coding unit is split into an odd number of coding units, the image decoding apparatus 100 may put a preset restriction on a coding unit at a preset location from among the split coding units. The restriction or the preset location has been described above in relation to various embodiments, and thus detailed descriptions thereof will not be provided herein.

According to one or more embodiments, the image decoding apparatus 100 may determine various-shaped coding units by splitting a first coding unit.

Referring to FIG. 9, the image decoding apparatus 100 may split the square first coding unit 900 or a non-square first coding unit 930 or 950 into various-shaped coding units.

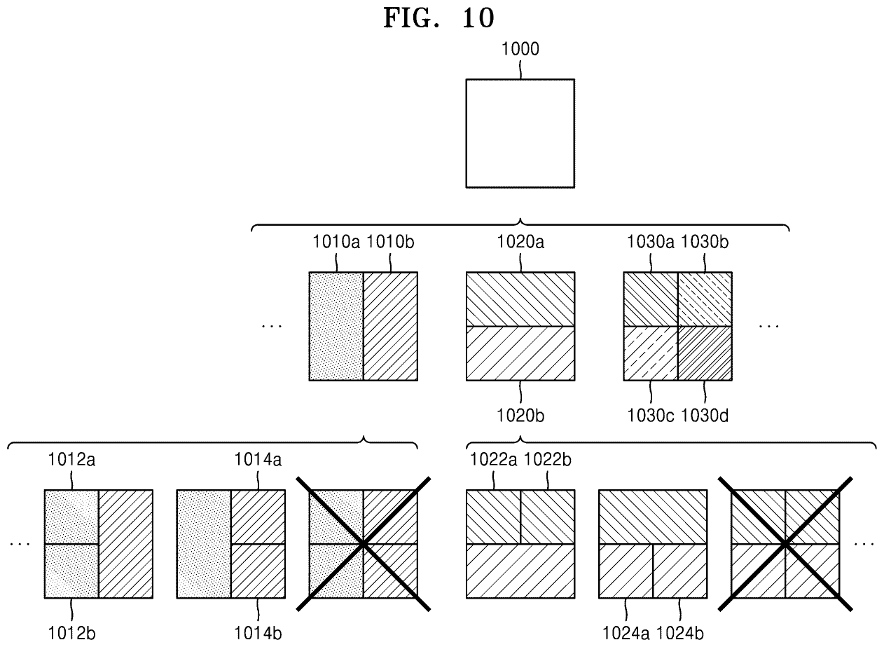

FIG. 10 illustrates that a shape into which a second coding unit is splittable is restricted when the second coding unit having a non-square shape, which is determined when the image decoding apparatus 100 splits a first coding unit 1000, satisfies a preset condition, according to one or more embodiments.

According to one or more embodiments, the image decoding apparatus 100 may determine to split the square first coding unit 1000 into non-square second coding units 1010a, and 1010b or 1020a and 1020b, based on split shape mode information, which is obtained by the bitstream obtainer 110. The second coding units 1010a and 1010b, or 1020a and 1020b may be independently split. As such, the image decoding apparatus 100 may determine to split or to not split each of the second coding units 1010a and 1010b, or 1020a and 1020b into a plurality of coding units, based on the split shape mode information of each of the second coding units 1010a and 1010b, or 1020a and 1020b. According to one or more embodiments, the image decoding apparatus 100 may determine third coding units 1012a and 1012b by splitting the non-square left second coding unit 1010a, which is determined by splitting the first coding unit 1000 in a vertical direction, in a horizontal direction. However, when the left second coding unit 1010a is split in a horizontal direction, the image decoding apparatus 100 may restrict the right second coding unit 1010b to not be split in a horizontal direction in which the left second coding unit 1010a is split. When third coding units 1014a and 1014b are determined by splitting the right second coding unit 1010b in a same direction, because the left and right second coding units 1010a and 1010b are independently split in a horizontal direction, the third coding units 1012a and 1012b, or 1014a and 1014b may be determined. However, this case serves equally as a case in which the image decoding apparatus 100 splits the first coding unit 1000 into four square second coding units 1030a, 1030b, 1030c, and 1030d, based on the split shape mode information, and may be inefficient in terms of image decoding.

According to one or more embodiments, the image decoding apparatus 100 may determine third coding units 1022a and 1022b, or 1024a and 1024b by splitting the non-square second coding unit 1020a or 1020b, which is determined by splitting the first coding unit 1000 in a horizontal direction, in a vertical direction. However, when a second coding unit (e.g., the upper second coding unit 1020a) is split in a vertical direction, for the above-described reason, the image decoding apparatus 100 may restrict the other second coding unit (e.g., the lower second coding unit 1020b) to not be split in a vertical direction in which the upper second coding unit 1020a is split.

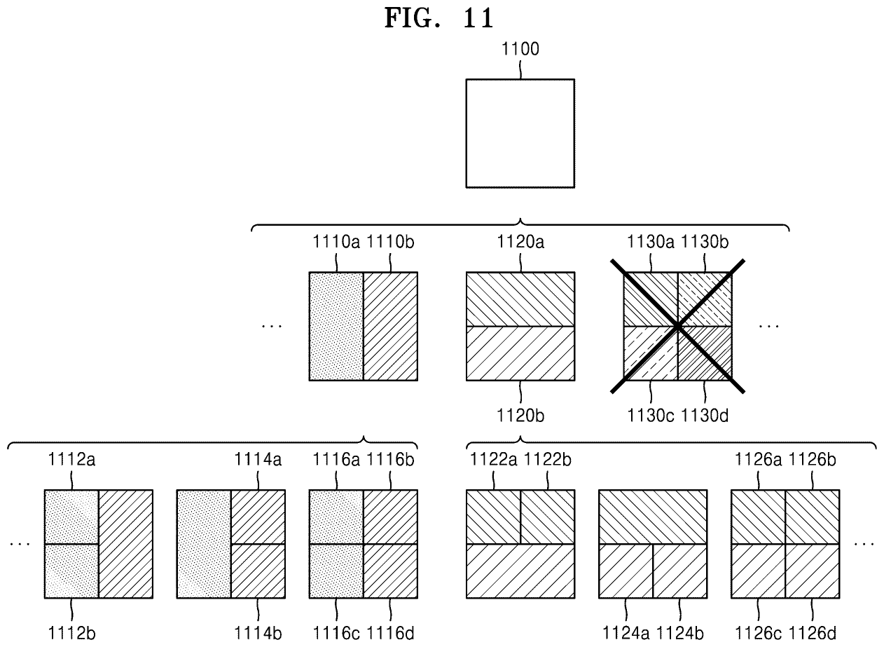

FIG. 11 illustrates a process, performed by the image decoding apparatus 100, of splitting a square coding unit when split shape mode information indicates that the square coding unit is to not be split into four square coding units, according to one or more embodiments.

According to one or more embodiments, the image decoding apparatus 100 may determine second coding units 1110a and 1110b, or 1120a and 1120b, etc. by splitting a first coding unit 1100, based on split shape mode information. The split shape mode information may include information about various methods of splitting a coding unit, but the information about various splitting methods may not include information for splitting a coding unit into four square coding units. According to such split shape mode information, the image decoding apparatus 100 may not split the square first coding unit 1100 into four square second coding units 1130a, 1130b, 1130c, and 1130d. The image decoding apparatus 100 may determine the non-square second coding units 1110a and 1110b, or 1120a and 1120b, etc., based on the split shape mode information.

According to one or more embodiments, the image decoding apparatus 100 may independently split the non-square second coding units 1110a and 1110b, or 1120a and 1120b, etc. Each of the second coding units 1110a and 1110b, or 1120a and 1120b, etc. may be recursively split in a preset order, and this splitting method may correspond to a method of splitting the first coding unit 1100, based on the split shape mode information.

For example, the image decoding apparatus 100 may determine square third coding units 1112a and 1112b by splitting the left second coding unit 1110a in a horizontal direction, and may determine square third coding units 1114a and 1114b by splitting the right second coding unit 1110b in a horizontal direction. Furthermore, the image decoding apparatus 100 may determine square third coding units 1116a, 1116b, 1116c, and 1116d by splitting both of the left and right second coding units 1110a and 1110b in a horizontal direction. In this case, coding units having the same shape as the four square second coding units 1130a, 1130b, 1130c, and 1130d split from the first coding unit 1100 may be determined.

As another example, the image decoding apparatus 100 may determine square third coding units 1122a and 1122b by splitting the upper second coding unit 1120a in a vertical direction, and may determine square third coding units 1124a and 1124b by splitting the lower second coding unit 1120b in a vertical direction. Furthermore, the image decoding apparatus 100 may determine square third coding units 1126a, 1126b, 1126c, and 1126d by splitting both the upper and lower second coding units 1120a and 1120b in a vertical direction. In this case, coding units having the same shape as the four square second coding units 1130a, 1130b, 1130c, and 1130d split from the first coding unit 1100 may be determined.

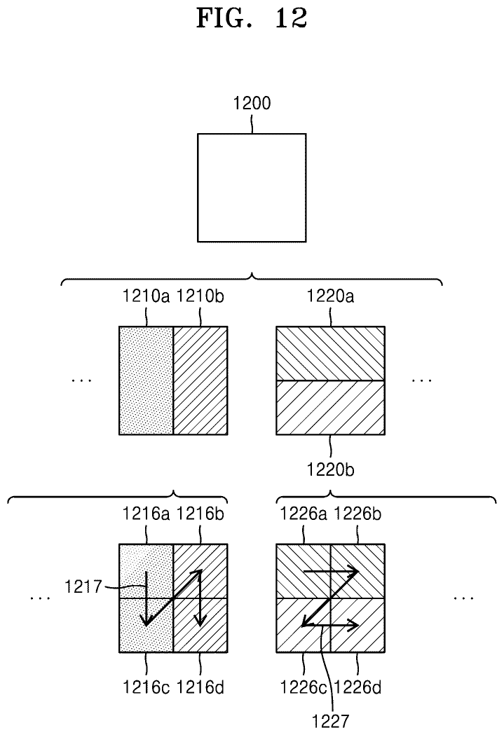

FIG. 12 illustrates that a processing order between a plurality of coding units may be changed depending on a process of splitting a coding unit, according to one or more embodiments.

According to one or more embodiments, the image decoding apparatus 100 may split a first coding unit 1200, based on split shape mode information. When a block shape indicates a square shape and the split shape mode information indicates to split the first coding unit 1200 in at least one of horizontal and vertical directions, the image decoding apparatus 100 may determine second coding units 1210a and 1210b, or 1220a and 1220b, etc. by splitting the first coding unit 1200. Referring to FIG. 12, the non-square second coding units 1210a and 1210b, or 1220a and 1220b determined by splitting the first coding unit 1200 in only a horizontal direction or vertical direction may be independently split based on the split shape mode information of each coding unit. For example, the image decoding apparatus 100 may determine third coding units 1216a, 1216b, 1216c, and 1216d by splitting the second coding units 1210a and 1210b, which are generated by splitting the first coding unit 1200 in a vertical direction, in a horizontal direction, and may determine third coding units 1226a, 1226b, 1226c, and 1226d by splitting the second coding units 1220a and 1220b, which are generated by splitting the first coding unit 1200 in a horizontal direction, in a vertical direction. An operation of splitting the second coding units 1210a and 1210b, or 1220a and 1220b has been described above in relation to FIG. 11, and thus detailed descriptions thereof will not be provided herein.

According to one or more embodiments, the image decoding apparatus 100 may process coding units in a preset order. An operation of processing coding units in a preset order has been described above in relation to FIG. 7, and thus detailed descriptions thereof will not be provided herein. Referring to FIG. 12, the image decoding apparatus 100 may determine four square third coding units 1216a, 1216b, 1216c, and 1216d, and 1226a, 1226b, 1226c, and 1226d by splitting the square first coding unit 1200. According to one or more embodiments, the image decoding apparatus 100 may determine processing orders of the third coding units 1216a, 1216b, 1216c, and 1216d, and 1226a, 1226b, 1226c, and 1226d based on a split shape by which the first coding unit 1200 is split.

According to one or more embodiments, the image decoding apparatus 100 may determine the third coding units 1216a, 1216b, 1216c, and 1216d by splitting the second coding units 1210a and 1210b generated by splitting the first coding unit 1200 in a vertical direction, in a horizontal direction, and may process the third coding units 1216a, 1216b, 1216c, and 1216d in a processing order 1217 for initially processing the third coding units 1216a and 1216c, which are included in the left second coding unit 1210a, in a vertical direction and then processing the third coding unit 1216b and 1216d, which are included in the right second coding unit 1210b, in a vertical direction.

According to one or more embodiments, the image decoding apparatus 100 may determine the third coding units 1226a, 1226b, 1226c, and 1226d by splitting the second coding units 1220a and 1220b generated by splitting the first coding unit 1200 in a horizontal direction, in a vertical direction, and may process the third coding units 1226a, 1226b, 1226c, and 1226d in a processing order 1227 for initially processing the third coding units 1226a and 1226b, which are included in the upper second coding unit 1220a, in a horizontal direction and then processing the third coding unit 1226c and 1226d, which are included in the lower second coding unit 1220b, in a horizontal direction.

Referring to FIG. 12, the square third coding units 1216a, 1216b, 1216c, and 1216d, and 1226a, 1226b, 1226c, and 1226d may be determined by splitting the second coding units 1210a and 1210b, and 1220a and 1220b, respectively. Although the second coding units 1210a and 1210b are determined by splitting the first coding unit 1200 in a vertical direction differently from the second coding units 1220a and 1220b which are determined by splitting the first coding unit 1200 in a horizontal direction, the third coding units 1216a, 1216b, 1216c, and 1216d, and 1226a, 1226b, 1226c, and 1226d split therefrom eventually show same-shaped coding units split from the first coding unit 1200. As such, by recursively splitting a coding unit in different manners based on the split shape mode information, the image decoding apparatus 100 may process a plurality of coding units in different orders even when the coding units are eventually determined to be the same shape.

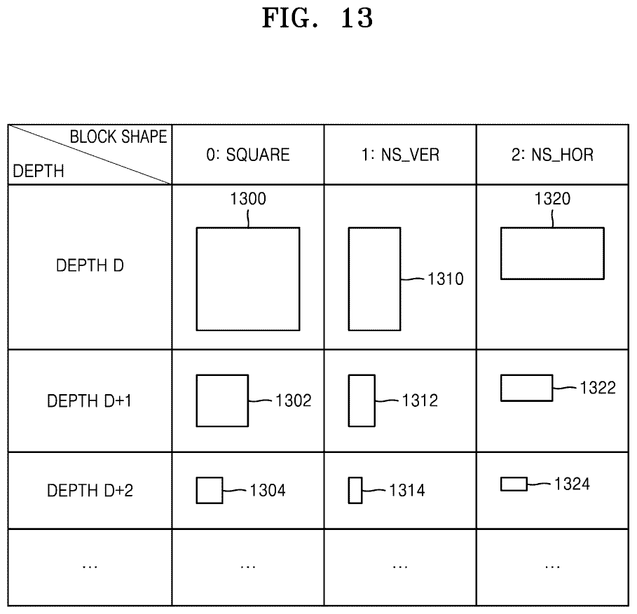

FIG. 13 illustrates a process of determining a depth of a coding unit as a shape and size of the coding unit change, when the coding unit is recursively split such that a plurality of coding units are determined, according to one or more embodiments.

According to one or more embodiments, the image decoding apparatus 100 may determine the depth of the coding unit, based on a preset criterion. For example, the preset criterion may be the length of a long side of the coding unit. When the length of a long side of a coding unit before being split is 2n times (n>0) the length of a long side of a split current coding unit, the image decoding apparatus 100 may determine that a depth of the current coding unit is increased from a depth of the coding unit before being split, by n. In the following descriptions, a coding unit having an increased depth is expressed as a coding unit of a lower depth.

Referring to FIG. 13, according to one or more embodiments, the image decoding apparatus 100 may determine a second coding unit 1302 and a third coding unit 1304 of lower depths by splitting a square first coding unit 1300 based on block shape information indicating a square shape (e.g., the block shape information may be expressed as ‘0: SQUARE’). Assuming that the size of the square first coding unit 1300 is 2N×2N, the second coding unit 1302 determined by splitting a width and height of the first coding unit 1300 in ½ may have a size of N×N. Furthermore, the third coding unit 1304 determined by splitting a width and height of the second coding unit 1302 in ½ may have a size of N/2×N/2. In this case, a width and height of the third coding unit 1304 are ¼ times those of the first coding unit 1300. When a depth of the first coding unit 1300 is D, a depth of the second coding unit 1302, the width and height of which are ½ times those of the first coding unit 1300, may be D+1, and a depth of the third coding unit 1304, the width and height of which are ¼ times those of the first coding unit 1300, may be D+2.

According to one or more embodiments, the image decoding apparatus 100 may determine a second coding unit 1312 or 1322 and a third coding unit 1314 or 1324 of lower depths by splitting a non-square first coding unit 1310 or 1320 based on block shape information indicating a non-square shape (e.g., the block shape information may be expressed as ‘1: NS_VER’ indicating a non-square shape, a height of which is longer than a width, or as ‘2: NS_HOR’ indicating a non-square shape, a width of which is longer than a height).

The image decoding apparatus 100 may determine a second coding unit 1302, 1312, or 1322 by splitting at least one of a width and height of the first coding unit 1310 having a size of N×2N. That is, the image decoding apparatus 100 may determine the second coding unit 1302 having a size of N×N or the second coding unit 1322 having a size of N×N/2 by splitting the first coding unit 1310 in a horizontal direction, or may determine the second coding unit 1312 having a size of N/2×N by splitting the first coding unit 1310 in horizontal and vertical directions.

According to one or more embodiments, the image decoding apparatus 100 may determine the second coding unit 1302, 1312, or 1322 by splitting at least one of a width and height of the first coding unit 1320 having a size of 2N×N. That is, the image decoding apparatus 100 may determine the second coding unit 1302 having a size of N×N or the second coding unit 1312 having a size of N/2×N by splitting the first coding unit 1320 in a vertical direction, or may determine the second coding unit 1322 having a size of N×N/2 by splitting the first coding unit 1320 in horizontal and vertical directions.

According to one or more embodiments, the image decoding apparatus 100 may determine a third coding unit 1304, 1314, or 1324 by splitting at least one of a width and height of the second coding unit 1302 having a size of N×N. That is, the image decoding apparatus 100 may determine the third coding unit 1304 having a size of N/2×N/2, the third coding unit 1314 having a size of N/4×N/2, or the third coding unit 1324 having a size of N/2×N/4 by splitting the second coding unit 1302 in vertical and horizontal directions.

According to one or more embodiments, the image decoding apparatus 100 may determine the third coding unit 1304, 1314, or 1324 by splitting at least one of a width and height of the second coding unit 1312 having a size of N/2×N. That is, the image decoding apparatus 100 may determine the third coding unit 1304 having a size of N/2×N/2 or the third coding unit 1324 having a size of N/2×N/4 by splitting the second coding unit 1312 in a horizontal direction, or may determine the third coding unit 1314 having a size of N/4×N/2 by splitting the second coding unit 1312 in vertical and horizontal directions.

According to one or more embodiments, the image decoding apparatus 100 may determine the third coding unit 1304, 1314, or 1324 by splitting at least one of a width and height of the second coding unit 1322 having a size of N×N/2. That is, the image decoding apparatus 100 may determine the third coding unit 1304 having a size of N/2×N/2 or the third coding unit 1314 having a size of N/4×N/2 by splitting the second coding unit 1322 in a vertical direction, or may determine the third coding unit 1324 having a size of N/2×N/4 by splitting the second coding unit 1322 in vertical and horizontal directions.

According to one or more embodiments, the image decoding apparatus 100 may split the square coding unit 1300, 1302, or 1304 in a horizontal or vertical direction. For example, the image decoding apparatus 100 may determine the first coding unit 1310 having a size of N×2N by splitting the first coding unit 1300 having a size of 2N×2N in a vertical direction, or may determine the first coding unit 1320 having a size of 2N×N by splitting the first coding unit 1300 in a horizontal direction. According to one or more embodiments, when a depth is determined based on the length of the longest side of a coding unit, a depth of a coding unit determined by splitting the first coding unit 1300 having a size of 2N×2N in a horizontal or vertical direction may be the same as the depth of the first coding unit 1300.

According to one or more embodiments, a width and height of the third coding unit 1314 or 1324 may be ¼ times those of the first coding unit 1310 or 1320. When a depth of the first coding unit 1310 or 1320 is D, a depth of the second coding unit 1312 or 1322, the width and height of which are ½ times those of the first coding unit 1310 or 1320, may be D+1, and a depth of the third coding unit 1314 or 1324, the width and height of which are ¼ times those of the first coding unit 1310 or 1320, may be D+2.

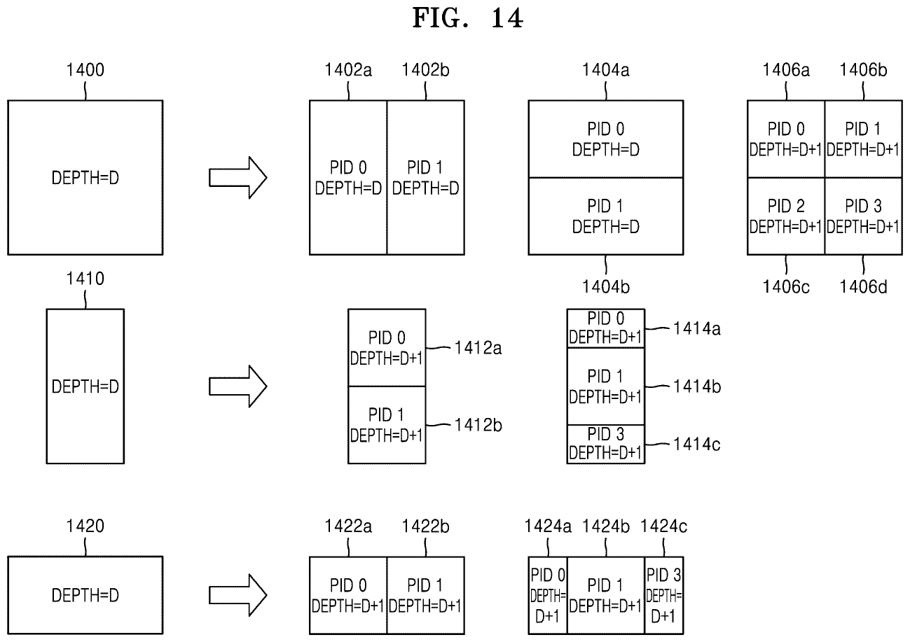

FIG. 14 illustrates depths that are determinable based on shapes and sizes of coding units, and part indexes (PIDs) for distinguishing the coding units, according to one or more embodiments.

According to one or more embodiments, the image decoding apparatus 100 may determine various-shape second coding units by splitting a square first coding unit 1400. Referring to FIG. 14, the image decoding apparatus 100 may determine second coding units 1402a and 1402b, 1404a and 1404b, and 1406a, 1406b, 1406c, and 1406d by splitting the first coding unit 1400 in at least one of vertical and horizontal directions based on split shape mode information. That is, the image decoding apparatus 100 may determine the second coding units 1402a and 1402b, 1404a and 1404b, and 1406a, 1406b, 1406c, and 1406d, based on the split shape mode information of the first coding unit 1400.

According to one or more embodiments, depths of the second coding units 1402a and 1402b, 1404a and 1404b, and 1406a, 1406b, 1406c, and 1406d that are determined based on the split shape mode information of the first coding unit 1400 having a square shape may be determined based on the length of a long side thereof. For example, because the length of a side of the first coding unit 1400 having a square shape equals the length of a long side of the non-square second coding units 1402a and 1402b, and 1404a and 1404b, the first coding unit 1400 and the second coding units 1402a and 1402b, and 1404a and 1404b each having a non-square shape may have the same depth, e.g., D. However, when the image decoding apparatus 100 splits the first coding unit 1400 into the four square second coding units 1406a, 1406b, 1406c, and 1406d based on the split shape mode information, because the length of a side of the square second coding units 1406a, 1406b, 1406c, and 1406d is ½ times the length of a side of the first coding unit 1400, a depth of the second coding units 1406a, 1406b, 1406c, and 1406d may be D+1 which is deeper than the depth D of the first coding unit 1400 by 1.

According to one or more embodiments, the image decoding apparatus 100 may determine a plurality of second coding units 1412a and 1412b, and 1414a, 1414b, and 1414c by splitting a first coding unit 1410, a height of which is longer than a width, in a horizontal direction based on the split shape mode information. According to one or more embodiments, the image decoding apparatus 100 may determine a plurality of second coding units 1422a and 1422b, and 1424a, 1424b, and 1424c by splitting a first coding unit 1420, a width of which is longer than a height, in a vertical direction based on the split shape mode information.

According to one or more embodiments, a depth of the second coding units 1412a and 1412b, and 1414a, 1414b, and 1414c, or 1422a and 1422b, and 1424a, 1424b, and 1424c, which are determined based on the split shape mode information of the non-square first coding unit 1410 or 1420, may be determined based on the length of a long side thereof. For example, because the length of a side of the square second coding units 1412a and 1412b is ½ times the length of a long side of the first coding unit 1410 having a non-square shape, a height of which is longer than a width, a depth of the square second coding units 1412a and 1412b is D+1 which is lower than the depth D of the non-square first coding unit 1410 by 1.

Furthermore, the image decoding apparatus 100 may split the non-square first coding unit 1410 into an odd number of second coding units 1414a, 1414b, and 1414c based on the split shape mode information. The odd number of second coding units 1414a, 1414b, and 1414c may include the non-square second coding units 1414a and 1414c and the square second coding unit 1414b. In this case, because the length of a long side of the non-square second coding units 1414a and 1414c and the length of a side of the square second coding unit 1414b are ½ times the length of a long side of the first coding unit 1410, a depth of the second coding units 1414a, 1414b, and 1414c may be D+1 which is lower than the depth D of the non-square first coding unit 1410 by 1. The image decoding apparatus 100 may determine depths of coding units split from the first coding unit 1420 having a non-square shape, a width of which is longer than a height, using the above-described method of determining depths of coding units split from the first coding unit 1410.

According to one or more embodiments, the image decoding apparatus 100 may determine PIDs for identifying split coding units, based on a size ratio between the coding units when an odd number of split coding units do not have equal sizes. Referring to FIG. 14, a coding unit 1414b of a center location among an odd number of split coding units 1414a, 1414b, and 1414c may have a width equal to that of the other coding units 1414a and 1414c and a height which is two times that of the other coding units 1414a and 1414c. That is, in this case, the coding unit 1414b at the center location may include two of the other coding unit 1414a or 1414c. Therefore, when a PID of the coding unit 1414b at the center location is 1 based on a scan order, a PID of the coding unit 1414c located next to the coding unit 1414b may be increased by 2 and thus may be 3. That is, discontinuity in PID values may be present. According to one or more embodiments, the image decoding apparatus 100 may determine whether an odd number of split coding units do not have equal sizes, based on whether discontinuity is present in PIDs for identifying the split coding units.

According to one or more embodiments, the image decoding apparatus 100 may determine whether to use a specific splitting method, based on PID values for identifying a plurality of coding units determined by splitting a current coding unit. Referring to FIG. 14, the image decoding apparatus 100 may determine an even number of coding units 1412a and 1412b or an odd number of coding units 1414a, 1414b, and 1414c by splitting the first coding unit 1410 having a rectangular shape, a height of which is longer than a width. The image decoding apparatus 100 may use PIDs indicating respective coding units so as to identify the respective coding units. According to one or more embodiments, the PID may be obtained from a sample at a preset location of each coding unit (e.g., an upper-left sample).

According to one or more embodiments, the image decoding apparatus 100 may determine a coding unit at a preset location from among the split coding units, using the PIDs for distinguishing the coding units. According to one or more embodiments, when the split shape mode information of the first coding unit 1410 having a rectangular shape, a height of which is longer than a width, indicates to split a coding unit into three coding units, the image decoding apparatus 100 may split the first coding unit 1410 into three coding units 1414a, 1414b, and 1414c. The image decoding apparatus 100 may assign a PID to each of the three coding units 1414a, 1414b, and 1414c. The image decoding apparatus 100 may compare PIDs of an odd number of split coding units to determine a coding unit at a center location from among the coding units. The image decoding apparatus 100 may determine the coding unit 1414b having a PID corresponding to a middle value among the PIDs of the coding units, as the coding unit at the center location from among the coding units determined by splitting the first coding unit 1410. According to one or more embodiments, the image decoding apparatus 100 may determine PIDs for distinguishing split coding units, based on a size ratio between the coding units when the split coding units do not have equal sizes. Referring to FIG. 14, the coding unit 1414b generated by splitting the first coding unit 1410 may have a width equal to that of the other coding units 1414a and 1414c and a height which is two times that of the other coding units 1414a and 1414c. In this case, when the PID of the coding unit 1414b at the center location is 1, the PID of the coding unit 1414c located next to the coding unit 1414b may be increased by 2 and thus may be 3. When the PID is not uniformly increased as described above, the image decoding apparatus 100 may determine that a coding unit is split into a plurality of coding units including a coding unit having a size different from that of the other coding units. According to one or more embodiments, when the split shape mode information indicates to split a coding unit into an odd number of coding units, the image decoding apparatus 100 may split a current coding unit in such a manner that a coding unit of a preset location among an odd number of coding units (e.g., a coding unit of a center location) has a size different from that of the other coding units. In this case, the image decoding apparatus 100 may determine the coding unit of the center location, which has a different size, using PIDs of the coding units. However, the PIDs and the size or location of the coding unit of the preset location are not limited to the above-described examples, and various PIDs and various locations and sizes of coding units may be used.

According to one or more embodiments, the image decoding apparatus 100 may use a preset data unit where a coding unit starts to be recursively split.

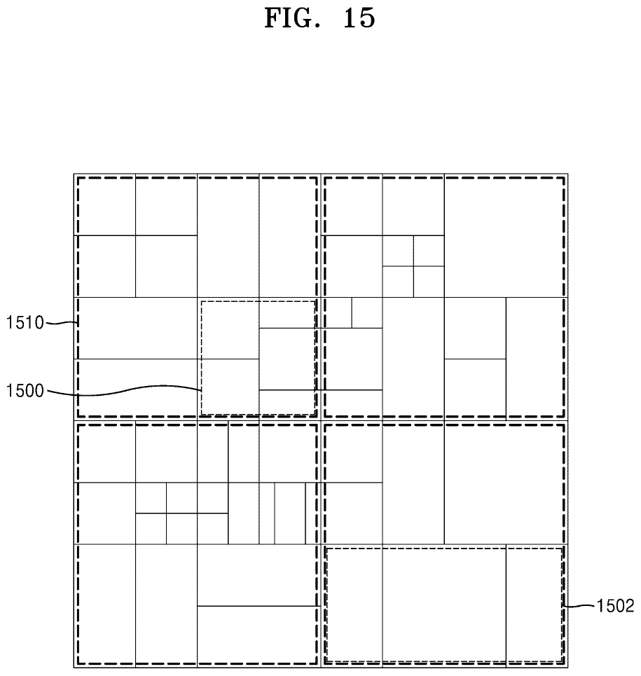

FIG. 15 illustrates that a plurality of coding units are determined based on a plurality of preset data units included in a picture, according to one or more embodiments.

According to one or more embodiments, a preset data unit may be defined as a data unit where a coding unit starts to be recursively split using split shape mode information. That is, the preset data unit may correspond to a coding unit of an uppermost depth, which is used to determine a plurality of coding units split from a current picture. In the following descriptions, for convenience of explanation, the preset data unit is referred to as a reference data unit.

According to one or more embodiments, the reference data unit may have a preset size and a preset shape. According to one or more embodiments, a reference data unit may include M×N samples. Herein, M and N may be equal to each other, and may be integers expressed as powers of 2. That is, the reference data unit may have a square or non-square shape, and may be split into an integer number of coding units.

According to one or more embodiments, the image decoding apparatus 100 may split the current picture into a plurality of reference data units. According to one or more embodiments, the image decoding apparatus 100 may split the plurality of reference data units, which are split from the current picture, using the split shape mode information of each reference data unit. The operation of splitting the reference data unit may correspond to a splitting operation using a quadtree structure.

According to one or more embodiments, the image decoding apparatus 100 may predetermine the minimum size allowed for the reference data units included in the current picture. Accordingly, the image decoding apparatus 100 may determine various reference data units having sizes equal to or greater than the minimum size, and may determine one or more coding units using the split shape mode information with reference to the determined reference data unit.

Referring to FIG. 15, the image decoding apparatus 100 may use a square reference coding unit 1500 or a non-square reference coding unit 1502. According to one or more embodiments, the shape and size of reference coding units may be determined based on various data units capable of including one or more reference coding units (e.g., sequences, pictures, slices, slice segments, tiles, tile groups, largest coding units, or the like).

According to one or more embodiments, the bitstream obtainer 110 of the image decoding apparatus 100 may obtain, from a bitstream, at least one of reference coding unit shape information and reference coding unit size information with respect to each of the various data units. An operation of splitting the square reference coding unit 1500 into one or more coding units has been described above in relation to the operation of splitting the current coding unit 300 of FIG. 3, and an operation of splitting the non-square reference coding unit 1502 into one or more coding units has been described above in relation to the operation of splitting the current coding unit 400 or 450 of FIG. 4. Thus, detailed descriptions thereof will not be provided herein.

According to one or more embodiments, the image decoding apparatus 100 may use a PID for identifying the size and shape of reference coding units, to determine the size and shape of reference coding units according to some data units predetermined based on a preset condition. That is, the bitstream obtainer 110 may obtain, from the bitstream, only the PID for identifying the size and shape of reference coding units with respect to each slice, slice segment, tile, tile group, or largest coding unit which is a data unit satisfying a preset condition (e.g., a data unit having a size equal to or smaller than a slice) among the various data units (e.g., sequences, pictures, slices, slice segments, tiles, tile groups, largest coding units, or the like). The image decoding apparatus 100 may determine the size and shape of reference data units with respect to each data unit, which satisfies the preset condition, using the PID. When the reference coding unit shape information and the reference coding unit size information are obtained and used from the bitstream according to each data unit having a relatively small size, efficiency of using the bitstream may not be high, and therefore, only the PID may be obtained and used instead of directly obtaining the reference coding unit shape information and the reference coding unit size information. In this case, at least one of the size and shape of reference coding units corresponding to the PID for identifying the size and shape of reference coding units may be predetermined. That is, the image decoding apparatus 100 may determine at least one of the size and shape of reference coding units included in a data unit serving as a unit for obtaining the PID, by selecting the predetermined at least one of the size and shape of reference coding units based on the PID.

According to one or more embodiments, the image decoding apparatus 100 may use one or more reference coding units included in a largest coding unit. That is, a largest coding unit split from a picture may include one or more reference coding units, and coding units may be determined by recursively splitting each reference coding unit. According to one or more embodiments, at least one of a width and height of the largest coding unit may be integer times at least one of the width and height of the reference coding units. According to one or more embodiments, the size of reference coding units may be obtained by splitting the largest coding unit n times based on a quadtree structure. That is, the image decoding apparatus 100 may determine the reference coding units by splitting the largest coding unit n times based on a quadtree structure, and may split the reference coding unit based on at least one of the block shape information and the split shape mode information according to various embodiments.

According to one or more embodiments, the image decoding apparatus 100 may obtain block shape information indicating the shape of a current coding unit or split shape mode information indicating a splitting method of the current coding unit, from the bitstream, and may use the obtained information. The split shape mode information may be included in the bitstream related to various data units. For example, the image decoding apparatus 100 may use the split shape mode information included in a sequence parameter set, a picture parameter set, a video parameter set, a slice header, a slice segment header, a tile header, or a tile group header. Furthermore, the image decoding apparatus 100 may obtain, from the bitstream, a syntax element corresponding to the block shape information or the split shape mode information according to each largest coding unit or each reference coding unit, and may use the obtained syntax element.

Hereinafter, a method of determining a split rule, according to one or more embodiments of the present disclosure will be described in detail.

The image decoding apparatus 100 may determine a split rule of an image. The split rule may be predetermined between the image decoding apparatus 100 and the image encoding apparatus 200. The image decoding apparatus 100 may determine the split rule of the image, based on information obtained from a bitstream. The image decoding apparatus 100 may determine the split rule based on the information obtained from at least one of a sequence parameter set, a picture parameter set, a video parameter set, a slice header, a slice segment header, a tile header, and a tile group header. The image decoding apparatus 100 may determine the split rule differently according to frames, slices, tiles, temporal layers, largest coding units, or coding units.

The image decoding apparatus 100 may determine the split rule based on a block shape of a coding unit. The block shape may include a size, shape, a ratio of width and height, and a direction of the coding unit. The image encoding apparatus 200 and the image decoding apparatus 100 may predetermine to determine the split rule based on the block shape of the coding unit. However, embodiments are not limited thereto. The image decoding apparatus 100 may determine the split rule based on the information obtained from the bitstream received from the image encoding apparatus 200.

The shape of the coding unit may include a square and a non-square. When the lengths of the width and height of the coding unit are the same, the image decoding apparatus 100 may determine the shape of the coding unit to be a square. In addition, when the lengths of the width and height of the coding unit are not the same, the image decoding apparatus 100 may determine the shape of the coding unit to be a non-square.

The size of the coding unit may include various sizes, such as 4×4, 8×4, 4×8, 8×8, 16×4, 16×8, and to 256×256. The size of the coding unit may be classified based on the length of a long side of the coding unit, the length of a short side, or the area. The image decoding apparatus 100 may apply the same split rule to coding units classified as the same group. For example, the image decoding apparatus 100 may classify coding units having the same lengths of the long sides as having the same size. Also, the image decoding apparatus 100 may apply the same split rule to coding units having the same lengths of long sides.

The ratio of the width and height of the coding unit may include 1:2, 2:1, 1:4, 4:1, 1:8, 8:1, 1:16, 16:1, 32:1, 1:32, or the like. Also, a direction of the coding unit may include a horizontal direction and a vertical direction. The horizontal direction may indicate a case in which the length of the width of the coding unit is longer than the length of the height thereof. The vertical direction may indicate a case in which the length of the width of the coding unit is shorter than the length of the height thereof.

The image decoding apparatus 100 may adaptively determine the split rule based on the size of the coding unit. The image decoding apparatus 100 may differently determine an allowable split shape mode based on the size of the coding unit. For example, the image decoding apparatus 100 may determine whether splitting is allowed based on the size of the coding unit. The image decoding apparatus 100 may determine a split direction according to the size of the coding unit. The image decoding apparatus 100 may determine an allowable split type according to the size of the coding unit.

The split rule determined based on the size of the coding unit may be a split rule pre-determined between the image encoding apparatus 200 and the image decoding apparatus 100. Also, the image decoding apparatus 100 may determine the split rule based on the information obtained from the bitstream.

The image decoding apparatus 100 may adaptively determine the split rule based on a location of the coding unit. The image decoding apparatus 100 may adaptively determine the split rule based on the location of the coding unit in the image.

Also, the image decoding apparatus 100 may determine the split rule such that coding units generated via different splitting paths do not have the same block shape. However, one or more embodiments is not limited thereto, and the coding units generated via different splitting paths have the same block shape. The coding units generated via the different splitting paths may have different decoding processing orders. Because the decoding processing orders are described above with reference to FIG. 12, details thereof are not provided again.

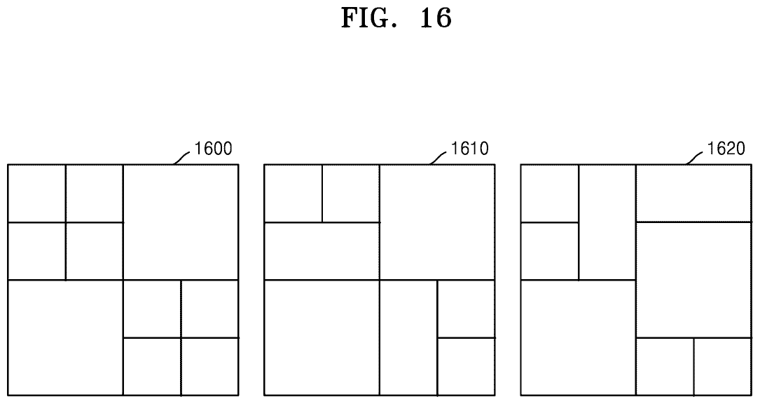

FIG. 16 illustrates coding units of individual pictures, when the individual pictures have different split shape combinations of coding units, according to one or more embodiments.

Referring to FIG. 16, the image decoding apparatus 100 may determine different split shape combinations of coding units for individual pictures. For example, the image decoding apparatus 100 may decode an image using a picture 1600 that can be split into four coding units, a picture 1610 that can be split into two or four coding units, and a picture 1620 that can be split into two, three, or four coding units, among at least one picture included in the image. The image decoding apparatus 100 may use only split shape information indicating splitting into four square coding units, in order to split the picture 1600 into a plurality of coding units. The image decoding apparatus 100 may use only split shape information indicating splitting into two or four coding units, in order to split the picture 1610. The image decoding apparatus 100 may use only split shape information indicating splitting into two, three, or four coding units, in order to split the picture 1620. The above-described split shape combinations are embodiments for describing operations of the image decoding apparatus 100, and therefore, the above-described split shape combinations should not be interpreted to be limited to the above-described embodiments. It should be interpreted that various split shape combinations can be used for each preset data unit.

According to one or more embodiments, the bitstream obtainer 110 of the image decoding apparatus 100 may obtain a bitstream including an index representing a combination of split shape information for each preset data unit (for example, a sequence, a picture, a slice, a slice segment, a tile, a tile group, etc.). For example, the bitstream obtainer 110 may obtain an index representing a combination of split shape information from a sequence parameter set, a picture parameter set, a slice header, a tile header, or a tile group header. The bitstream obtainer 110 of the image decoding apparatus 100 may use the obtained index to determine a split shape combination into which coding units can be split for each preset data unit, and accordingly, the bitstream obtainer 110 may use different split shape combinations for individual preset data units.

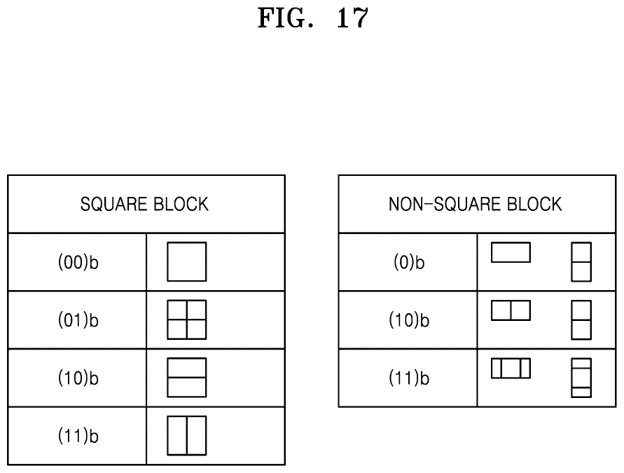

FIG. 17 illustrates various shapes of coding units that can be determined based on split shape mode information that can be expressed with a binary code, according to one or more embodiments.

According to one or more embodiments, the image decoding apparatus 100 may split coding units into various shapes using block shape information and split shape mode information obtained through the bitstream obtainer 110. Shapes into which coding units can be split may be various shapes including shapes described above through the embodiments.

Referring to FIG. 17, the image decoding apparatus 100 may split a coding unit having a square shape in at least one direction of a horizontal direction and a vertical direction, and a coding unit having a non-square shape in the horizontal direction or the vertical direction, based on split shape mode information.

According to one or more embodiments, when the image decoding apparatus 100 can split a coding unit having a square shape in the horizontal direction and the vertical direction to determine four square coding units, split shape mode information of a square coding unit may represent four split shapes. According to one or more embodiments, the split shape mode information may be expressed with a binary code of 2 digits, and each split shape may be assigned a binary code. For example, when a coding unit is not split, split shape mode information may be expressed as (00)b, when a coding unit is split in the horizontal direction and the vertical direction, split shape mode information may be expressed as (01)b, when a coding unit is split in the horizontal direction, split shape mode information may be expressed as (10)b, and when a coding unit is split in the vertical direction, split shape mode information may be expressed as (11)b.

According to one or more embodiments, when the image decoding apparatus 100 splits a coding unit having a non-square shape in the horizontal direction or the vertical direction, kinds of split shapes that can be represented by split shape mode information may depend on the number of coding units into which the coding unit is to be split. Referring to FIG. 17, the image decoding apparatus 100 may split a coding unit having a non-square shape up to three, according to one or more embodiments. Also, the image decoding apparatus 100 may split a coding unit into two coding units. In this case, split shape mode information may be expressed as (10)b.

The image decoding apparatus 100 may split a coding unit into three coding units. In this case, split shape mode information may be expressed as (11)b. The image decoding apparatus 100 may determine not to split a coding unit. In this case, split shape mode information may be expressed as (0)b. That is, the image decoding apparatus 100 may use Variable Length Coding (VLC), instead of Fixed Length Coding (FLC), in order to use a binary code representing split shape mode information.

According to one or more embodiments, referring to FIG. 17, a binary code of split shape mode information representing that a coding unit is not split may be expressed as (0)b. In the case in which a binary code of split shape mode information representing that a coding unit is not split is set to (00)b, a binary code of split shape mode information of 2 bits may need to be all used although there is no split shape mode information set to (01)b. However, in the case in which three split shapes of a coding unit having a non-square shape are used, as shown in FIG. 17, the image decoding apparatus 100 may determine that a coding unit is not split using a binary code (0)b of 1 bit as split shape mode information, thereby efficiently using a bitstream. However, split shapes of a coding unit having a non-square shape, which are represented by split shape mode information, should be not interpreted to be limited to three shapes shown in FIG. 17, and should be interpreted to be various shapes including the above-described embodiments.

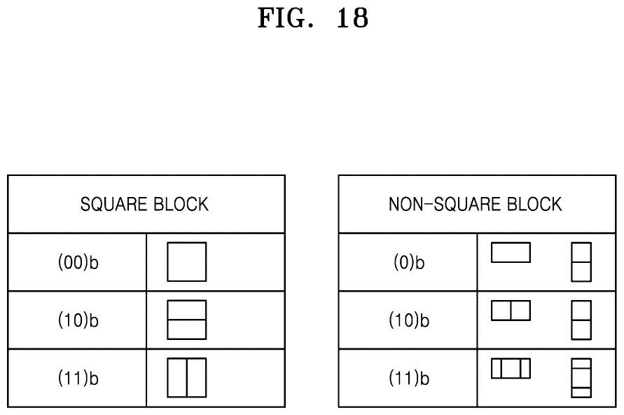

FIG. 18 illustrates other shapes of coding units that can be determined based on split shape mode information that can be represented with a binary code, according to one or more embodiments.

Referring to FIG. 18, the image decoding apparatus 100 may split a coding unit having a square shape in the horizontal direction or the vertical direction, and a coding unit having a non-square shape in the horizontal direction or the vertical direction, based on split shape mode information. That is, the split shape mode information may indicate splitting a coding unit having a square shape in one direction. In this case, a binary code of split shape mode information representing that a coding unit having a square shape is not split may be expressed as (0)b. In the case in which a binary code of split shape mode information representing that a coding unit is not split is set to (00)b, a binary code of split shape mode information of 2 bits may need to be all used although there is no split shape mode information set to (01)b. However, in the case in which three split shapes of a coding unit having a square shape are used, as shown in FIG. 18, the image decoding apparatus 100 may determine that a coding unit is not split using a binary code (0)b of 1 bit as split shape mode information, thereby efficiently using a bitstream. However, split shapes of a coding unit having a square shape, which are represented by split shape mode information, should be not interpreted to be limited to three shapes shown in FIG. 18, and should be interpreted to be various shapes including the above-described embodiments.

According to one or more embodiments, block shape information or split shape mode information may be expressed using a binary code, and the block shape information or split shape mode information may be generated directly as a bitstream. Also, block shape information or split shape mode information that can be expressed with a binary code may be used as an input binary code in context adaptive binary arithmetic coding (CABAC), instead of being generated directly as a bitstream.

A process in which the image decoding apparatus 100 obtains a syntax for block shape information or split shape mode information through CABAC, according to one or more embodiments, will be described. The image decoding apparatus 100 may obtain a bitstream including a binary code for the syntax through the bitstream obtainer 110. The image decoding apparatus 100 may de-binarize a bin string included in the obtained bitstream to detect a syntax element representing block shape information or split shape mode information. According to one or more embodiments, the image decoding apparatus 100 may obtain a group of binary bin strings corresponding to a syntax element to be decoded, and decode the individual bins using probability information. The image decoding apparatus 100 may repeat the operation until a bin string configured with the decoded bins is identical to one of previously obtained bin strings. The image decoding apparatus 100 may perform de-binarization on the bin string to determine a syntax element.

According to one or more embodiments, the image decoding apparatus 100 may perform a decoding process of adaptive binary arithmetic coding to determine a syntax for the bin string, and the image decoding apparatus 100 may update a probability model for the bins obtained through the bitstream obtainer 110. Referring to FIG. 17, the bitstream obtainer 110 of the image decoding apparatus 100 may obtain a bitstream that represents a binary code representing split shape mode information, according to one or more embodiments. The image decoding apparatus 100 may determine a syntax for the split shape mode information using the obtained binary code having a size of 1 or 2 bits. The image decoding apparatus 100 may update a probability for each bit of the binary code of 2 bits, in order to determine the syntax for the split shape mode information. That is, the image decoding apparatus 100 may update, according to which one of 0 or 1 a value of a first bin of the binary code of 2 bits is, a probability that the next bin will have a value of 0 or 1 upon decoding.

According to one or more embodiments, in the process of determining the syntax, the image decoding apparatus 100 may update probabilities for the bins that are used in a process of decoding the bins of the bin string for the syntax, and the image decoding apparatus 100 may determine that a specific bit of the bin string has the same probability, without updating a probability of the specific bit.

Referring to FIG. 17, in a process of determining a syntax using a bin string representing split shape mode information of a coding unit having a non-square shape, the image decoding apparatus 100 may determine a syntax for the split shape mode information using a bin having a value of 0 in the case in which the coding unit having the non-square shape is not split. That is, when block shape information represents that a current coding unit has a non-square shape, a first bin of the bin string for the split shape mode information may be 0 in the case in which the coding unit having the non-square shape is not split, and may be 1 in the case in which the coding unit is split into two or three coding units. Accordingly, a probability that the first bin of the bin string of the split shape mode information of the coding unit having the non-square shape will be 0 may be ⅓, and a probability that the first bin will be 1 may be ⅔. Because split shape mode information representing that a coding unit having a non-square shape is not split can be expressed with a bin string of 1 bit having a value of 0, as described above, the image decoding apparatus 100 may determine, only in the case in which the first bin of the split shape mode information is 1, whether a second bin is 0 or 1 to determine the syntax for the split shape mode information. According to one or more embodiments, when the first bin for the split shape mode information is 1, the image decoding apparatus 100 may determine that a probability that the second bin will be 0 is equal to a probability that the second bin will be 1, and decode the second bin.

Accordingly, the image decoding apparatus 100 may use, in the process of determining the bins of the bin string for the split shape mode information, various probabilities for the individual bins. According to one or more embodiments, the image decoding apparatus 100 may determine different probabilities of bins for split shape mode information according to a width of a current coding unit or a length of a longer side of the current coding unit. According to one or more embodiments, the image decoding apparatus 100 may determine different probabilities of bins for split shape mode information according to at least one of a shape of a current coding unit and a length of a longer side of the current coding unit. According to one or more embodiments, the image decoding apparatus 100 may determine different probabilities of bins for split shape mode information according to at least one of a shape of a current coding unit and a length of a longer side of the current coding unit.

According to one or more embodiments, the image decoding apparatus 100 may determine that probabilities of bins for split shape mode information are the same with respect to coding units that are equal to or larger than a preset size. For example, the image decoding apparatus 100 may determine that probabilities of bins for split shape mode information are the same with respect to coding units of which lengths of longer sides are equal to or greater than 64 samples.

According to one or more embodiments, the image decoding apparatus 100 may determine initial probabilities for bins constituting a bin string of split shape mode information based on a slice type (for example, an I slice, a P slice, or a B slice).

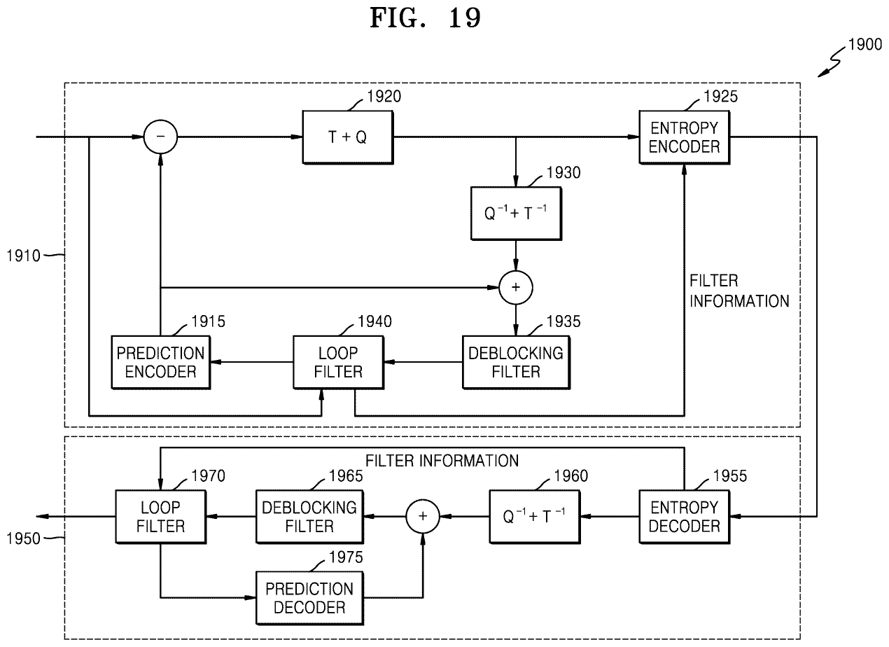

FIG. 19 is a block diagram of an image encoding and decoding system that performs loop filtering.

An encoding end 1910 of an image encoding and decoding system 1900 may transmit an encoded bitstream of an image, and a decoding end 1950 of the image encoding and decoding system 1900 may receive a bitstream and decode the bitstream to output a reconstructed image. Here, the encoding end 1910 may be a configuration that is similar to the image encoding apparatus 200 to be described below, and the decoding end 1950 may be a configuration that is similar to the image decoding apparatus 100.

In the encoding end 1910, a prediction encoder 1915 outputs prediction data through inter prediction and intra prediction, and a transformer and quantizer 1920 outputs a quantized transform coefficient of residual data between the prediction data and a current input image. An entropy encoder 1925 encodes the quantized transform coefficient and outputs the encoded quantized transform coefficient as the bitstream. The quantized transform coefficient is reconstructed into data of a spatial domain via an inverse quantizer and inverse transformer 1930, and the reconstructed data of the spatial domain may be output as a reconstructed image via a deblocking filter 1935 and a loop filter 1940. The reconstructed image may be used as a reference image of a next input image in the prediction encoder 1915.

Encoded image data among the bitstream received by the decoding end 1950 is reconstructed as residual data of a spatial domain via an entropy decoder 1955 and an inverse quantizer and inverse transformer 1960. Image data of a spatial domain may be configured when prediction data output by a prediction decoder 1975 and the residual data are combined, and a deblocking filter 1965 and a loop filter 1970 may output a reconstructed image for a current original image by performing filtering on the image data of the spatial domain. The reconstructed image may be used as a reference image for a next original image by the prediction decoder 1975.

The loop filter 1940 of the encoding end 1910 performs loop filtering using filter information input according to a user input or system settings. Filter information used by the loop filter 1940 is output to the entropy encoder 1925 and transmitted to the decoding end 1950 along with the encoded image data. The loop filter 1970 of the decoding end 1950 may perform loop filtering based on the filter information input from the decoding end 1950.

Various embodiments described above describe operations related to an image decoding method that is performed by the image decoding apparatus 100. Hereinafter, operations of the image encoding apparatus 200 that performs an image encoding method corresponding to a reverse order of the image decoding method will be described through various embodiments.

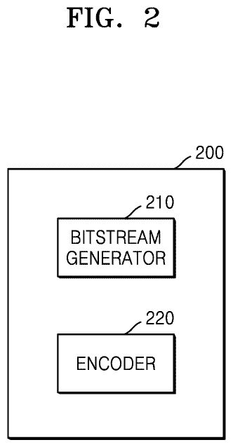

FIG. 2 is a block diagram of the image encoding apparatus 200 capable of encoding an image, based on at least one of block shape information and split shape mode information, according to one or more embodiments.

The image encoding apparatus 200 may include an encoder 220 and a bitstream generator 210. The encoder 220 may receive an input image and encode the input image. The encoder 220 may encode the input image to obtain at least one syntax element. The syntax element may include at least one of a skip flag, a prediction mode, a motion vector difference, a motion vector prediction method (or index), a transform quantized coefficient, a coded block pattern, a coded block flag, an intra prediction mode, a direct flag, a merge flag, a delta QP, a reference index, a prediction direction, or a transform index. The encoder 220 may determine a context model, based on block shape information including at least one of a shape, a direction, a ratio of a height and a width, or a size of a coding unit.

The bitstream generator 210 may generate a bitstream, based on an encoded input image. For example, the bitstream generator 210 may generate a bitstream by performing entropy encoding on a syntax element based on a context model. The image encoding apparatus 200 may transmit the bitstream to the image decoding apparatus 100.

According to one or more embodiments, the encoder 220 of the image encoding apparatus 200 may determine a shape of a coding unit. For example, a coding unit may have a square shape or a non-square shape, and information representing such a shape may be included in block shape information.

According to one or more embodiments, the encoder 220 may determine a shape into which a coding unit is to be split. The encoder 220 may determine a shape of at least one coding unit included in a coding unit, and the bitstream generator 210 may generate a bitstream including split shape mode information including information about the shape of the coding unit.

According to one or more embodiments, the encoder 220 may determine whether or not to split a coding unit. When the encoder 220 determines that a coding unit includes only one coding unit or that a coding unit is not split, the bitstream generator 210 may generate a bitstream including split shape mode information representing that the coding unit is not split. The encoder 220 may split a coding unit into a plurality of coding units included in the coding unit, and the bitstream generator 210 may generate a bitstream including split shape mode information representing that a coding unit is to be split into a plurality of coding units.

According to one or more embodiments, information representing the number of coding units into which a coding unit is split or a direction in which the coding unit is split may be included in the split shape mode information. For example, the split shape mode information may represent splitting in at least one direction of a vertical direction and a horizontal direction or may represent non-splitting.

The image encoding apparatus 200 may determine split shape mode information based on a split shape mode of a coding unit. The image encoding apparatus 200 may determine a context model, based on at least one of a shape, a direction, a ratio of a width and a height, or a size of the coding unit. The image encoding apparatus 200 may generate information about a split shape mode for splitting the coding unit as a bitstream based on the context model.

To determine the context model, the image encoding apparatus 200 may obtain an arrangement for making at least one of a shape, a direction, a ratio of a width and a height, or a size of the coding unit correspond to an index for the context model. The image encoding apparatus 200 may obtain the index for the context model, based on at least one of the shape, the direction, the ratio of the width and the height, or the size of the coding unit, from the arrangement. The image encoding apparatus 200 may determine the context model, based on the index for the context model.

To determine the context model, the image encoding apparatus 200 may determine the context model further based on block shape information including at least one of a shape, a direction, a ratio of a width and a height, or a size of a surrounding coding unit adjacent to the coding unit. The surrounding coding unit may include at least one of coding units located on the left-lower side, left side, left-upper side, upper side, right-upper side, right side, or right-lower side of the coding unit.

To determine the context model, the image encoding apparatus 200 may compare a length of a width of an upper surrounding coding unit with a length of the width of the coding unit. The image encoding apparatus 200 may compare lengths of heights of left and right surrounding coding units with a length of the height of the coding unit. The image encoding apparatus 200 may determine the context model, based on results of the comparisons.

Operations of the image encoding apparatus 200 include contents that are similar to those of the image decoding apparatus 100 described above with reference to FIGS. 3 to 19, and therefore, detailed descriptions thereof will be omitted.

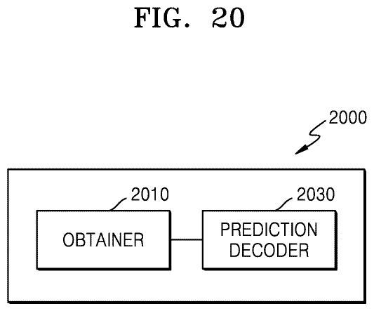

FIG. 20 is a block diagram of a structure of an image decoding apparatus 2000 according to one or more embodiments.

Referring to FIG. 20, the image decoding apparatus 2000 may include an obtainer 2010 and a prediction decoder 2030.

The obtainer 2010 and the prediction decoder 2030, according to one or more embodiments, may be implemented as at least one processor. According to one or more embodiments, the obtainer 2010 and the prediction decoder 2030 may operate according to at least one instruction stored in at least one memory.

The image decoding apparatus 2000 may include at least one memory for storing input and output data of the obtainer 2010 and the prediction decoder 2030. The image decoding apparatus 2000 may include a memory controller for controlling data input/output of the at least one memory.

According to one or more embodiments, the obtainer 2010 may correspond to the entropy decoder 1955 shown in FIG. 19, and the prediction decoder 2030 may correspond to the prediction decoder 1975 shown in FIG. 19.

The obtainer 2010 may obtain a bitstream generated as a result of encoding a picture. The bitstream may include an encoding result with respect to a current block. The current block may be a largest coding unit, a coding unit, or a transformation unit split from a current picture desired to be decoded.

According to one or more embodiments, the obtainer 2010 may receive the bitstream from an image encoding apparatus through a network.

According to one or more embodiments, the obtainer 2010 may obtain the bitstream from a data storage medium including a magnetic medium (such as, a hard disk, a floppy disk, or a magnetic tape), an optical recording medium (such as, CD-ROM or DVD), or a magneto-optical medium (such as, a floptical disk).

The obtainer 2010 may obtain, from the bitstream, syntax elements for decoding a picture. Values corresponding to the syntax elements may be included in the bitstream according to a layer structure of a picture.

The obtainer 2010 may obtain the syntax elements by entropy-decoding bins included in the bitstream.

According to one or more embodiments, the bitstream may include information about a prediction mode of the current block within the current picture. A prediction mode of the current block may be one of a plurality of prediction modes including an intra mode and an inter mode.

The prediction decoder 2030 may generate a prediction block of the current block by performing intra prediction or inter prediction with respect to the current block according to the prediction mode of the current block, and may reconstruct the current block using the prediction block.

According to one or more embodiments, when the prediction mode of the current block is an intra mode, the obtainer 2010 may obtain information about an intra prediction mode of the current block from the bitstream.

According to one or more embodiments, the information about the intra prediction mode of the current block may include information indicating a method of determining the intra prediction mode. According to one or more embodiments, the method of determining the intra prediction mode may include a method of determining the intra prediction mode using a reference block or a method of determining the intra prediction mode using the information obtained from the bitstream.

According to one or more embodiments, the information indicating the method of determining the intra prediction mode may be included in a sequence parameter set, a picture parameter set, a slice header, or slice data of the bitstream.

According to one or more embodiments, the information indicating the method of determining the intra prediction mode may not be included in the bitstream. In this case, the prediction decoder 2030 may determine the intra prediction mode of the current block according to a pre-determined method.

According to one or more embodiments, when the method of determining the intra prediction mode is a method of using the information obtained from the bitstream, the prediction decoder 2030 may determine, as the intra prediction mode of the current block, an intra prediction mode indicated by the information obtained from the bitstream among a plurality of intra prediction modes. For example, the information indicating the intra prediction mode of the current block may include a flag or index indicating one intra prediction mode from among the plurality of intra prediction modes.

When the method of determining the intra prediction mode is a method of using a reference block, the prediction decoder 2030 according to one or more embodiments may determine the intra prediction mode of the current block using at least one of a reference block in the current picture reconstructed earlier than the current block (hereinafter, a spatial reference block) or a reference block in a previous picture reconstructed earlier than the current block (hereinafter, a temporal reference block).

According to one or more embodiments, to determine the spatial reference block, the obtainer 2010 may obtain, from the bitstream, information about a block vector indicating the spatial reference block.

According to one or more embodiments, to determine the temporal reference block, the obtainer 2010 may obtain, from the bitstream, an index of a previous picture including the temporal reference block and/or information about a motion vector indicating the temporal reference block.

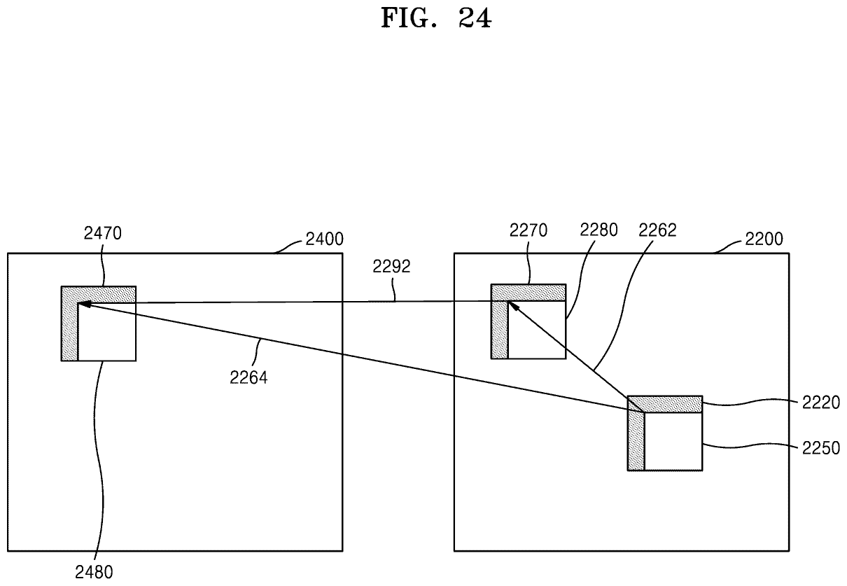

A method of determining the intra prediction mode of the current block using the spatial reference block and/or the temporal reference block will now be described below with reference to FIGS. 24 through 29.

When a prediction block is generated through intra prediction with respect to the current block, the prediction decoder 2030 may obtain the reconstructed current block using the prediction block.

According to one or more embodiments, the prediction decoder 2030 may determine the prediction block as the reconstructed current block.

According to one or more embodiments, the prediction decoder 2030 may generate the reconstructed current block by combining residual data obtained from the bitstream by the obtainer 2010 with the prediction block.

In standards such as High Efficiency Video Coding (HEVC) and versatile video coding (VVC), the intra prediction mode indicated by the information obtained from the bitstream may be determined as the intra prediction mode of the current block. A bitrate may be increased by including, in the bitstream, the information indicating the intra prediction mode of the current block among several intra prediction modes. According to one or more embodiments, the prediction decoder 2030 determines at least one of the spatial reference block or the temporal reference block through a predetermined method, and determines, as the intra prediction mode of the current block, an intra prediction mode derived from at least one of the spatial reference block or the temporal reference block, thereby reducing the bit rate of the bitstream.

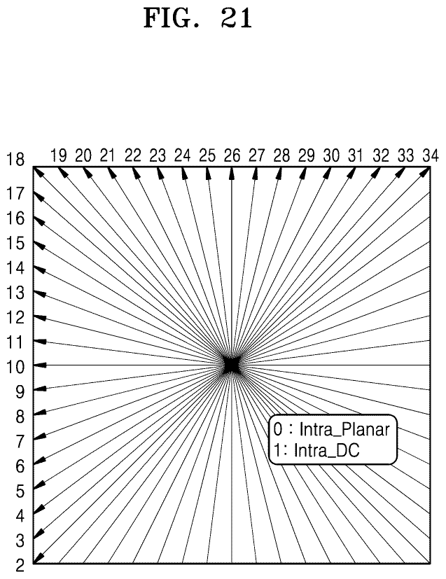

Intra prediction performed with respect to the current block will now be described with reference to FIGS. 21 through 23.

FIG. 21 is a diagram illustrating types of intra prediction modes according to one or more embodiments.

An intra prediction mode of the current block may be determined to perform intra prediction on the current block.

According to one or more embodiments, when a prediction mode of the current block is an intra mode, the obtainer 2010 may obtain information about the intra prediction mode of the current block from a bitstream.

The intra prediction mode of the current block may be one of a plurality of intra prediction modes.

According to one or more embodiments, the plurality of intra prediction modes may include directional intra prediction modes and non-directional intra prediction modes.

Referring to FIG. 21, according to one or more embodiments, the plurality of intra prediction modes may include a 0 numbered non-directional Intra_Planar mode, a 1 numbered non-directional Intra_DC mode, and 2 through 34 numbered directional Intra_Angular modes.

In the Intra_Angular modes, locations of reference samples for generating prediction samples of samples in the current block may be identified based on directions or angles indicated by the Intra_Angular modes. For example, in an 18 numbered mode, reference samples located in a direction of −32 degrees may be identified with respect to the samples in the current block.

The intra prediction modes illustrated in FIG. 21 are examples, and the number and types of intra prediction modes available in the intra mode according to one or more embodiments may be set in various ways. For example, the intra prediction modes illustrated in FIG. 21 may be the 35 intra prediction modes defined in the HEVC standard, and, according to one or more embodiments, the number of intra prediction modes available in the intra mode may be 67 as defined in the VVC standard.

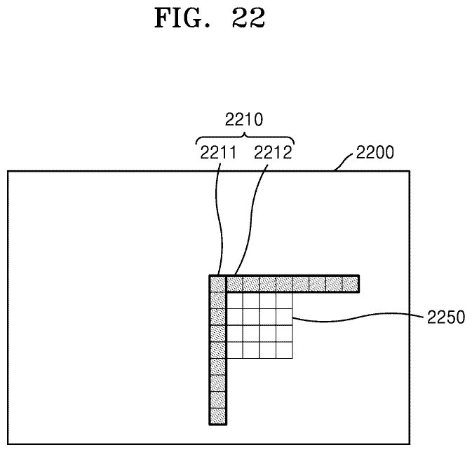

FIG. 22 is a diagram illustrating neighboring samples that may be used for intra prediction with respect to a current block according to one or more embodiments.

According to one or more embodiments, the prediction decoder 2030 may identify neighboring samples 2210 adjacent to a current block 2250 within a current picture 2200 to perform intra prediction on the current block 2250.

The prediction decoder 2030 may generate a prediction block of the current block 2250 according to an intra prediction mode using the identified neighboring samples 2210 as reference samples.

According to one or more embodiments, when the neighboring samples 2210 are identified, filtering according to the intra prediction mode may be applied to the identified neighboring samples 2210, and the prediction block of the current block 2250 may be generated based on filtered samples.

Referring to FIG. 22, according to one or more embodiments, the neighboring samples 2210 may include left samples 2211 of the current block 2250 and upper samples 2212 of the current block 2250.

FIG. 22 illustrates the current block 2250 in a size of 4×4, nine left samples 2211, and eight upper samples 2212. The number of left samples 2211 and the number of upper samples 2212 used for intra prediction of the current block 2250 may be set in various ways.

For example, for intra prediction of the current block 2250, the prediction decoder 2030 may identify 2n+1 left samples 2211 (where n is a height of the current block 2250, and is an integer equal to or greater than 1), and may identify 2m upper samples 2212 (where m is a width of the current block 2250, and is an integer equal to or greater than 1).

According to one or more embodiments, FIG. 22 illustrates that the left samples 2211 are disposed in one column. However, according to one or more embodiments, the left samples 2211 may be disposed in two or more columns. In addition, the upper samples 2212 may also be disposed in two or more rows.

According to one or more embodiments, when some neighboring samples 2210 necessary for intra prediction have not been reconstructed before the current block 2250, the prediction decoder 2030 may generate the not-reconstructed neighboring samples through padding.

According to one or more embodiments, when the neighboring samples 2210 of the current block 2250 are identified, the prediction decoder 2030 may generate the prediction block of the current block 2250 using the neighboring samples 2210.

According to one or more embodiments, in order to generate the prediction block, the prediction decoder 2030 may filter the neighboring samples 2210 according to the intra prediction mode, and may identify samples respectively corresponding to the samples in the current block 2250 from among the filtered neighboring samples according to the intra prediction mode. In addition, the prediction decoder 2030 may generate prediction samples of the samples in the current block 2250 by applying the identified samples to a certain operation equation.

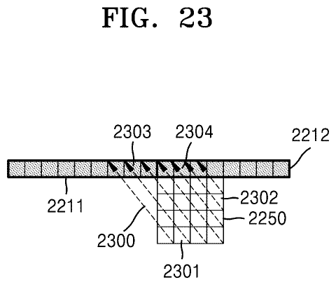

A process of performing intra prediction on the current block 2250 using the neighboring samples 2210 of the current block 2250 will be described with reference to FIG. 23.

FIG. 23 is a diagram for explaining a process of predicting a current block using neighboring samples according to an intra prediction mode according to one or more embodiments.

As described above, when the neighboring samples 2210 of the current block 2250 are identified, the prediction decoder 2030 may generate prediction samples of the samples of the current block 2250, based on the neighboring samples 2210.

Some of the Intra_Angular modes may need only the left samples 2211 among the neighboring samples 2210, and the other modes may need only the upper samples 2212 among the neighboring samples 2210. Another mode may need both the left samples 2211 and the upper samples 2212.

In the 18 numbered intra prediction mode, as shown in FIG. 23, both the left samples 2211 and the upper samples 2212 may be used to generate the prediction samples of the samples in the current block 2250.

FIG. 23 illustrates that the left samples 2211 are disposed on the left side of the upper samples 2212, which may mean that sample values of the left samples 2211 and sample values of the upper samples 2212 are consecutively stored in memory.

According to one or more embodiments, the prediction decoder 2030 may identify the neighboring samples respectively corresponding to the samples in the current block 2250 from among the neighboring samples 2210, and may apply sample values of the identified neighboring samples to a certain operation equation to calculate sample values of the prediction samples.

For example, in order to obtain a prediction sample of a sample 2301 located at (3, 1) in the current block 2250, a neighboring sample 2303 among the left samples 2211 may be identified in a direction 2300 indicated by the intra prediction mode. As a sample value of the identified neighboring sample 2303 is applied to the certain operation equation, a prediction sample value of the sample 2301 located at (3, 1) in the current block 2250 may be obtained.

In addition, in order to obtain a prediction sample of a sample 2302 located at (1, 3) in the current block 2250, a neighboring sample 2304 among the upper samples 2212 may be identified in the direction 2300 indicated by the intra prediction mode. As a sample value of the identified neighboring sample 2304 is applied to the certain operation equation, a prediction sample value of the sample 2302 located at (1, 3) in the current block 2250 may be obtained.

When prediction sample values of the samples in the current block 2250 are obtained based on the neighboring samples 2210, the prediction decoder 2030 may reconstruct the current block 2250 using the obtained prediction sample values.

As described above, an intra prediction mode of the current block 2250 needs to be determined to perform intra prediction on the current block 2250. When information for indicating one intra prediction mode from among the plurality of intra prediction modes illustrated in FIG. 21 is included in a bitstream, this may increase a bitrate.

According to one or more embodiments, the bitrate may be reduced by determining an intra prediction mode derived from a spatial reference block and/or a temporal reference block as the intra prediction mode of the current block 2250.

A method of determining the spatial reference block and the temporal reference block will be described with reference to FIG. 24.

FIG. 24 is a diagram for explaining a method of determining a reference block of a current block, according to one or more embodiments.

According to one or more embodiments, the prediction decoder 2030 may determine at least one of a spatial reference block 2280 in the current picture 2200 reconstructed before the current block 2250 or a temporal reference block 2480 in a previous picture 2400 reconstructed before the current block 2250, according to template matching. According to one or more embodiments, the previous picture 2400 may be a picture reconstructed before the current picture 2200.

During template matching, a neighboring sample set reconstructed before the current block 2250 may be used as a template 2220. According to one or more embodiments, the template 2220 of the current block 2250 may include at least some of the neighboring samples 2210 illustrated in FIG. 22.

According to one or more embodiments, the prediction decoder 2030 may search for a template 2270 most similar to the template 2220 from the current picture 2200, using the neighboring sample set of the current block 2250 as the template 2220, and may determine a block adjacent to the found template 2270 as the spatial reference block 2280.

Because the template 2220 is located on left and top sides of the current block 2250 in FIG. 24, a block located on right and bottom sides of the similar template 2270 found from the current picture 2200 may be determined as the spatial reference block 2280. According to one or more embodiments, a size of the spatial reference block 2280 may be the same as that of the current block 2250.

According to one or more embodiments, the prediction decoder 2030 may search for a template 2470 most similar to the template 2220 from the previous picture 2400, using the neighboring sample set of the current block 2250 as the template 2220, and may determine a block adjacent to the found template 2470 as the temporal reference block 2480. Because the template 2220 is located on left and top sides of the current block 2250 in FIG. 24, a block located on right and bottom sides of the similar template 2470 found from the previous picture 2400 may be determined as the temporal reference block 2480. According to one or more embodiments, a size of the temporal reference block 2480 may be the same as that of the current block 2250.

When the templates 2270 and 2470 similar to the template 2220 of the current block 2250 are searched for, difference values between sample values may be used. For example, the similar templates 2270 and 2470 including sample values most similar to the sample values included in the template 2220 of the current block 2250 may be determined within the current picture 2200 and/or the previous picture 2400.

To search for the similar templates 2270 and 2470, the prediction decoder 2030 may determine a basic motion vector. For example, a pre-determined motion vector (e.g., a zero vector) or a motion vector of a block at a pre-determined location may be determined as the basic motion vector. The pre-determined location may refer to a specific location within the current picture 2200 that is agreed upon between an encoder and a decoder further described herein.

The prediction decoder 2030 may search for the templates 2270 and 2470 most similar to the template 2200 within a preset range from a point indicated by the basic motion vector, and may determine a block adjacent to the similar templates 2270 and 2470 as the spatial reference block 2280 or the temporal reference block 2480.

According to one or more embodiments, the basic motion vector used to search for the similar template 2270 within the current picture 2200 may be referred to as a basic block vector.

In the aforementioned template matching, the spatial reference block 2280 and the temporal reference block 2480 are directly searched for by the prediction decoder 2030. According to one or more embodiments, the prediction decoder 2030 may determine the spatial reference block 2280 and the temporal reference block 2480 using information signaled through the bitstream. The spatial reference block 2280 and the temporal reference block 2480 being directly searched for by the prediction decoder 2030 may be understood as the prediction decoder 2030 determining locations of the spatial reference block 2280 and the temporal reference block 2480 on its own without obtaining information indicating the locations of the spatial reference block 2280 and the temporal reference block 2480.

According to one or more embodiments, the obtainer 2010 may obtain information about a block vector 2262 indicating the spatial reference block 2280 from the bitstream, and the prediction decoder 2030 may determine the spatial reference block 2280 within the current picture 2200 using the block vector 2262.

According to one or more embodiments, the information about the block vector 2262 indicating the spatial reference block 2280 may include information (e.g., a flag or index) indicating any one of block vector candidates included in a pre-constructed block vector candidate set.

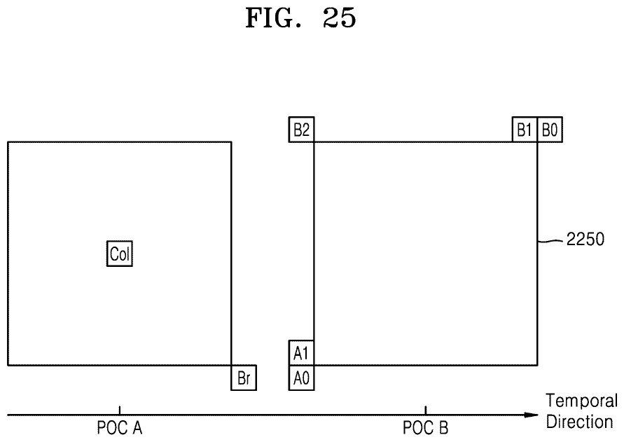

According to one or more embodiments, the prediction decoder 2030 may construct the block vector candidate set using motion vectors or block vectors of neighboring blocks temporally or spatially related to the current block 2250 (e.g., at least some of the neighboring blocks illustrated in FIG. 25), and may determine the block vector 2262 for indicating the spatial reference block 2280, based on the information obtained from the bitstream.

According to one or more embodiments, the prediction decoder 2030 may determine the block vector 2262 for indicating the spatial reference block 2280 by combining a block vector candidate indicated by the information obtained from the bitstream from among the block vector candidates in the block vector candidate set with a block vector difference obtained from the bitstream.

According to one or more embodiments, when constructing a block vector candidate set, the prediction decoder 2030 may determine each of the block vector candidates included in the block vector candidate set based on template matching based on a motion vector or block vector of a temporal neighboring block and/or a spatial neighboring block (e.g., at least some of the neighboring blocks illustrated in FIG. 25).

According to one or more embodiments, the prediction decoder 2030 may also determine the spatial reference block 2280 indicated by a pre-determined block vector within the current picture 2200. The pre-determined block vector may be, for example, a block vector of a block at a pre-determined location or a zero vector.

According to one or more embodiments, the obtainer 2010 may obtain information about a motion vector 2264 indicating the temporal reference block 2480 from the bitstream, and the prediction decoder 2030 may determine the temporal reference block 2480 within the previous picture 2400 using the motion vector 2264.

According to one or more embodiments, the information about the motion vector 2264 indicating the temporal reference block 2480 may include information (e.g., a flag or index) indicating any one of motion vector candidates included in a pre-constructed motion vector candidate set.

According to one or more embodiments, the prediction decoder 2030 may construct the motion vector candidate set using motion vectors or block vectors of neighboring blocks temporally or spatially related to the current block 2250 (e.g., at least some of the neighboring blocks illustrated in FIG. 25), and may determine the block vector 2264 for indicating the temporal reference block 2480, based on the information obtained from the bitstream.

According to one or more embodiments, the prediction decoder 2030 may determine the motion vector 2264 for indicating the temporal reference block 2480 by combining a motion vector candidate indicated by the information obtained from the bitstream from among the motion vector candidates in the motion vector candidate set with a motion vector difference obtained from the bitstream.

According to one or more embodiments, when constructing a motion vector candidate set, the prediction decoder 2030 may determine each of the motion vector candidates included in the motion vector candidate set through template matching based on a motion vector or block vector of a temporal neighboring block and/or a spatial neighboring block (e.g., at least some of the neighboring blocks illustrated in FIG. 25).

According to one or more embodiments, the prediction decoder 2030 may also determine the temporal reference block 2480 indicated by a pre-determined motion vector within the previous picture 2400. The pre-determined motion vector may be, for example, a motion vector of a block at a pre-determined location or a zero vector.

Neighboring blocks of the current block 2250 that may be used to derive the block vector 2262 or the motion vector 2264 of the current block 2250 will be described with reference to FIG. 25.

FIG. 25 is a diagram illustrating locations of neighboring blocks related to a current block, according to one or more embodiments.

Referring to FIG. 25, a temporal neighboring block may include at least one of a block Col located at the same point as the current block 2250 or a block Br spatially adjacent to the block Col at the same location in a picture having a picture order count (POC) (e.g., POC A) different from a POC (e.g., POC B) of the current picture 2200 including the current block 2250. The POC may refer to a value allocated to a picture according to an output order.

The block Br may be located on a lower right side of the block Col located at the same point as the current block 2250. The block Col located at the same point as the current block 2250 may be a block including a sample corresponding to a center sample in the current block 2250 from among samples in the picture of the POC A.

A spatial neighboring block may include at least one of a left lower corner block A0, a left lower block A1, a right upper corner block B0, a right upper block B1, or a left upper corner block B2.

The locations of the temporal neighboring block and the spatial neighboring block shown in FIG. 25 are an example, and the locations of temporal neighboring blocks and spatial neighboring blocks and the numbers thereof may be changed in various ways.

As described above with reference to FIG. 24, the spatial reference block 2280 and the temporal reference block 2480 may be determined in various ways.

For example, both the spatial reference block 2280 and the temporal reference block 2480 may be determined based on template matching.

In addition, for example, the spatial reference block 2280 may be determined using the block vector 2262 determined based on the information obtained from the bitstream or the pre-determined block vector, and the temporal reference block 2480 may be determined based on template matching.

In addition, for example, the spatial reference block 2280 may be determined based on template matching, and the temporal reference block 2480 may be determined using the motion vector 2264 determined based on the information obtained from the bitstream or the pre-determined motion vector.

In addition, for example, the spatial reference block 2280 may be determined using the block vector 2262 determined based on the information obtained from the bitstream or the pre-determined block vector, and the temporal reference block 2480 may be determined using the motion vector 2264 determined based on the information obtained from the bitstream or the pre-determined motion vector.

According to one or more embodiments, the prediction decoder 2030 may determine the spatial reference block 2280, based on the block vector 2262, the pre-determined block vector, or template matching, and may determine the temporal reference block 2480, based on a motion vector 2292 of the spatial reference block 2280. This takes into account a case where the motion vector 2292 and a reference picture index are stored for the spatial reference block 2280.

For example, when the spatial reference block 2280 is reconstructed according to a block indicated by the motion vector 2292 in the previous picture 2400 indicated by the reference picture index, namely, when the spatial reference block 2280 is reconstructed through inter prediction, the prediction decoder 2030 may use, as the temporal reference block 2480, a block used to reconstruct the spatial reference block 2280.

When the spatial reference block 2280 is determined based on template matching or the pre-determined block vector and the temporal reference block 2480 is determined based on the motion vector 2292 of the spatial reference block 2280, the information for indicating the locations of the spatial reference block 2280 and the temporal reference block 2480 of the current block 2250 does not need to be included in the bitstream, so the bitrate of the bitstream may be reduced.

As described below, the prediction decoder 2030 may determine the spatial reference block 2280 within the current picture 2200, and, when it is not possible to derive an intra prediction mode from the spatial reference block 2280, may determine the temporal reference block 2480 within the previous picture 2400. According to one or more embodiments, the prediction decoder 2030 may determine the temporal reference block 2480 within the previous picture 2400, and, when it is not possible to derive an intra prediction mode from the temporal reference block 2480, may determine the spatial reference block 2280 within the current picture 2200.

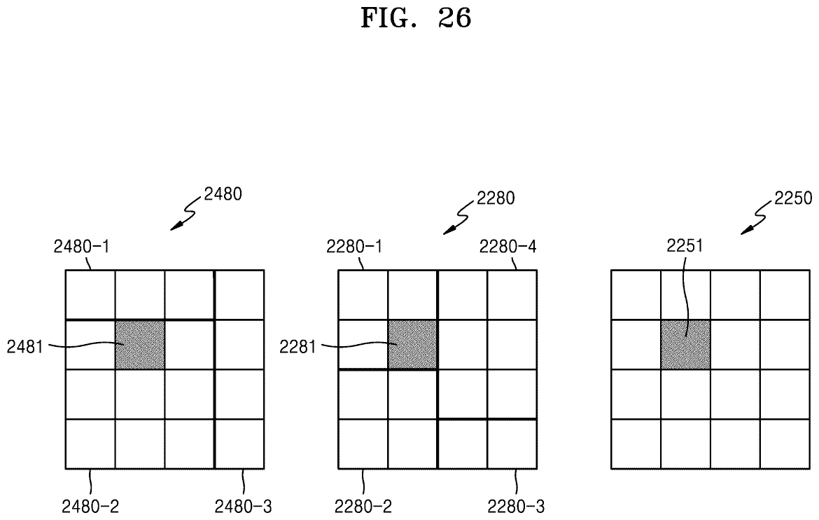

FIG. 26 is a diagram for explaining a method of determining an intra prediction mode of a reference block as an intra prediction mode of a current block, according to one or more embodiments.

The prediction decoder 2030 may identify a pre-determined location within the current block 2250, in order to obtain an intra prediction mode of the current block 2250 from at least one of the spatial reference block 2280 or the temporal reference block 2480.

The pre-determined location may be agreed between the image decoding apparatus 2000 and an image encoding apparatus. For example, when a location of a left upper sample of the current block 2250 is (x, y) (where x and y are integers greater than or equal to 0), the pre-determined location may be (x+w/2, y+h/2). Here, w (w is an integer greater than or equal to 1) may be a width of the current block 2250, and h (h is an integer greater than or equal to 1) may be a height of the current block 2250.

According to one or more embodiments, the pre-determined location within the current block 2250 may be identified based on the information obtained from the bitstream. According to one or more embodiments, information about the pre-determined location within the current block 2250 may be signaled via a packet separate from the bitstream.

According to one or more embodiments, the prediction decoder 2030 may identify a corresponding location of the pre-determined location within the current block 2250 from at least one of the spatial reference block 2280 or the temporal reference block 2480. The corresponding location may refer to a position within a reference block (e.g., first reference block, second reference block) that maps (e.g., geometrically) to the pre-determined location within the current block 2250.

Because the spatial reference block 2280 and the temporal reference block 2480 correspond to areas determined through, for example, template matching, the spatial reference block 2280 and the temporal reference block 2480 may be divided as one or more blocks reconstructed according to different prediction modes.

For example, the spatial reference block 2280 illustrated in FIG. 26 may be reconstructed by being divided into a first sub-block 2280-1, a second sub-block 2280-2, a third sub-block 2280-3, and a fourth sub-block 2280-4. In this case, the first sub-block 2280-1, the second sub-block 2280-2, the third sub-block 2280-3, and the fourth sub-block 2280-4 may be reconstructed independently of each other. For example, the first sub-block 2280-1 and the third sub-block 2280-3 may be reconstructed according to an inter mode, and the second sub-block 2280-2 and the fourth sub-block 2280-4 may be reconstructed according to an intra mode. When the second sub-block 2280-2 and the fourth sub-block 2280-4 are reconstructed according to an intra mode, an intra prediction mode of the second sub-block 2280-2 and an intra prediction mode of the fourth sub-block 2280-4 may be the same as or different from each other.

The temporal reference block 2480 illustrated in FIG. 26 may be reconstructed by being divided into a first sub-block 2480-1, a second sub-block 2480-2, and a third sub-block 2480-3. In this case, the first sub-block 2480-1, the second sub-block 2480-2, and the third sub-block 2480-3 may be reconstructed independently of each other. For example, the first sub-block 2480-1 and the third sub-block 2480-3 may be reconstructed according to an inter mode, and the second sub-block 2480-2 may be reconstructed according to an intra mode.

The first sub-block 2280-1, the second sub-block 2280-2, the third sub-block 2280-3, and the fourth sub-block 2280-4 of the spatial reference block 2280, and the first sub-block 2480-1, the second sub-block 2480-2, and the third sub-block 2480-3 of the temporal reference block 2480 may each correspond to a coding unit split from the current picture 2200 or the previous picture 2400.

Because the spatial reference block 2280 and the temporal reference block 2480 may include a plurality of coding units, the prediction decoder 2030 may identify a location corresponding to a pre-determined location in the current block 2250 from at least one of the spatial reference block 2280 or the temporal reference block 2480, and may obtain an intra prediction mode used to reconstruct a sample at the identified corresponding location.

For example, when the location of the left upper sample of the current block 2250 based on the upper left sample of the current picture 2200 is (x, y) (where x and y are integers greater than or equal to 0), the pre-determined location is (a, b) (where a and b are integers greater than or equal to 0), and a location of a left upper sample of the spatial reference block 2280 or the temporal reference block 2480 based on the left upper sample of the current picture 2200 or the previous picture 2400 is (m, n) (where m and n are integers greater than or equal to 0), a corresponding location in the spatial reference block 2280 or the temporal reference block 2480 may be (m+a−x, n+b−y).

As illustrated in FIG. 26, corresponding locations 2281 and 2481 of a pre-determined location 2251 within the current block 2250 may be included within the first sub-block 2280-1 of the spatial reference block 2280 and the second sub-block 2480-2 of the temporal reference block 2480.

The prediction decoder 2030 may determine the intra prediction mode of the current block 2250 using the intra prediction mode used to reconstruct samples at the corresponding locations 2281 and 2481 (or sub-blocks 2280-1 and 2480-2 including the corresponding locations 2281 and 2481) included in at least one of the spatial reference block 2280 or the temporal reference block 2480.

According to one or more embodiments, the prediction decoder 2030 may determine the spatial reference block 2280 within the current picture 2200, and may determine, as the intra prediction mode of the current block 2250, an intra prediction mode used to reconstruct the sample at the corresponding location 2281 within the spatial reference block 2280.

According to one or more embodiments, when the intra prediction mode is not used to reconstruct the sample at the corresponding location 2281 within the spatial reference block 2280, the prediction decoder 2030 may determine the temporal reference block 2480 within the previous picture 2400, and may determine, as the intra prediction mode of the current block 2250, an intra prediction mode used to reconstruct the sample at the corresponding location 2481 within the temporal reference block 2480. For example, when the sample at the corresponding location 2281 within the spatial reference block 2280 is reconstructed according to an inter mode, the prediction decoder 2030 may determine the temporal reference block 2480 within the previous picture 2400, and may determine, as the intra prediction mode of the current block 2250, an intra prediction mode used to reconstruct the sample at the corresponding location 2281 within the temporal reference block 2480.

According to one or more embodiments, when the intra prediction mode is not used to reconstruct the sample at the corresponding location 2481 within the temporal reference block 2480, the prediction decoder 2030 may determine the spatial reference block 2280 within the current picture 2200, and may determine, as the intra prediction mode of the current block 2250, an intra prediction mode used to reconstruct the sample at the corresponding location 2281 within the spatial reference block 2280.

According to one or more embodiments, when the intra prediction mode is not used to reconstruct the sample at the corresponding location 2281 within the spatial reference block 2280 and the intra prediction mode is not used to reconstruct the sample at the corresponding location 2481 within the temporal reference block 2480, the prediction decoder 2030 may determine a pre-determined intra prediction mode, for example, a planar mode, as the intra prediction mode of the current block 2250.

According to one or more embodiments, the prediction decoder 2030 may select one intra prediction mode from among the intra prediction mode used to reconstruct the sample at the corresponding location 2281 within the spatial reference block 2280 and the intra prediction mode used to reconstruct the sample at the corresponding location 2481 within the temporal reference block 2480, and may determine the selected intra prediction mode as the intra prediction mode of the current block 2250.

According to one or more embodiments, the information obtained from the bitstream may be used to select one intra prediction mode from among the intra prediction mode used to reconstruct the sample at the corresponding location 2281 within the spatial reference block 2280 and the intra prediction mode used to reconstruct the sample at the corresponding location 2481 within the temporal reference block 2480.

For example, the obtainer 2010 may obtain information, from the bitstream, information indicating one intra prediction mode from among the intra prediction mode used to reconstruct the sample at the corresponding location 2281 within the spatial reference block 2280 and the intra prediction mode used to reconstruct the sample at the corresponding location 2481 within the temporal reference block 2480, and the prediction decoder 2030 may determine the intra prediction mode indicated by the obtained information as the intra prediction mode of the current block 2250.

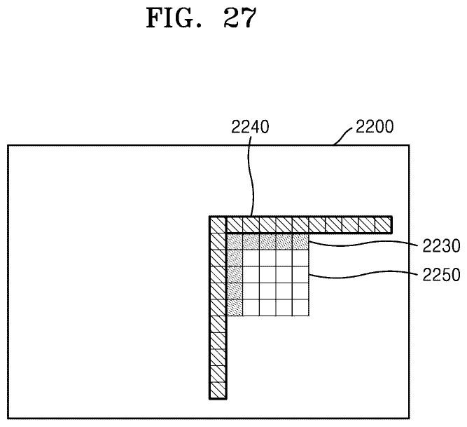

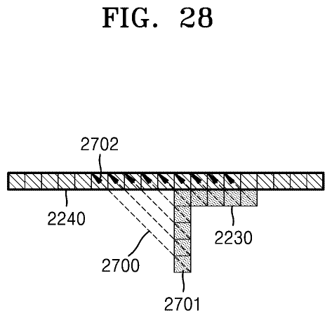

According to one or more embodiments, the prediction decoder 2030 may apply the intra prediction mode of the spatial reference block 2280 and the intra prediction mode of the temporal reference block 2480 to a neighboring sample set of the current block 2250 in order to select one intra prediction mode from among the intra prediction modes used to reconstruct the sample at the corresponding location 2281 in the spatial reference block 2280 (hereinafter, referred to as the intra prediction mode of the spatial reference block 2280) and the intra prediction mode used to reconstruct the sample at the corresponding position 2481 in the temporal reference block 2480 (hereinafter, referred to as the intra prediction mode of the temporal reference block 2480). This will be described with reference to FIGS. 27 and 28.

FIG. 27 is a diagram illustrating neighboring samples that may be used for intra prediction with respect to a neighboring sample set of a current block, according to one or more embodiments.

According to one or more embodiments, a neighboring sample set 2230 of the current block 2250 may correspond to the neighboring samples 2210 illustrated in FIG. 22, which are used for intra prediction with respect to the current block 2250.

According to one or more embodiments, the neighboring sample set 2230 of the current block 2250 may correspond to the template 2220 of the current block 2250 illustrated in FIG. 24.

Because the neighboring sample set 2230 of the current block 2250 includes samples reconstructed before the current block 2250, intra prediction according to the intra prediction mode of the spatial reference block 2280 and the intra prediction mode of the temporal reference block 2480 may be performed, and then which intra prediction mode is more useful for the current block 2250 may be selected.

For intra prediction on the neighboring sample set 2230 of the current block 2250, neighboring samples 2240 adjacent to the neighboring sample set 2230 may be identified.

When a height of the neighboring sample set 2230 is k (where k is an integer greater than or equal to 1), 2k+1 samples adjacent to a left side of the neighboring sample set 2230 may be identified, and, when a width of the neighboring sample set 2230 is I (where I is an integer greater than or equal to 1), 21 samples adjacent to a top of the neighboring sample set 2230 may be identified.

According to one or more embodiments, the prediction decoder 2030 may obtain a first prediction sample set of the neighboring sample set 2230 using the neighboring samples 2240 of the neighboring sample set 2230 as reference samples according to the intra prediction mode of the spatial reference block 2280, and may obtain a second prediction sample set of the neighboring sample set 2230 using the neighboring samples 2240 of the neighboring sample set 2230 as reference samples according to the intra prediction mode of the temporal reference block 2480.

According to one or more embodiments, to perform intra prediction baded on the intra prediction mode of the spatial reference block 2280 with respect to the neighboring sample set 2230, the neighboring samples 2240 may be filtered according to the intra prediction mode of the spatial reference block 2280. In addition, according to one or more embodiments, to perform intra prediction based on the intra prediction mode of the temporal reference block 2480 with respect to the neighboring sample set 2230, the neighboring samples 2240 may be filtered according to the intra prediction mode of the temporal reference block 2480.

FIG. 28 is a diagram for explaining a process of predicting a neighboring sample set using neighboring samples of the neighboring sample set, according to an intra prediction mode, according to one or more embodiments.

As described above with reference to FIG. 23, according to one or more embodiments, the prediction decoder 2030 may identify samples respectively corresponding to the samples in the neighboring sample set 2230 from among the neighboring samples 2240 of the neighboring sample set 2230, and may apply sample values of the identified samples to a preset operation equation to calculate a prediction sample set of the neighboring sample set 2230.

For example, to obtain a prediction sample of a left lower sample 2701 in the neighboring sample set 2230, a neighboring sample 2702 among the neighboring samples 2240 of the neighboring sample set 2230 may be identified along a direction 2700 indicated by the intra prediction mode of the spatial reference block 2280 or the intra prediction mode of the temporal reference block 2480. As a sample value of the identified neighboring sample 2702 is applied to the preset operation equation, a prediction sample value of the left lower sample 2701 in the neighboring sample set 2230 may be obtained.

The prediction decoder 2030 may obtain a first prediction sample set or second prediction sample set of the neighboring sample set 2230 by performing intra prediction with respect to the neighboring sample set 2230 according to the intra prediction mode of the spatial reference block 2280 or the intra prediction mode of the temporal reference block 2480, based on the neighboring samples 2240 of the neighboring sample set 2230.

When the first prediction sample set and the second prediction sample set are obtained, the prediction decoder 2030 may select one intra prediction mode from among the intra prediction mode of the spatial reference block 2280 and the intra prediction mode of the temporal reference block 2480, based on a comparison result of a comparison between the neighboring sample set 2230 and the first prediction sample set and a comparison result of a comparison between the neighboring sample set 2230 and the second prediction sample set.

According to one or more embodiments, the comparison results may be based on difference values between sample values within the neighboring sample set 2230 and sample values within the first prediction sample set and the second prediction sample set. For example, when a sum of the difference values between the sample values of the neighboring sample set 2230 and the sample values in the first prediction sample set is less than a sum of the difference values between the sample values of the neighboring sample set 2230 and the sample values in the second prediction sample set, the prediction decoder 2030 may select the intra prediction mode of the spatial reference block 2280 as the intra prediction mode of the current block 2250.

According to one or more embodiments, the comparison result between the neighboring sample set 2230 and the first prediction sample set (or the second prediction sample set) may use a sum of absolute difference (SAD), a sum of Absolute Transformed Difference (SATD), or a histogram of oriented gradient (HoG).

When the intra prediction mode of the current block 2250 is determined, the prediction decoder 2030 may obtain a prediction block of the current block 2250 by performing intra prediction on the current block 2250 according to the intra prediction mode of the current block 2250.

One or more embodiments in which intra prediction is performed on the current block 2250 according to one intra prediction mode has been described above. However, according to one or more embodiments, intra prediction may be performed on the current block 2250 according to two or more intra prediction modes.

According to one or more embodiments, the prediction decoder 2030 may obtain a first prediction block by performing intra prediction on the current block 2250 according to the intra prediction mode of the spatial reference block 2280 or the intra prediction mode of the temporal reference block 2480.

For example, when it is possible to derive an intra prediction mode from the spatial reference block 2280, the first prediction block may be obtained based on the intra prediction mode of the spatial reference block 2280. When it is not possible to derive an intra prediction mode from the spatial reference block 2280, the first prediction block may be obtained based on the intra prediction mode of the temporal reference block 2480. In addition, for example, when it is possible to derive an intra prediction mode from the temporal reference block 2480, the first prediction block may be obtained based on the intra prediction mode of the temporal reference block 2480. When it is not possible to derive an intra prediction mode from the temporal reference block 2480, the first prediction block may be obtained based on the intra prediction mode of the spatial reference block 2280. In addition, for example, when it is possible to derive an intra prediction mode from both the spatial reference block 2280 and the temporal reference block 2480, the first prediction block may be obtained according to an intra prediction mode selected from the intra prediction mode of the spatial reference block 2280 and the intra prediction mode of the temporal reference block 2480.

The prediction decoder 2030 may obtain a second prediction block by performing intra prediction on the current block 2250 according to the pre-determined intra prediction mode (e.g., a planar mode). The prediction decoder 2030 may obtain a third prediction block based on a weighted sum of the first prediction block and the second prediction block, and reconstruct the current block 2250 using the third prediction block.

According to one or more embodiments, the prediction decoder 2030 may obtain the first prediction block by performing intra prediction on the current block 2250 according to the intra prediction mode of the spatial reference block 2280 or the intra prediction mode of the temporal reference block 2480, and may determine the spatial reference block 2280 or the temporal reference block 2480 as the second prediction block. The prediction decoder 2030 may also obtain the third prediction block based on a weighted sum of the first prediction block and the second prediction block, and reconstruct the current block 2250 using the third prediction block.

According to one or more embodiments, when the first prediction block is generated according to the intra prediction mode of the spatial reference block 2280, the spatial reference block 2280 may be determined as the second prediction block. When the first prediction block is generated according to the intra prediction mode of the temporal reference block 2480, the temporal reference block 2480 may be determined as the second prediction block. Because the spatial reference block 2280 and the temporal reference block 2480 also correspond to blocks found as being similar to the current block 2250, the accuracy of prediction may be improved using the spatial reference block 2280 or the temporal reference block 2480 as a prediction block.

According to one or more embodiments, the prediction decoder 2030 may obtain the first prediction block by performing intra prediction on the current block 2250 according to the intra prediction mode of the spatial reference block 2280, and may obtain the second prediction block by performing intra prediction on the current block 2250 according to the intra prediction mode of the temporal reference block 2480. The prediction decoder 2030 may also obtain the third prediction block based on a weighted sum of the first prediction block and the second prediction block, and reconstruct the current block 2250 using the third prediction block.

According to one or more embodiments, when it is not possible to derive an intra prediction modes from both the spatial reference block 2280 and the temporal reference block 2480, the prediction decoder 2030 may obtain the first prediction block by performing intra prediction on the current block 2250 according to a pre-determined first intra prediction mode (e.g., a planar mode), and may obtain the second prediction block by performing intra prediction on the current block 2250 according to a pre-determined second intra prediction mode (e.g., a DC mode). The prediction decoder 2030 may also obtain the third prediction block based on a weighted sum of the first prediction block and the second prediction block, and reconstruct the current block 2250 using the third prediction block.

For the weighted sum described above or a weighted sum described below, according to one or more embodiments, a weight applied to the first prediction block and a weight applied to the second prediction block may be determined according to the information obtained from the bitstream.

According to one or more embodiments, the weight applied to the first prediction block and the weight applied to the second prediction block may be pre-determined. For example, the weight applied to the first prediction block and the weight applied to the second prediction block may be each pre-determined to be ½.

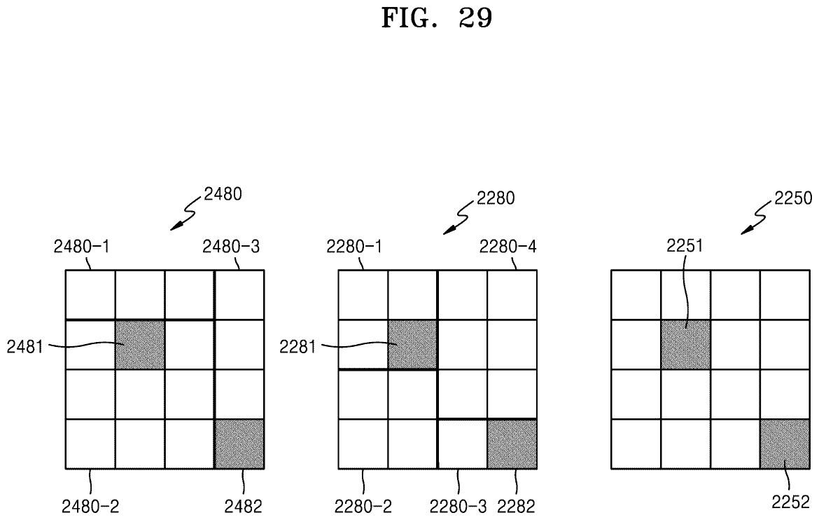

FIG. 29 is a diagram for explaining a method of determining an intra prediction mode of a reference block as an intra prediction mode of a current block, according to one or more embodiments.

According to one or more embodiments, the number of pre-determined locations within the current block 2250 for determining the intra prediction mode of the current block 2250 may be plural.

The plurality of pre-determined locations may be agreed between the image decoding apparatus 2000 and an image encoding apparatus. For example, when a location of a left upper sample of the current block 2250 is (x, y) (where x and y are integers greater than or equal to 0), the plurality of pre-determined locations may be (x, y) and (x+w/2, y+h/2). Here, w (w is an integer greater than or equal to 1) may be a width of the current block 2250, and h (h is an integer greater than or equal to 1) may be a height of the current block 2250.

According to one or more embodiments, the plurality of pre-determined locations within the current block 2250 may be identified based on the information obtained from the bitstream. According to one or more embodiments, information about the plurality of pre-determined locations within the current block 2250 may be signaled via a packet separate from the bitstream.

According to one or more embodiments, the prediction decoder 2030 may identify a plurality of corresponding locations of the plurality of pre-determined locations within the current block 2250 from at least one of the spatial reference block 2280 or the temporal reference block 2480.

For example, when the location of the left upper sample of the current block 2250 based on the upper left sample of the current picture 2200 is (x, y), a pre-determined first location 2251 is (a, b) (where a and b are integers greater than or equal to 0), and a location of a left upper sample of the spatial reference block 2280 or the temporal reference block 2480 based on the left upper sample of the current picture 2200 or the previous picture 2400 is (m, n) (where m and n are integers greater than or equal to 0), a plurality of corresponding locations 2281, 2282, 2481, and 2482 in the spatial reference block 2280 or the temporal reference block 2480 may be (m+a−x, n+b−y) and (m+c−x, n+d−y).

Referring to FIG. 29, the corresponding locations 2281 and 2481 corresponding to the pre-determined first location 2251 within the current block 2250 may be identified from the first sub-block 2280-1 of the spatial reference block 2280 and the second sub-block 2480-2 of the temporal reference block 2480. The corresponding locations 2282 and 2482 corresponding to the pre-determined second location 2252 within the current block 2250 may be identified from the third sub-block 2280-3 of the spatial reference block 2280 and the third sub-block 2480-3 of the temporal reference block 2480.

When the plurality of corresponding locations 2281, 2282, 2481, and 2482 are identified from at least one of the spatial reference block 2280 or the temporal reference block 2480, the prediction decoder 2030 may perform intra prediction on the current block 2250 according to at least one intra prediction mode used to reconstruct samples at the plurality of corresponding locations 2281, 2282, 2481, and 2482.

According to one or more embodiments, when it is not possible to derive an intra prediction mode from the plurality of corresponding locations 2281 and 2282 of the spatial reference block 2280, the prediction decoder 2030 may determine the temporal reference block 2480, and may perform intra prediction on the current block 2250 according to at least one intra prediction mode used to reconstruct the samples at the plurality of corresponding locations 2481 and 2482 within the temporal reference block 2480.

According to one or more embodiments, when it is not possible to derive an intra prediction mode from the plurality of corresponding locations 2481 and 2482 of the temporal reference block 2480, the prediction decoder 2030 may determine the spatial reference block 2280, and may perform intra prediction on the current block 2250 according to at least one intra prediction mode used to reconstruct the samples at the plurality of corresponding locations 2281 and 2282 within the spatial reference block 2280.

According to one or more embodiments, the prediction decoder 2030 may determine the spatial reference block 2280 and the temporal reference block 2480 within the current picture 2200 and the previous picture 2400, respectively, and may perform intra prediction on the current block 2250 according to at least one intra prediction mode used to reconstruct the samples at the plurality of corresponding locations 2281, 2282, 2481, and 2482 within the spatial reference block 2280 and the temporal reference block 2480.

According to one or more embodiments, when one intra prediction mode is used to reconstruct the samples at the plurality of corresponding locations 2281, 2282, 2481, and 2482, namely, when an intra prediction mode is used to reconstruct a sample at one corresponding location and an intra prediction mode is not used to reconstruct samples at other corresponding locations, the prediction decoder 2030 may perform intra prediction on the current block 2250 according to one available intra prediction mode.

According to one or more embodiments, when one intra prediction mode is used to reconstruct the samples at the plurality of corresponding locations 2281, 2282, 2481, and 2482, the prediction decoder 2030 may obtain the first prediction block by performing intra prediction on the current block 2250 according to the one available intra prediction mode. The prediction decoder 2030 may obtain the second prediction block by performing intra prediction on the current block 2250 according to the pre-determined intra prediction mode (e.g., a planar mode), or may determine the temporal reference block 2480 or the spatial reference block 2280 as the second prediction block. The prediction decoder 2030 may reconstruct the current block 2250 using the third prediction block generated based on a weighted sum of the first prediction block and the second prediction block.

According to one or more embodiments, when two intra prediction modes are used to reconstruct the samples at the plurality of corresponding locations 2281, 2282, 2481, and 2482, the prediction decoder 2030 may obtain the first prediction block by performing intra prediction on the current block 2250 according to one intra prediction mode among the two intra prediction modes. The prediction decoder 2030 may obtain the second prediction block by performing intra prediction on the current block 2250 according to the other intra prediction mode among the two intra prediction modes. The prediction decoder 2030 may reconstruct the current block 2250 using the third prediction block generated based on a weighted sum of the first prediction block and the second prediction block.

According to one or more embodiments, the prediction decoder 2030 may select one intra prediction mode from a plurality of intra prediction modes used to reconstruct the samples at the plurality of corresponding locations 2281, 2282, 2481, and 2482, and may generate a prediction block by performing intra prediction on the current block 2250 according to the selected intra prediction mode. In order to select one intra prediction mode, the prediction decoder 2030 may perform intra prediction on the neighboring sample set 2230 of the current block 2250 according to the plurality of intra prediction modes, and may consider a difference between each of a plurality of prediction sample sets generated as a result of performing the intra prediction and the neighboring sample set 2230. Because a process of performing intra prediction on the neighboring sample set 2230 in order to select one intra prediction mode from among several intra prediction modes has been described above with reference to FIGS. 27 and 28, a detailed description thereof is omitted here.

According to one or more embodiments, the prediction decoder 2030 may obtain the first prediction block by performing intra prediction on the current block 2250 according to the one intra prediction mode selected from the plurality of intra prediction modes. The prediction decoder 2030 may obtain the second prediction block by performing intra prediction on the current block 2250 according to the pre-determined intra prediction mode (e.g., a planar mode), or may determine the temporal reference block 2480 or the spatial reference block 2280 as the second prediction block. The prediction decoder 2030 may reconstruct the current block 2250 using the third prediction block generated based on a weighted sum of the first prediction block and the second prediction block.

According to one or more embodiments, the prediction decoder 2030 may select the first intra prediction mode and the second intra prediction mode from among the plurality of intra prediction modes, and obtain the first prediction block by performing intra prediction on the current block 2250 according to the first intra prediction mode. The prediction decoder 2030 may obtain the second prediction block by performing intra prediction on the current block 2250 according to the second intra prediction mode, and reconstruct the current block 2250 using the third prediction block generated based on a weighted sum of the first prediction block and the second prediction block.

According to one or more embodiments, in order to select the first intra prediction mode and the second intra prediction mode from among the plurality of intra prediction modes, the prediction decoder 2030 may perform intra prediction on the neighboring sample set 2230 of the current block 2250 according to the plurality of intra prediction modes, and may consider the difference between each of the plurality of prediction sample sets generated as a result of performing the intra prediction and the neighboring sample set 2230. The prediction decoder 2030 may determine two prediction sample sets in the order of a smallest difference from the neighboring sample set 2230, and may select two intra prediction modes used to generate the two prediction sample sets as the first intra prediction mode and the second intra prediction mode, respectively.

According to one or more embodiments, when an intra prediction mode is not used to reconstruct the samples at the plurality of corresponding locations 2281, 2282, 2481, and 2482, the prediction decoder 2030 may perform intra prediction on the current block 2250 according to the pre-determined intra prediction mode (e.g., a planar mode).

According to one or more embodiments, when an intra prediction mode is not used to reconstruct the samples at the plurality of corresponding locations 2281, 2282, 2481, and 2482, the prediction decoder 2030 may obtain the first prediction block by performing intra prediction on the current block 2250 according to the pre-determined first intra prediction mode (e.g., a planar mode), or may obtain the second prediction block by performing intra prediction on the current block 2250 according to the pre-determined second intra prediction mode (e.g., a DC mode). The prediction decoder 2030 may reconstruct the current block 2250 using the third prediction block generated based on a weighted sum of the first prediction block and the second prediction block.

According to the above-described embodiment, even when a corresponding location of a pre-determined location within the current block 2250 is identified from at least one of the spatial reference block 2280 or the temporal reference block 2480, when an inter mode is used to reconstruct a sample of the corresponding location, it becomes impossible to derive an intra prediction mode of the current block 2250 from the corresponding location.

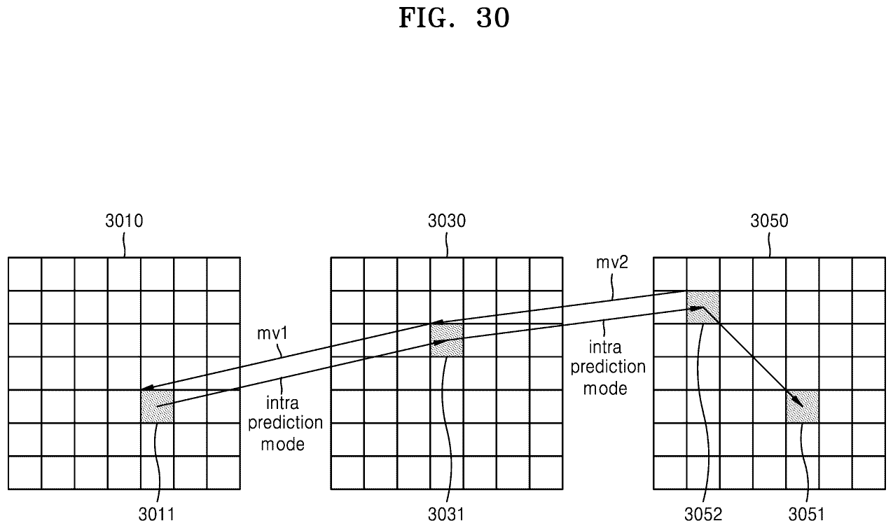

According to one or more embodiments, the intra prediction mode of the current block 2250 may be derived from the sample reconstructed in the inter mode through a propagation process of the intra prediction mode. This will be described with reference to FIG. 30.

FIG. 30 is a diagram for describing a process of propagating an intra prediction mode, according to one or more embodiments.

Referring to FIG. 30, a first picture 3010 is an intra picture, and all blocks within the first picture 3010 may be reconstructed through an intra mode. Intra prediction modes of the blocks within the first picture 3010 may be determined through a bitstream or may be determined from spatial reference blocks of the blocks. For example, an intra prediction mode of a first block 3011 in the first picture 3010 may be derived from a spatial reference block of the first block 3011 in the first picture 3010.

A second picture 3030 may be a picture decoded later than the first picture 3010. Some of the blocks in the second picture 3030 may be reconstructed according to an intra mode, and others may be reconstructed according to an inter mode.

For example, when a second block 3031 in the second picture 3030 is inter-predicted using the first block 3011 in the first picture 3010 as a reference block, the intra-prediction mode of the first block 3011 indicated by a motion vector mv1 of the second block 3031 may be propagated to the second block 3031. For blocks to which the intra mode is applied from among the blocks in the second picture 3030, the intra prediction mode may be determined from a spatial reference block or a temporal reference block according to the above-described embodiment.

A third picture 3050 may be a picture decoded later than the second picture 3030, and, when an intra mode is applied to a third block 3051 in the third picture 3050, an intra prediction mode of the third block 3051 may be derived from a fourth block 3052, which is a spatial reference block of the third block 3051. Even when the inter mode is applied to the fourth block 3052, the intra prediction mode of the second block 3031 indicated by a motion vector mv2 of the fourth block 3052 may be propagated to the fourth block 3052, and thus the intra prediction mode of the third block 3051 may be derived from the fourth block 3052.

According to the embodiment described above with reference to FIGS. 26 and 29, when a sample at a corresponding location within the spatial reference block 2280 is reconstructed according to an inter mode, an intra prediction mode may not be derived from the corresponding location. However, through the propagation process of the intra prediction mode illustrated in FIG. 30, an intra prediction mode may be derived from a sample reconstructed according to an inter mode.

According to one or more embodiments, blocks into which the first picture 3010, the second picture 3030, and the third picture 3050 illustrated in FIG. 30 are split may each be a storage unit of the intra prediction mode. For example, sizes of the blocks into which the first picture 3010, the second picture 3030, and the third picture 3050 are split may each be 4×4, which may mean that the intra prediction mode is stored in units of blocks each having a size 4×4 for the first picture 3010, the second picture 3030, and the third picture 3050. According to one or more embodiments, each of the first picture 3010, the second picture 3030, and the third picture 3050 may be reconstructed based on blocks split according to a different split form than a block split form illustrated in FIG. 30.

A method of determining an intra prediction mode of the current block 2250, and a method of performing intra prediction on the current block 2250 have been described through the above-described embodiment. However, the above-described embodiment is independently applicable to each of a luma component and a chroma component of the current block 2250. For example, an intra prediction mode for the luma component of the current block 2250 may be determined from the spatial reference block 2280 and/or the temporal reference block 2480, and intra prediction may be applied to the luma component of the current block 2250 according to the determined intra prediction mode. In addition, an intra prediction mode for the luma component of the current block 2250 may be determined from the spatial reference block 2280 and/or the temporal reference block 2480 (these may be different from the spatial reference block 2280 and/or the temporal reference block 2480 for the luma component), and intra prediction may be applied to the luma component of the current block 2250 according to the determined intra prediction mode.

According to one or more embodiments, the intra prediction mode determined for the luma component of the current block 2250 may also be applied equally to the chroma component of the current block 2250.

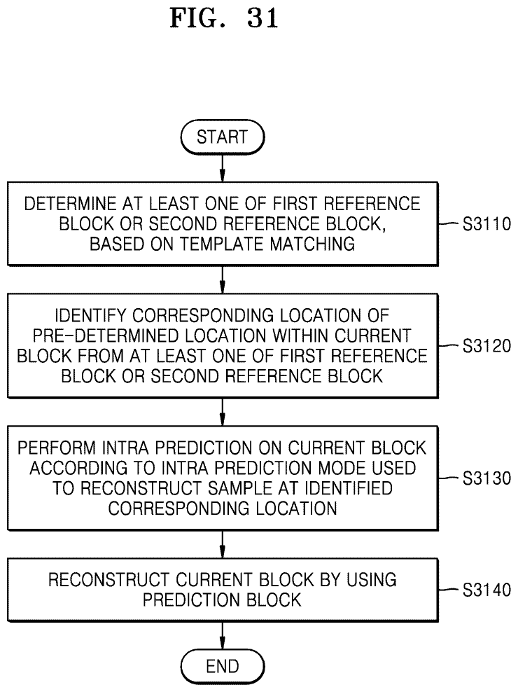

FIG. 31 is a flowchart of an image decoding method according to one or more embodiments. In the following embodiments, each operation may be performed sequentially. Alternatively, the order of each operation may be changed, and at least two operations may also be performed in parallel. In some examples, one or more operations may be skipped or repeated one or more times.

In operation S3110, the image decoding apparatus 2000 may determine, based on template matching, at least one of a first reference block in the current picture 2200 reconstructed before the current block 2250 or a second reference block in the previous picture 2400 reconstructed before the current block 2250.

The first reference block may refer to as the spatial reference block 2280, and the second reference block may be refer to as the temporal reference block 2480.

According to the one or more embodiments, both the first reference block and the second reference block may be determined based on template matching.

According to one or more embodiments, the first reference block may be determined using a block vector determined based on information obtained from a bitstream or a pre-determined block vector, and the temporal reference block may be determined based on template matching.

According to one or more embodiments, the first reference block may be determined based on template matching, and the second reference block may be determined using a motion vector determined based on the information obtained from the bitstream or a pre-determined motion vector.

According to one or more embodiments, the first reference block may be determined using a block vector determined based on the information obtained from the bitstream or a pre-determined block vector, and the second reference block may be determined using the motion vector determined based on the information obtained from the bitstream or the pre-determined motion vector.

According to one or more embodiments, the first reference block may be determined based on the block vector or template matching, and the second reference block may be determined based on the motion vector of the first reference block.

According to one or more embodiments, when it is impossible to derive an intra prediction mode from the first reference block, the second reference block may be determined within the previous picture 2400.

According to one or more embodiments, when it is impossible to derive an intra prediction mode from the second reference block, the first reference block may be determined within the current picture 2200.

In operation S3120, the image decoding apparatus 2000 may identify the corresponding locations 2281 and 2481 of the pre-determined location 2251 within the current block 2250 from at least one of the first reference block or the second reference block.

According to one or more embodiments, the number of pre-determined locations 2251 and 2252 may be more than one. In this case, the plurality of corresponding locations 2281, 2282, 2481, and 2482 may be identified from at least one of the first reference block or the second reference block.

In operation S3130, the image decoding apparatus 2000 may generate a prediction block by performing intra prediction on the current block 2250 according to an intra prediction mode used to reconstruct the samples at the identified corresponding locations 2281 and 2481.

According to one or more embodiments, the image decoding apparatus 2000 may generate the first prediction block by performing intra prediction on the current block 2250 according to one intra prediction mode, or may generate the second prediction block by performing intra prediction on the current block 2250 according to another intra prediction mode. The image decoding apparatus 2000 may also generate the third prediction block based on a weighted sum of the first prediction block and the second prediction block.

A method of determining an intra prediction mode of the current block 2250 and a method of generating a prediction block by performing intra prediction on the current block 2250 have been described above with reference to FIGS. 21 through 23 and FIGS. 26 through 30, and thus detailed descriptions thereof will be omitted.

In operation S3140, the image decoding apparatus 2000 may reconstruct the current block 2250 using the prediction block or the third prediction block.

According to one or more embodiments, the image decoding apparatus 2000 may determine the prediction block or the third prediction block as a reconstructed current block.

According to one or more embodiments, the image decoding apparatus 2000 may generate the reconstructed current block by combining the residual data obtained from the bitstream with the prediction block or the third prediction block.

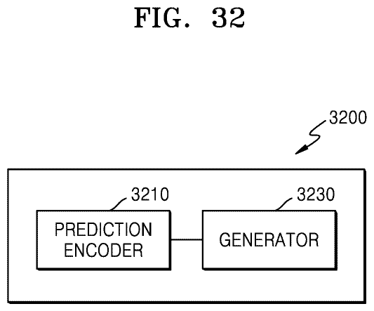

FIG. 32 is a block diagram of an image encoding apparatus according to one or more embodiments.

Referring to FIG. 32, an image encoding apparatus 3200 may include a prediction encoder 3210 and a generator 3230.

The prediction encoder 3210 and the generator 3230, according to one or more embodiments, may be implemented as at least one processor. According to one or more embodiments, the prediction encoder 3210 and the generator 3230 may operate according to at least one instruction stored in at least one memory.

The image encoding apparatus 3200 may include at least one memory for storing input/output data of the prediction encoder 3210 and the generator 3230. The image encoding apparatus 3200 may also include a memory controller for controlling data input/output of the memory.

According to one or more embodiments, the prediction encoder 3210 may correspond to the prediction encoder 1915 shown in FIG. 19, and the generator 3630 may correspond to the entropy encoder 1925 shown in FIG. 19.

The prediction encoder 3210 may determine the prediction mode of the current block 2250. The current block 2250 may be a largest coding unit, a coding unit, transformation unit, or prediction unit split from the current picture 2200 desired to be encoded.

According to one or more embodiments, the prediction mode of the current block 2250 may be determined as one of a plurality of prediction modes including an intra mode and an inter mode.

According to one or more embodiments, when the prediction mode of the current block 2250 is an intra mode, the prediction encoder 3210 may determine the intra prediction mode of the current block 2250.

The intra prediction mode of the current block 2250 may be one of a plurality of intra prediction modes. As described above with reference to FIG. 21, the plurality of intra prediction modes may include a non-directional intra mode and a directional intra mode.

According to one or more embodiments, the prediction encoder 3210 may perform intra prediction or inter prediction on the current block 2250 according to the prediction mode of the current block 2250, and encode the current block 2250 using a prediction block generated as a result of performing the intra prediction or the inter prediction.

According to one or more embodiments, the encoding of the current block 2250 may refer to a process of generating information that allows the image decoding apparatus 2000 to reconstruct the current block 2250. Information generated through encoding may be included in a bitstream.

According to one or more embodiments, the prediction encoder 3610 may generate residual data corresponding to a difference between the prediction block and the current block 2250. When the prediction block is determined to be the current block 2250, no residual data may be generated.

When the prediction mode of the current block 2250 is an intra mode, the prediction encoder 3210 according to one or more embodiments may determine a method of determining the intra prediction mode. Information indicating the method of determining the intra prediction mode may be included in the bitstream through the generator 3230.

According to one or more embodiments, the method of determining the intra prediction mode may include a method of deriving the intra prediction mode from a reference block or a method of selecting, based on costs, one intra prediction mode from among a plurality of intra prediction modes.

According to one or more embodiments, information indicating the method of determining the intra prediction mode may be included in a sequence parameter set, a picture parameter set, a slice header, or slice data of the bitstream.

According to one or more embodiments, the prediction encoder 3210 may determine the intra prediction mode of the current block 2250 according to one pre-determined method.

According to one or more embodiments, when the method of determining the intra prediction mode is a method of selecting, based on costs, one intra prediction mode from among a plurality of intra prediction modes, the prediction encoder 3210 may select an intra prediction mode causing the least cost in encoding the current block 2250 from among the plurality of intra prediction modes. Information indicating the selected intra prediction mode may be included in the bitstream. For example, the information indicating the intra prediction mode of the current block 2250 may include a flag or index indicating one intra prediction mode from among the plurality of intra prediction modes.

When the method of determining the intra prediction mode is a method of deriving an intra prediction mode from a reference block, the prediction encoder 3210 according to one or more embodiments may determine at least one reference block from among a reference block in the current picture 2200 encoded earlier than the current block 2250 (hereinafter, the spatial reference block 2280) or a reference block in the previous picture 2400 encoded earlier than the current block 2250 (hereinafter, the temporal reference block 2480).

The prediction encoder 3210 may determine, as the intra prediction mode of the current block 2250, an intra prediction mode derived from at least one of the spatial reference block 2280 or the temporal reference block 2480.

To determine the spatial reference block 2280, the prediction encoder 3210 may determine a block vector indicating the spatial reference block 2280.

To determine the temporal reference block 2480, the prediction encoder 3210 may determine an index of the previous picture 2400 including the temporal reference block 2480 and/or a motion vector indicating the temporal reference block 2480.

When a prediction block is generated through intra prediction with respect to the current block 2250, the prediction encoder 3210 may encode the current block 2250 using the prediction block.

According to one or more embodiments, the prediction encoder 3210 may generate the residual data corresponding to a difference between the prediction block and the current block 2250. The residual data may be included in the bitstream.

The generator 3230 may generate a bitstream generated as a result of encoding a picture. The bitstream may include an encoding result with respect to the current block 2250.

According to one or more embodiments, the generator 3230 may transmit the bitstream to the image decoding apparatus 2000 through a network.

According to one or more embodiments, the generator 3230 may store the bitstream in a data storage medium including magnetic media (such as, a hard disk, a floppy disk, and a magnetic tape), optical recording media (such as, CD-ROM and DVD), and a magneto-optical medium (such as, a floptical disk).

The generator 3230 may generate a bitstream including syntax elements generated by encoding a picture. Values corresponding to the syntax elements may be included in the bitstream according to a layer structure of a picture.

The generator 3230 may obtain bins included in the bitstream by entropy-encoding the syntax elements.

According to one or more embodiments, the bitstream may include information about the prediction mode of the current block 2250 within the current picture 2200.

According to one or more embodiments, when the prediction mode 2250 of the current block 2250 is an intra mode, the bitstream may include at least one of information indicating how the intra prediction mode of the current block 2250 is determined, information indicating the location of a reference block (e.g., the spatial reference block 2280 and/or the temporal reference block 2480), or information about the residual data.

A method, performed by the prediction encoder 3210, of determining the spatial reference block 2280 and the temporal reference block 2480 will now be described.

According to one or more embodiments, the prediction encoder 3210 may determine, according to template matching, at least one of a spatial reference block 2280 in the current picture 2200 encoded before the current block 2250 or a temporal reference block 2480 in the previous picture 2400 encoded before the current block 2250. According to one or more embodiments, the previous picture 2400 may be encoded before the current picture 2200.

During template matching, a neighboring sample set encoded before the current block 2250 may be used as the template 2220.

According to one or more embodiments, the prediction encoder 3210 may search for a template 2270 most similar to the template 2220 from the current picture 2200, using the neighboring sample set of the current block 2250 as the template 2220, and may determine a block adjacent to the found template 2270 as the spatial reference block 2280.

According to one or more embodiments, the prediction encoder 3210 may search for a template 2470 most similar to the template 2220 from the previous picture 2400, using the neighboring sample set of the current block 2250 as the template 2220, and may determine a block adjacent to the found template 2470 as the temporal reference block 2480.

To search for the similar templates 2270 and 2470, the prediction encoder 3210 may determine a basic motion vector. For example, a pre-determined motion vector (e.g., a zero vector) or a motion vector of a block at a pre-determined location may be determined as the basic motion vector.

The prediction encoder 3210 may search for the templates 2270 and 2470 most similar to the template 2220 within a preset range from a point indicated by the basic motion vector, and may determine a block adjacent to the similar templates 2270 and 2470 as the spatial reference block 2280 or the temporal reference block 2480.

According to one or more embodiments, the basic motion vector used to search for the similar template 2270 within the current picture 2200 may be referred to as a basic block vector.

When at least one of the spatial reference block 2280 or the temporal reference block 2480 may be determined through template matching by the prediction encoder 3210, the aforementioned prediction decoder 2030 may also determine at least one of the spatial reference block 2280 or the temporal reference block 2480 through template matching.

According to one or more embodiments, the prediction encoder 3210 may determine the block vector 2262 indicating the location of the spatial reference block 2280. Information indicating the block vector 2262 may be included in the bitstream.

According to one or more embodiments, the information indicating the block vector 2262 may include information representing any one of the block vector candidates included in the block vector candidate set. According to one or more embodiments, the information indicating the block vector 2262 may include a block vector difference between a block vector candidate selected from among the block vector candidates and the block vector 2262 indicating the spatial reference block 2280.

According to one or more embodiments, the prediction encoder 3210 may determine the motion vector 2264 indicating the location of the temporal reference block 2480. Information indicating the motion vector 2264 may be included in the bitstream.

According to one or more embodiments, the information indicating the motion vector 2264 may include information representing any one of the motion vector candidates included in the motion vector candidate set. According to one or more embodiments, the information indicating the motion vector 2264 may include a motion vector difference between a motion vector candidate selected from among the motion vector candidates and the motion vector 2264 indicating the temporal reference block 2480.

According to one or more embodiments, the prediction encoder 3210 may also determine the spatial reference block 2280 indicated by a pre-determined block vector within the current picture 2200. According to one or more embodiments, the prediction encoder 3210 may also determine the temporal reference block 2480 indicated by a pre-determined motion vector within the previous picture 2400. The pre-determined block vector and the pre-determined motion vector may represent a block vector and a motion vector both pre-agreed between the image encoding apparatus 3200 and the image decoding apparatus 2000.

According to one or more embodiments, the spatial reference block 2280 and the temporal reference block 2480 may be determined in various ways.

For example, both the spatial reference block 2280 and the temporal reference block 2480 may be determined based on template matching.

In addition, for example, the spatial reference block 2280 may be determined using the block vector 2262, and the temporal reference block 2480 may be determined based on template matching.

In addition, for example, the spatial reference block 2280 may be determined based on template matching, and the temporal reference block 2480 may be determined using the motion vector 2264.

In addition, for example, the spatial reference block 2280 may be determined using the block vector 2262, and the temporal reference block 2480 may be determined using the motion vector 2264.

In addition, for example, the spatial reference block 2280 may be determined based on the block vector or template matching, and the temporal reference block 2480 may be determined based on the motion vector 2292 of the spatial reference block 2280.

According to one or more embodiments, the prediction encoder 3210 may determine the spatial reference block 2280 within the current picture 2200, and, when it is not possible to derive an intra prediction mode from the spatial reference block 2280, may determine the temporal reference block 2480 within the previous picture 2400.

According to one or more embodiments, the prediction encoder 3210 may determine the temporal reference block 2480 within the previous picture 2400, and, when it is not possible to derive an intra prediction mode from the temporal reference block 2480, may determine the spatial reference block 2280 within the current picture 2200.

When at least one of the spatial reference block 2280 or the temporal reference block 2480 is determined, the prediction encoder 3210 may identify a pre-determined location within the current block 2250 in order to obtain an intra prediction mode of the current block 2250 from at least one of the spatial reference block 2280 or the temporal reference block 2480.

The pre-determined location may be agreed between the image decoding apparatus 2000 and the image encoding apparatus 3200. For example, when a location of a left upper sample of the current block 2250 is (x, y) (where x and y are integers greater than or equal to 0), the pre-determined location may be (x+w/2, y+h/2). Here, w (w is an integer greater than or equal to 1) may indicate a width of the current block 2250, and h (h is an integer greater than or equal to 1) may indicate a height of the current block 2250.

According to one or more embodiments, the prediction encoder 3210 may determine, within the current block 2250, a location for deriving an intra prediction mode, and information about the determined location may be included in the bitstream.

According to one or more embodiments, the prediction encoder 3210 may identify the corresponding locations 2281 and 2481 of the pre-determined location 2251 within the current block 2250 from at least one of the spatial reference block 2280 or the temporal reference block 2480.

The prediction encoder 3210 may determine the intra prediction mode of the current block 2250 using an intra prediction mode used to encode the samples at the corresponding locations 2281 and 2481 included in at least one of the spatial reference block 2280 or the temporal reference block 2480.

According to one or more embodiments, the prediction encoder 3210 may determine the spatial reference block 2280 within the current picture 2200, and may determine, as the intra prediction mode of the current block 2250, an intra prediction mode used to encode the sample at the corresponding location 2281 within the spatial reference block 2280.

According to one or more embodiments, when the intra prediction mode is not used to encode the sample at the corresponding location 2281 within the spatial reference block 2280, the prediction encoder 3210 may determine the temporal reference block 2480 within the previous picture 2400, and may determine, as the intra prediction mode of the current block 2250, an intra prediction mode used to encode the sample at the corresponding location 2481 within the temporal reference block 2480.

According to one or more embodiments, when the intra prediction mode is not used to encode the sample at the corresponding location 2481 within the temporal reference block 2480, the prediction encoder 3210 may determine the spatial reference block 2280 within the current picture 2200, and may determine, as the intra prediction mode of the current block 2250, an intra prediction mode used to encode the sample at the corresponding location 2281 within the spatial reference block 2280.

According to one or more embodiments, when the intra prediction mode is not used to encode the sample at the corresponding location 2281 within the spatial reference block 2280 and the intra prediction mode is not used to encode the sample at the corresponding location 2481 within the temporal reference block 2480, the prediction encoder 3210 may determine a pre-determined intra prediction mode, for example, a planar mode, as the intra prediction mode of the current block 2250.

According to one or more embodiments, the prediction encoder 3210 may select one intra prediction mode from among the intra prediction mode used to encode the sample at the corresponding location 2281 within the spatial reference block 2280 and the intra prediction mode used to encode the sample at the corresponding location 2481 within the temporal reference block 2480, and may determine the selected intra prediction mode as the intra prediction mode of the current block 2250.

According to one or more embodiments, information indicating one intra prediction mode from among the intra prediction mode used to encode the sample at the corresponding location 2281 within the spatial reference block 2280 and the intra prediction mode used to encode the sample at the corresponding location 2481 within the temporal reference block 2480 may be included in the bitstream.

According to one or more embodiments, the prediction encoder 3210 may apply the intra prediction mode of the spatial reference block 2280 and the intra prediction mode of the temporal reference block 2480 to the neighboring sample set 2230 of the current block 2250, in order to select one intra prediction mode from among the intra prediction mode of the spatial reference block 2280 and the intra prediction mode of the temporal reference block 2480.

Because the neighboring sample set 2230 of the current block 2250 includes samples encoded before the current block 2250, the prediction encoder 3210 may perform intra prediction according to the intra prediction mode of the spatial reference block 2280 and the intra prediction mode of the temporal reference block 2480, and determine which intra prediction mode is more useful for the current block 2250.

When the intra prediction mode of the current block 2250 is determined, the prediction encoder 3210 may obtain a prediction block of the current block 2250 by performing intra prediction on the current block 2250 according to the intra prediction mode of the current block 2250.

According to one or more embodiments, the prediction encoder 3210 may obtain a first prediction block by performing intra prediction on the current block 2250 according to the intra prediction mode of the spatial reference block 2280 or the intra prediction mode of the temporal reference block 2480. The prediction encoder 3210 may obtain a second prediction block by performing intra prediction on the current block 2250 according to the pre-determined intra prediction mode (e.g., a planar mode). The prediction encoder 3210 may also obtain a third prediction block based on a weighted sum of the first prediction block and the second prediction block, and encode the current block 2250 using the third prediction block.

According to one or more embodiments, the prediction encoder 3210 may obtain the first prediction block by performing intra prediction on the current block 2250 according to the intra prediction mode of the spatial reference block 2280 or the intra prediction mode of the temporal reference block 2480, and may determine the spatial reference block 2280 or the temporal reference block 2480 as the second prediction block. The prediction encoder 3210 may also obtain the third prediction block based on a weighted sum of the first prediction block and the second prediction block, and encode the current block 2250 using the third prediction block.

According to one or more embodiments, the prediction encoder 3210 may obtain the first prediction block by performing intra prediction on the current block 2250 according to the intra prediction mode of the spatial reference block 2280, or may obtain the second prediction block by performing intra prediction on the current block 2250 according to the intra prediction mode of the temporal reference block 2480. The prediction encoder 3210 may also obtain the third prediction block based on a weighted sum of the first prediction block and the second prediction block, and encode the current block 2250 using the third prediction block.

According to one or more embodiments, when it is not possible to derive an intra prediction mode from both the spatial reference block 2280 and the temporal reference block 2480, the prediction encoder 3210 may obtain the first prediction block by performing intra prediction on the current block 2250 according to a pre-determined first intra prediction mode (e.g., a planar mode), or may obtain the second prediction block by performing intra prediction on the current block 2250 according to a pre-determined second intra prediction mode (e.g., a DC mode). The prediction encoder 3210 may also obtain the third prediction block based on a weighted sum of the first prediction block and the second prediction block, and encode the current block 2250 using the third prediction block.

According to one or more embodiments, information about the weight applied to the first prediction block and the weight applied to the second prediction block may be included in the bitstream.

According to one or more embodiments, the weight applied to the first prediction block and the weight applied to the second prediction block may be pre-determined. For example, the weight applied to the first prediction block and the weight applied to the second prediction block may be each pre-determined to be ½.

According to one or more embodiments, the number of pre-determined locations within the current block 2250 for determining the intra prediction mode of the current block 2250 may be plural.

The plurality of pre-determined locations may be agreed between the image decoding apparatus 2000 and the image encoding apparatus 3200. For example, when a location of a left upper sample of the current block 2250 is (x, y) (where x and y are integers greater than or equal to 0), the plurality of pre-determined locations may be (x, y) and (x+w/2, y+h/2). Here, w (w is an integer greater than or equal to 1) may indicate a width of the current block 2250, and h (h is an integer greater than or equal to 1) may indicate a height of the current block 2250.

According to one or more embodiments, the prediction encoder 3210 may determine a plurality of locations within the current block 2250. Information about the determined plurality of locations may be included in the bitstream. According to one or more embodiments, information about the determined plurality of locations within the current block 2250 may be signaled via a packet separate from the bitstream.

According to one or more embodiments, the prediction encoder 3210 may identify the plurality of corresponding locations 2281, 2282, 2481, and 2482 of the plurality of pre-determined locations 2251 and 2252 within the current block 2250 from at least one of the spatial reference block 2280 or the temporal reference block 2480.

When the plurality of corresponding locations 2281, 2282, 2481, and 2482 are identified from at least one of the spatial reference block 2280 or the temporal reference block 2480, the prediction encoder 3210 may perform intra prediction on the current block 2250 according to at least one intra prediction mode used to encode the samples at the plurality of corresponding locations 2281, 2282, 2481, and 2482.

According to one or more embodiments, when it is not possible to derive an intra prediction mode from the plurality of corresponding locations 2281 and 2282 of the spatial reference block 2280, the prediction encoder 3210 may determine the temporal reference block 2480, and may perform intra prediction on the current block 2250 according to at least one intra prediction mode used to encode the samples at the plurality of corresponding locations 2481 and 2482 within the temporal reference block 2480.

According to one or more embodiments, when it is not possible to derive an intra prediction mode from the plurality of corresponding locations 2481 and 2482 of the temporal reference block 2480, the prediction encoder 3210 may determine the spatial reference block 2280, and may perform intra prediction on the current block 2250 according to at least one intra prediction mode used to encode the samples at the plurality of corresponding locations 2281 and 2282 within the spatial reference block 2280.

According to one or more embodiments, the prediction encoder 3210 may determine the spatial reference block 2280 and the temporal reference block 2280 within the current picture 2200 and the previous picture 2400, respectively, and may perform intra prediction on the current block 2250 according to at least one intra prediction mode used to encode the samples at the plurality of corresponding locations 2281, 2282, 2481, and 2482 within the spatial reference block 2280 and the temporal reference block 2480.

According to one or more embodiments, when one intra prediction mode is used to encode the samples at the plurality of corresponding locations 2281, 2282, 2481, and 2482, namely, when an intra prediction mode is used to encode a sample at one corresponding location and an intra prediction mode is not used to encode samples at other corresponding locations, the prediction encoder 3210 may perform intra prediction on the current block 2250 according to one available intra prediction mode.

According to one or more embodiments, when one intra prediction mode is used to encode the samples at the plurality of corresponding locations 2281, 2282, 2481, and 2482, the prediction encoder 3210 may obtain the first prediction block by performing intra prediction on the current block 2250 according to the one available intra prediction mode. The prediction encoder 3210 may obtain the second prediction block by performing intra prediction on the current block 2250 according to the pre-determined intra prediction mode (e.g., a planar mode), or may determine the temporal reference block 2480 or the spatial reference block 2280 as the second prediction block. The prediction encoder 3210 may encode the current block 2250 using the third prediction block generated based on a weighted sum of the first prediction block and the second prediction block.

According to one or more embodiments, when two intra prediction modes are used to encode the samples at the plurality of corresponding locations 2281, 2282, 2481, and 2482, the prediction encoder 3210 may obtain the first prediction block by performing intra prediction on the current block 2250 according to one intra prediction mode among the two intra prediction modes. The prediction encoder 3210 may obtain the second prediction block by performing intra prediction on the current block 2250 according to the other intra prediction mode among the two intra prediction modes. The prediction encoder 3210 may encode the current block 2250 using the third prediction block generated based on a weighted sum of the first prediction block and the second prediction block.

According to one or more embodiments, the prediction encoder 3210 may select one intra prediction mode from a plurality of intra prediction modes used to encode the samples at the plurality of corresponding locations 2281, 2282, 2481, and 2482, and may generate a prediction block by performing intra prediction on the current block 2250 according to the selected intra prediction mode. In order to select one intra prediction mode, the prediction encoder 3210 may perform intra prediction on the neighboring sample set 2230 of the current block 2250 according to the plurality of intra prediction modes, and may consider a difference between each of a plurality of prediction sample sets generated as a result of performing the intra prediction and the neighboring sample set 2230.

According to one or more embodiments, the prediction encoder 3210 may obtain the first prediction block by performing intra prediction on the current block 2250 according to the one intra prediction mode selected from the plurality of intra prediction modes. The prediction encoder 3210 may obtain the second prediction block by performing intra prediction on the current block 2250 according to the pre-determined intra prediction mode (e.g., a planar mode), or may determine the temporal reference block 2480 or the spatial reference block 2280 as the second prediction block. The prediction encoder 3210 may encode the current block 2250 using the third prediction block generated based on a weighted sum of the first prediction block and the second prediction block.

According to one or more embodiments, the prediction encoder 3210 may select the first intra prediction mode and the second intra prediction mode from among the plurality of intra prediction modes, and obtain the first prediction block by performing intra prediction on the current block 2250 according to the first intra prediction mode. The prediction encoder 3210 may obtain the second prediction block by performing intra prediction on the current block 2250 according to the second intra prediction mode, and encode the current block 2250 using the third prediction block generated based on a weighted sum of the first prediction block and the second prediction block.

According to one or more embodiments, in order to select the first intra prediction mode and the second intra prediction mode from among the plurality of intra prediction modes, the prediction encoder 3210 may perform intra prediction on the neighboring sample set 2230 of the current block 2250 according to the plurality of intra prediction modes, and may consider the difference between each of the plurality of prediction sample sets generated as a result of performing the intra prediction and the neighboring sample set 2230.

According to one or more embodiments, when an intra prediction mode is not used to encode the samples at the plurality of corresponding locations 2281, 2282, 2481, and 2482, the prediction encoder 3210 may perform intra prediction on the current block 2250 according to the pre-determined intra prediction mode (e.g., a planar mode).

According to one or more embodiments, when an intra prediction mode is not used to encode the samples at the plurality of corresponding locations 2281, 2282, 2481, and 2482, the prediction encoder 3210 may obtain the first prediction block by performing intra prediction on the current block 2250 according to the pre-determined first intra prediction mode (e.g., a planar mode), or may obtain the second prediction block by performing intra prediction on the current block 2250 according to the pre-determined second intra prediction mode (e.g., a DC mode). The prediction encoder 3210 may encode the current block 2250 using the third prediction block generated based on a weighted sum of the first prediction block and the second prediction block.

According to one or more embodiments, an operation of the prediction encoder 3210 of the image encoding apparatus 3200 may be the same as an operation of the prediction decoder 2030 of the image decoding apparatus 2000, so the description of the operation of the prediction decoder 2030 given above may be equally applied to the prediction encoder 3210.

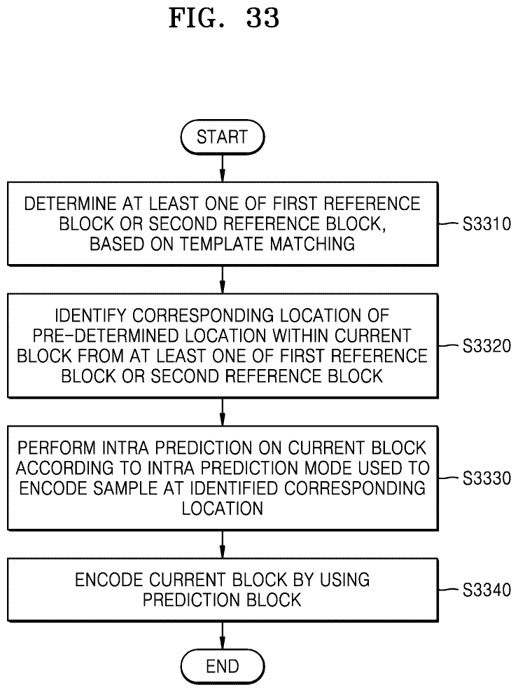

FIG. 33 is a flowchart of an image encoding method according to one or more embodiments. In the following embodiments, each operation may be performed sequentially. Alternatively, the order of each operation may be changed, and at least two operations may also be performed in parallel. In some examples, one or more operations may be skipped or repeated one or more times.

In operation S3310, the image encoding apparatus 3200 may determine at least one of a first reference block in the current picture 2200 encoded before the current block 2250 or a second reference block in the previous picture 2400 encoded before the current block 2250, based on template matching.

The first reference block may be referred to as the spatial reference block 2280, and the second reference block may be referred to as the temporal reference block 2480.

According to the embodiment, both the first reference block and the second reference block may be determined based on template matching.

According to the embodiment, the first reference block may be determined using a block vector, and the second reference block may be determined based on template matching.

According to the embodiment, the first reference block may be determined based on template matching, and the second reference block may be determined using a motion vector.

According to the embodiment, the first reference block may be determined using a block vector, and the second reference block may be determined using a motion vector.

According to one or more embodiments, the first reference block may be determined based on a block vector or template matching, and the second reference block may be determined based on a motion vector of the first reference block.

According to one or more embodiments, the second reference block may be determined when it is impossible to derive an intra prediction mode from the first reference block.

According to one or more embodiments, the first reference block may be determined when it is impossible to derive an intra prediction mode from the second reference block.

In operation S3320, the image encoding apparatus 3200 may identify the corresponding locations 2281 and 2481 of the pre-determined location 2251 within the current block 2250 from at least one of the first reference block or the second reference block.

According to one or more embodiments, the number of pre-determined locations 2251 and 2252 may be plural. In this case, the plurality of corresponding locations 2281, 2282, 2481, and 2482 may be identified from at least one of the first reference block or the second reference block.

In operation S3330, the image encoding apparatus 3200 may generate a prediction block by performing intra prediction on the current block 2250 according to an intra prediction mode used to encode the samples at the identified corresponding locations 2281 and 2481.

According to one or more embodiments, the image encoding apparatus 3200 may generate the first prediction block by performing intra prediction on the current block 2250 according to one intra prediction mode, or may generate the second prediction block by performing intra prediction on the current block 2250 according to another intra prediction mode. The image encoding apparatus 3200 may also generate the third prediction block based on a weighted sum of the first prediction block and the second prediction block.

A method of determining an intra prediction mode of the current block 2250 and a method of generating a prediction block by performing intra prediction on the current block 2250 have been described above with reference to FIGS. 21 through 23 and FIGS. 26 through 30, and thus detailed descriptions thereof will be omitted.

In operation S3340, the image encoding apparatus 3200 may encode the current block 2250 using the prediction block or the third prediction block.

A bitstream may be generated as a result of encoding the current block 2250.

According to one or more embodiments, the image encoding apparatus 3200 may obtain residual data corresponding to a difference between the prediction block or the third prediction block and the current block 2250, and information about the residual data may be included in the bitstream.

The image encoding method, the image encoding apparatus 3200, the image decoding method, and the image decoding apparatus 2000, according to one or more embodiments, aim to improve performance of prediction encoding and prediction decoding with respect to the current block 2250.

The image encoding method, the image encoding apparatus 3200, the image decoding method, and the image decoding apparatus 2000, according to one or more embodiments, aim to reduce the amount of data necessary for signaling an intra prediction mode.

The image encoding method, the image encoding apparatus 3200, the image decoding method, and the image decoding apparatus 2000, according to one or more embodiments, aim to reduce a bit rate of a bitstream.

The technical problems to be addressed through this present disclosure are not limited to the above-mentioned technical problems, and other technical problems not mentioned will be clearly understood by a person skilled in the art to which the present disclosure pertains from the following description.

An image decoding method according to one or more embodiments may include determining at least one of a first reference block in the current picture 2200 reconstructed before the current block 2250 or a second reference block in the previous picture 2400 reconstructed before the current block 2250, based on template matching.

The image decoding method according to one or more embodiments may include identifying a corresponding location of a pre-determined location within the current block 2250 from at least one of the first reference block or the second reference block.

The image decoding method according to one or more embodiments may include generating a prediction block by performing intra prediction on the current block 2250 according to an intra prediction mode used to reconstruct a sample at the identified corresponding location.

The image decoding method according to one or more embodiments may include reconstructing the current block 2250 using the prediction block.

According to one or more embodiments, the intra prediction mode of the current block 2250 may be derived from the reference block, so that the bitrate of the bitstream may be reduced.

According to one or more embodiments, the generating of the prediction block may include performing intra prediction on the current block 2250 according to an intra prediction mode used to reconstruct a sample at the corresponding location of the first reference block, and, when an intra prediction mode is not used to reconstruct the sample at the corresponding location of the first reference block, intra prediction may be performed on the current block 2250 according to an intra prediction mode used to reconstruct a sample at the corresponding location of the second reference block.

According to one or more embodiments, a determination as to whether the intra prediction mode of the first reference block in the current picture 2200 is available may be first made, and then a determination as to whether the intra prediction mode of the second reference block in the previous picture 2400 is available, so that a process for deriving the intra prediction mode of the current block 2250 may be simplified.

According to one or more embodiments, the determining of the at least one of the first reference block or the second reference block may include determining the first reference block based on the template matching; and, when an intra prediction mode is not used to reconstruct the sample at the corresponding location of the first reference block, determining the second reference block within the previous picture 2400, based on a motion vector used to reconstruct the sample at the corresponding location of the first reference block.

According to one or more embodiments, because the first reference block is determined based on template matching and the second reference block is determined based on a motion vector of the first reference block, information indicating the first reference block and the second reference block may not need to be included in the bitstream.

According to one or more embodiments, the generating of the prediction block may include, when an intra prediction mode is not used to reconstruct a sample at the identified corresponding location, performing intra prediction on the current block 2250 according to a pre-determined intra prediction mode.

According to one or more embodiments, when it is impossible to derive an intra prediction mode from reference blocks, efficient intra prediction may be achieved using a default intra prediction mode.

According to one or more embodiments, the generating of the prediction block may include selecting one intra prediction mode from among a first intra prediction mode used to reconstruct the sample at the corresponding location of the first reference block and a second intra prediction mode used to reconstruct the sample at the corresponding location of the second reference block; and performing intra prediction on the current block 2250 according to the selected intra prediction mode.

According to one or more embodiments, one intra prediction mode useful for predicting the current block may be selected, so that the accuracy of prediction may be improved.

According to one or more embodiments, the selecting may include selecting an intra prediction mode indicated by information obtained from the bitstream from among the first intra prediction mode and the second intra prediction mode.

According to one or more embodiments, one intra prediction mode is selected according to the information obtained from the bitstream, load on the image decoding apparatus 2000 may be reduced.

According to one or more embodiments, the selecting may include obtaining a first prediction sample set of the neighboring sample set by applying intra prediction according to the first intra prediction mode to the neighboring sample set reconstructed before the current block; obtaining a second prediction sample set of the neighboring sample set by applying intra prediction according to the second intra prediction mode to the neighboring sample set; and selecting one intra prediction mode from among the first intra prediction mode and the second intra prediction mode, based on a result of comparing the first prediction sample set with the neighboring sample set and a result of comparing the second prediction sample set and the neighboring sample set.

According to one or more embodiments, the image decoding apparatus 2000 directly applies intra prediction to a neighboring sample set in order to select one intra prediction mode, so that the bitrate of the bitstream may be reduced.

According to one or more embodiments, the generating of the prediction block may include obtaining a first prediction block by performing, on the current block 2250, intra prediction according to the first intra prediction mode used to reconstruct the sample at the corresponding location of the first reference block; obtaining a second prediction block by performing, on the current block 2250, intra prediction according to the second intra prediction mode used to reconstruct the sample at the corresponding location of the second reference block; and obtaining a third prediction block based on a weighted sum of the first prediction block and the second prediction block, and the reconstructing of the current block 2250 may include reconstructing the current block 2250 using the third prediction block.

According to one or more embodiments, the current block 2250 is reconstructed using two intra prediction modes, so that the accuracy of prediction may be improved.

According to one or more embodiments, the generating of the prediction block may include obtaining a first prediction block by performing, on the current block 2250, intra prediction according to the intra prediction mode used to reconstruct the sample at the corresponding location; obtaining a second prediction block by performing, on the current block 2250, intra prediction according to a pre-determined intra prediction mode; and obtaining a third prediction block based on a weighted sum of the first prediction block and the second prediction block, and the reconstructing of the current block 2250 may include reconstructing the current block 2250 using the third prediction block.

According to one or more embodiments, the current block 2250 is reconstructed using two intra prediction modes, so that the accuracy of prediction may be improved.

According to one or more embodiments, the reconstructing of the current block 2250 may include reconstructing the current block 2250 using a result of combining at least one of the first reference block or the second reference block with the prediction block.

According to one or more embodiments, the accuracy of prediction may be improved using a reference block as the prediction block.

According to one or more embodiments, the identifying may include identifying a plurality of corresponding locations of a plurality of pre-determined locations within the current block 2250 from at least one of the first reference block or the second reference block, and the generating of the prediction block may include generating of the prediction block by performing intra prediction on the current block 2250 according to at least one intra prediction mode used to reconstruct a sample at least one corresponding location among the identified plurality of corresponding locations.

According to one or more embodiments, several locations for deriving the intra prediction mode of the current block 2250 are determined within the current block 2250, so that the determination of the intra prediction mode of the current block 2250 may be more reliable.

According to one or more embodiments, the generating of the prediction block may include obtaining a first prediction block by performing intra prediction on the current block 2250 according to a first intra prediction mode used to reconstruct a sample at a first corresponding location among the identified plurality of corresponding locations; obtaining a second prediction block by performing intra prediction on the current block 2250 according to a second intra prediction mode used to reconstruct a sample at a second corresponding location among the identified plurality of corresponding locations; and obtaining a third prediction block based on a weighted sum of the first prediction block and the second prediction block, and the reconstructing of the current block 2250 may include reconstructing the current block 2250 using the third prediction block.

According to one or more embodiments, the current block 2250 is reconstructed using two intra prediction modes, so that the accuracy of prediction may be improved.

According to one or more embodiments, the generating of the prediction block may include obtaining a first prediction block by performing intra prediction on the current block 2250 according to a first intra prediction mode selected from among a plurality of intra prediction modes used to reconstruct samples at the plurality of corresponding locations; obtaining a second prediction block by performing intra prediction on the current block 2250 according to a second intra prediction mode selected from among the plurality of intra prediction modes used to reconstruct the samples at the plurality of corresponding locations; and obtaining a third prediction block based on a weighted sum of the first prediction block and the second prediction block, and the reconstructing of the current block 2250 may include reconstructing the current block 2250 using the third prediction block.

According to one or more embodiments, the current block 2250 is reconstructed using two intra prediction modes that are the most suitable for the current block 2250, so that the accuracy of prediction may be improved.

According to one or more embodiments, the generating of the prediction block may include obtaining prediction sample sets of a neighboring sample set by applying intra prediction according to each of the plurality of intra prediction modes to the neighboring sample set reconstructed before the current block 2250; and selecting a first intra prediction mode and a second intra prediction mode from among the plurality of intra prediction modes, based on a result of comparing each of the prediction sample sets with the neighboring sample set.

According to one or more embodiments, two intra prediction modes that are the most suitable for the current block 2250 may be selected through intra prediction on the neighboring sample set of the current block 2250.

An image decoding apparatus according to one or more embodiments may include at least one memory storing at least one instruction; and at least one processor operating according to the at least one instruction.

According to one or more embodiments, the at least one processor may determine at least one of a first reference block in the current picture 2200 reconstructed before the current block 2250 or a second reference block in the previous picture 2400 reconstructed before the current block 2250, based on template matching.

According to one or more embodiments, the at least one processor may include identifying a corresponding location of a pre-determined location within the current block 2250 from at least one of the first reference block or the second reference block.

According to one or more embodiments, the at least one processor may include generating a prediction block by performing intra prediction on the current block 2250 according to an intra prediction mode used to reconstruct a sample at the identified corresponding location.

According to one or more embodiments, the at least one processor may reconstruct the current block 2250 using the prediction block.

According to one or more embodiments, the intra prediction mode of the current block 2250 may be derived from the reference block, so that the bitrate of the bitstream may be reduced.

An image encoding method according to one or more embodiments may include determining at least one of a first reference block in the current picture 2200 encoded before the current block 2250 or a second reference block in the previous picture 2400 encoded before the current block 2250, based on template matching.

The image encoding method according to one or more embodiments may include identifying a corresponding location of a pre-determined location within the current block 2250 from at least one of the first reference block or the second reference block.

The image encoding method according to one or more embodiments may include generating a prediction block by performing intra prediction on the current block 2250 according to an intra prediction mode used to encode a sample at the identified corresponding location.

The image encoding method according to one or more embodiments may include encoding the current block 2250 using the prediction block.

According to one or more embodiments, the intra prediction mode of the current block 2250 may be derived from the reference block, so that the bitrate of the bitstream may be reduced.

An image encoding apparatus according to one or more embodiments may include at least one memory storing at least one instruction; and at least one processor operating according to the at least one instruction.

According to one or more embodiments, the at least one processor may determine at least one of a first reference block in the current picture 2200 encoded before the current block 2250 or a second reference block in the previous picture 2400 encoded before the current block 2250, based on template matching.

According to one or more embodiments, the at least one processor may include identifying a corresponding location of a pre-determined location within the current block 2250 from at least one of the first reference block or the second reference block.

According to one or more embodiments, the at least one processor may include generating a prediction block by performing intra prediction on the current block 2250 according to an intra prediction mode used to encode a sample at the identified corresponding location.

According to one or more embodiments, the at least one processor may encode the current block 2250 using the prediction block.

According to one or more embodiments, the intra prediction mode of the current block 2250 may be derived from the reference block, so that the bitrate of the bitstream may be reduced.

In a computer-readable recording medium having recorded a bitstream thereon, according to one or more embodiments, the bitstream may include a result of encoding the current block 2250.

According to one or more embodiments, the result of encoding the current block 2250 may be generated by determining at least one of a first reference block in the current picture 2200 encoded before the current block 2250 or a second reference block in the previous picture 2400 encoded before the current block 2250, based on template matching.

According to one or more embodiments, the result of encoding the current block 2250 may be generated by identifying a corresponding location of a pre-determined location within the current block 2250 from at least one of the first reference block or the second reference block.

According to one or more embodiments, the result of encoding the current block 2250 may be generated by generating a prediction block by performing intra prediction on the current block 2250 according to an intra prediction mode used to encode a sample at the identified corresponding location.

According to one or more embodiments, the result of encoding the current block 2250 may be generated by encoding the current block 2250 using the prediction block.

According to one or more embodiments, the intra prediction mode of the current block 2250 may be derived from the reference block, so that the bitrate of the bitstream may be reduced.

The image encoding method, the image encoding apparatus 3200, the image decoding method, and the image decoding apparatus 2000 according to one or more embodiments may improve performance of prediction encoding and prediction decoding with respect to the current block 2250.

The image encoding method, the image encoding apparatus 3200, the image decoding method, and the image decoding apparatus 2000 according to one or more embodiments may reduce the amount of data necessary for signaling an intra prediction mode.

The image encoding method, the image encoding apparatus 3200, the image decoding method, and the image decoding apparatus 2000 according to one or more embodiments may reduce a bit rate of a bitstream.

Effects obtainable from the present disclosure are not limited to the aforementioned technical effects, and other effects not mentioned will be clearly understood by a person skilled in the art to which the present disclosure pertains from the following description.

The above-described embodiments of the present disclosure can be written as computer-executable programs, and the written computer-executable programs can be stored in a machine-readable storage medium.

The machine-readable storage medium may be provided as a non-transitory storage medium. The ‘non-transitory storage medium’ is a tangible device and only means that it does not contain a signal (e.g., electromagnetic waves). This term does not distinguish a case in which data is stored semi-permanently in a storage medium from a case in which data is temporarily stored. For example, the non-transitory recording medium may include a buffer in which data is temporarily stored.

According to one or more embodiments of the present disclosure, methods according to various disclosed embodiments may be provided by being included in a computer program product. The computer program product, which is a commodity, may be traded between sellers and buyers. Computer program products are distributed in the form of device-readable storage media (e.g., compact disc read only memory (CD-ROM)), or may be distributed (e.g., downloaded or uploaded) through an application store or between two user devices (e.g., smartphones) directly and online. In the case of online distribution, at least a portion of the computer program product (e.g., a downloadable app) may be stored at least temporarily in a device-readable storage medium, such as a memory of a manufacturer's server, a server of an application store, or a relay server, or may be temporarily generated.

While one or more embodiments of the present disclosure have been described with reference to the figures, it will be understood by those of ordinary skill in the art that various changes in form and details may be made therein without departing from the spirit and scope as defined by the following claims.

Unless explicitly described or implicitly understood from one or more embodiments of the present disclosure, at least one of the components, elements, modules or units, or any nominalized verbs (collectively “components” in this paragraph) represented by a block or an equivalent indication in the drawings may be implemented or embodied by analog and/or digital circuits including one or more of a logic gate, an integrated circuit, a microprocessor, a microcontroller, a memory circuit, a passive electronic component, an active electronic component, an optical component, and the like. Alternatively or additionally, these components may be implemented or embodied by software including one or more instructions stored in an internal or external storage medium that is readable by at least one processor. For example, the at least one processor may invoke at least one of the one or more instructions stored in the storage medium, and execute it, with or without using one or more other components under the control of the at least one processor. This allows the at least one processor to perform at least one function or operation described above as being performed by each of the components according to the at least one instruction invoked. Here, the at least one processor may include a central processing unit (CPU), a graphic processing unit (GPU), another type of microprocessor, not being limited thereto. In other examples, the at least one processor may be implemented in application specific integrated circuit (ASIC) and field-programmable gate array (FPGA).

The method of generating of the prediction block may include based on the intra prediction mode being unused to reconstruct the sample at the corresponding location of the first reference block, intra prediction is performed on the current block according to the intra prediction mode used to reconstruct the sample at the corresponding location of the second reference block.

The method of determining of the at least one of the first reference block or the second reference block may include determining the first reference block based on the template matching; and based on the intra prediction mode being unused to reconstruct the sample at the corresponding location of the first reference block, determining the second reference block within the previous picture based on a motion vector used to reconstruct the sample at the corresponding location of the first reference block.

The method of generating of the prediction block may include based on the intra prediction mode being unused to reconstruct the sample at the identified corresponding location, performing intra prediction on the current block according to a pre-determined intra prediction mode.

The method of generating of the prediction block may include selecting the intra prediction mode from a first intra prediction mode used to reconstruct the sample at the corresponding location of the first reference block and a second intra prediction mode used to reconstruct the sample at the corresponding location of the second reference block; and performing intra prediction on the current block according to the selected intra prediction mode.

The method of selecting of the intra prediction mode may include selecting the intra prediction mode indicated by information obtained from a bitstream.

The method of selecting of the intra prediction mode may include obtaining a first prediction sample set of a neighboring sample set reconstructed before the current block by applying intra prediction according to the first intra prediction mode to the neighboring sample set; obtaining a second prediction sample set of the neighboring sample set by applying intra prediction according to the second intra prediction mode to the neighboring sample set; and selecting the intra prediction mode from the first intra prediction mode and the second intra prediction mode, based on a result of comparing the first prediction sample set with the neighboring sample set and a result of comparing the second prediction sample set and the neighboring sample set.

The method of generating of the prediction block may include obtaining a first prediction block by performing, on the current block, intra prediction according to a first intra prediction mode used to reconstruct the sample at the corresponding location of the first reference block; obtaining a second prediction block by performing, on the current block, intra prediction according to a second intra prediction mode used to reconstruct the sample at the corresponding location of the second reference block; and obtaining a third prediction block based on a weighted sum of the first prediction block and the second prediction block. The method of reconstructing of the current block may include reconstructing the current block using the third prediction block.

The method of generating of the prediction block may include obtaining a first prediction block by performing, on the current block, intra prediction according to the intra prediction mode used to reconstruct the sample at the corresponding location; obtaining a second prediction block by performing, on the current block, intra prediction according to a pre-determined intra prediction mode; and obtaining a third prediction block based on a weighted sum of the first prediction block and the second prediction block. The method of reconstructing of the current block comprises reconstructing the current block using the third prediction block.

The method of reconstructing of the current block may include reconstructing the current block using a result of combining at least one of the first reference block or the second reference block with the prediction block.

The method of identifying the corresponding location may include identifying a plurality of corresponding locations of a plurality of pre-determined locations within the current block from at least one of the first reference block or the second reference block. The method of generating of the prediction block may include generating the prediction block by performing intra prediction on the current block according to at least one intra prediction mode used to reconstruct a sample at least one corresponding location among the plurality of corresponding locations.

The method of generating of the prediction block may include obtaining a first prediction block by performing intra prediction on the current block according to a first intra prediction mode used to reconstruct a sample at a first corresponding location among the identified plurality of corresponding locations; obtaining a second prediction block by performing intra prediction on the current block according to a second intra prediction mode used to reconstruct a sample at a second corresponding location among the identified plurality of corresponding locations; and obtaining a third prediction block based on a weighted sum of the first prediction block and the second prediction block. The method of reconstructing of the current block may include reconstructing the current block using the third prediction block.

The method of generating of the prediction block may include obtaining a first prediction block by performing intra prediction on the current block according to a first intra prediction mode selected from among a plurality of intra prediction modes used to reconstruct samples at the identified plurality of corresponding locations; obtaining a second prediction block by performing intra prediction on the current block according to a second intra prediction mode selected from among the plurality of intra prediction modes used to reconstruct the samples at the identified plurality of corresponding locations; and obtaining a third prediction block based on a weighted sum of the first prediction block and the second prediction block. The method of reconstructing of the current block may include reconstructing the current block using the third prediction block.

What is claimed is:

1. A method for image decoding, the method comprising:
determining at least one of a first reference block in a current picture reconstructed before a current block or a second reference block in a previous picture reconstructed before the current block, based on template matching;
identifying a corresponding location of a pre-determined location within the current block from at least one of the first reference block or the second reference block;
generating a prediction block by performing intra prediction on the current block according to an intra prediction mode used to reconstruct a sample at the identified corresponding location; and
reconstructing the current block using the prediction block.

2. The method of claim 1, wherein the generating of the prediction block comprises:
based on the intra prediction mode being unused to reconstruct the sample at the corresponding location of the first reference block, intra prediction is performed on the current block according to the intra prediction mode used to reconstruct the sample at the corresponding location of the second reference block.

3. The method of claim 1, wherein the determining of the at least one of the first reference block or the second reference block comprises:
determining the first reference block based on the template matching; and
based on the intra prediction mode being unused to reconstruct the sample at the corresponding location of the first reference block, determining the second reference block within the previous picture based on a motion vector used to reconstruct the sample at the corresponding location of the first reference block.

4. The method of claim 1, wherein the generating of the prediction block comprises:
based on the intra prediction mode being unused to reconstruct the sample at the identified corresponding location, performing intra prediction on the current block according to a pre-determined intra prediction mode.

5. The method of claim 1, wherein the generating of the prediction block comprises:
selecting the intra prediction mode from a first intra prediction mode used to reconstruct the sample at the corresponding location of the first reference block and a second intra prediction mode used to reconstruct the sample at the corresponding location of the second reference block; and
performing intra prediction on the current block according to the selected intra prediction mode.

6. The method of claim 5, wherein the selecting of the intra prediction mode comprises:
selecting the intra prediction mode indicated by information obtained from a bitstream from the first intra prediction mode and the second intra prediction mode.

7. The method of claim 5, wherein the selecting of the intra prediction mode comprises:
obtaining a first prediction sample set of a neighboring sample set reconstructed before the current block by applying intra prediction according to the first intra prediction mode to the neighboring sample set;
obtaining a second prediction sample set of the neighboring sample set by applying intra prediction according to the second intra prediction mode to the neighboring sample set; and
selecting the intra prediction mode from the first intra prediction mode and the second intra prediction mode, based on a result of comparing the first prediction sample set with the neighboring sample set and a result of comparing the second prediction sample set and the neighboring sample set.

8. The method of claim 1, wherein the generating of the prediction block comprises:
obtaining a first prediction block by performing, on the current block, intra prediction according to a first intra prediction mode used to reconstruct the sample at the corresponding location of the first reference block;
obtaining a second prediction block by performing, on the current block, intra prediction according to a second intra prediction mode used to reconstruct the sample at the corresponding location of the second reference block; and
obtaining a third prediction block based on a weighted sum of the first prediction block and the second prediction block, and
wherein the reconstructing of the current block comprises reconstructing the current block using the third prediction block.

9. The method of claim 1, wherein the generating of the prediction block comprises:
obtaining a first prediction block by performing, on the current block, intra prediction according to the intra prediction mode used to reconstruct the sample at the corresponding location;
obtaining a second prediction block by performing, on the current block, intra prediction according to a pre-determined intra prediction mode; and
obtaining a third prediction block based on a weighted sum of the first prediction block and the second prediction block, and
wherein the reconstructing of the current block comprises reconstructing the current block using the third prediction block.

10. The method of claim 1, wherein the reconstructing of the current block comprises:
reconstructing the current block using a result of combining at least one of the first reference block or the second reference block with the prediction block.

11. The method of claim 1, wherein the identifying of the corresponding location comprises identifying a plurality of corresponding locations of a plurality of pre-determined locations within the current block from at least one of the first reference block or the second reference block, and
wherein the generating of the prediction block comprises generating the prediction block by performing intra prediction on the current block according to at least one intra prediction mode used to reconstruct a sample at least one corresponding location among the plurality of corresponding locations.

12. The method of claim 11, wherein the generating of the prediction block comprises:
obtaining a first prediction block by performing intra prediction on the current block according to a first intra prediction mode used to reconstruct a sample at a first corresponding location among the identified plurality of corresponding locations;
obtaining a second prediction block by performing intra prediction on the current block according to a second intra prediction mode used to reconstruct a sample at a second corresponding location among the identified plurality of corresponding locations; and
obtaining a third prediction block based on a weighted sum of the first prediction block and the second prediction block, and
wherein the reconstructing of the current block comprises reconstructing the current block using the third prediction block.

13. The method of claim 11, wherein the generating of the prediction block comprises:
obtaining a first prediction block by performing intra prediction on the current block according to a first intra prediction mode selected from among a plurality of intra prediction modes used to reconstruct samples at the identified plurality of corresponding locations;
obtaining a second prediction block by performing intra prediction on the current block according to a second intra prediction mode selected from among the plurality of intra prediction modes used to reconstruct the samples at the identified plurality of corresponding locations; and
obtaining a third prediction block based on a weighted sum of the first prediction block and the second prediction block, and
wherein the reconstructing of the current block comprises reconstructing the current block using the third prediction block.

14. A method for image encoding, the method comprising:
determining at least one of a first reference block in a current picture encoded before a current block or a second reference block in a previous picture encoded before the current block, based on template matching;
identifying a corresponding location of a pre-determined location within the current block from at least one of the first reference block or the second reference block;
generating a prediction block by performing intra prediction on the current block according to an intra prediction mode used to encode a sample at the identified corresponding location; and
encoding the current block using the prediction block.

15. A non-transitory computer-readable medium having a bitstream recorded thereon,
wherein the bitstream includes a result of encoding a current block, and
the result of encoding the current block is generated by:
determine at least one of a first reference block in a current picture encoded before the current block or a second reference block in a previous picture encoded before the current block, based on template matching;
identify a corresponding location of a pre-determined location within the current block from at least one of the first reference block or the second reference block;
generate a prediction block by performing intra prediction on the current block according to an intra prediction mode used to encode a sample at the identified corresponding location; and
encode the current block using the prediction block.
